(19) United States
(12) Patent Application Publication
(10) Pub. No.: US 2003/0187853 A1
(43) Pub. Date: Oct. 2, 2003

(54) Distributed data storage system and method

(76) Inventors: Roy Austin Hensley, Plano, TX (US); Kevin Mark Klughart, Denton, TX (US)

Correspondence Address: KEVIN MARK KLUGHART, 2516 LILLIAN MILLER PARKWAY, SUITE 115, DENTON, TX, 76210-7205, US

(21) Appl. No.: 10/351,621

(22) Filed: Jan. 24, 2003

Related U.S. Application Data
(60) Provisional application No. 60/351,668, filed on Jan. 24, 2002.

(51) Int. Cl. G06F 17/30

(52) U.S. Cl. 707/10

(57) ABSTRACT

A distributed data storage system and method comprising a highly integrated mass storage controller system permitting distributed management and control of data storage is disclosed. The present invention in some preferred embodiments permits mass storage media to be made available on a network in a fashion to permit global access, while automatically handling many high-level file access and data integrity/security/control functions normally associated with a host operating system. This integration and redistribution of functionality permits spatial diversification of data resources, automatic mirroring of data, fault isolation, data security, and a plethora of other control functions to be integrated into the mass storage device. This integration permits peer-to-peer communication between mass storage devices to both unburden the host data consumers but also isolate the data management functions from the data presentation functions normally associated with host systems. Exemplary embodiments of the present invention as applied to specific preferred system contexts include but are not limited to distributed data storage in a networked environment, brokered data access metering, database access/control, data backup, journaling, checkpointing, and automated software distribution.

### PROVISIONAL PATENT APPLICATIONS

Applicants claim benefit pursuant to 35 U.S.C. §119 and hereby incorporate by reference U.S. Provisional Patent Application for “DISTRIBUTED DATA STORAGE SYSTEM AND METHOD”, Ser. No. 60/351,668, docket RAH-2002-003, filed Jan. 24, 2002, and submitted to the USPTO with Express Mail Label ET702590370US.

### CROSS REFERENCE TO RELATED APPLICATIONS

### Utility Patent Applications

Applicants hereby incorporate by reference U.S. Utility patent application by Kevin Mark Klughart for “SYSTEM AND METHOD FOR DATA COMPRESSION AND ENCRYPTION”, Ser. NO. 09/330,942, docket KEI-CRIPT-003, filed Jun. 11, 1999, and submitted to the USPTO with Express Mail Label EM267139727US.

Applicants hereby incorporate by reference U.S. Utility patent application by Kevin Mark Klughart for “INTEGRATED VOLTAGE/CURRENT/POWER REGULATOR/SWITCH SYSTEM AND METHOD”, Ser. No. 09/809,611, docket KEI-VRM-002U, filed Mar. 15, 2001, and submitted to the USPTO with Express Mail Label EF100540238US. This patent application was prosecuted to issuance as U.S. Pat. No. 6,396,137 on May 28, 2002 and is hereby incorporated by reference.

Applicants claim benefit pursuant to 35 U.S.C. §120 and hereby incorporate by reference U.S. Utility patent application for “INTELLECTUAL PROPERTY (IP) BROKERING SYSTEM AND METHOD”, Ser. No. 10/322,683, docket RAH-2002-004, filed Dec. 18, 2002, and submitted to the USPTO with Express Mail Label EU8288407887US.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The disclosed invention anticipates a distributed data storage system and method incorporating X-Drives or the like in which traditional data management functions are migrated from host computers to the actual mass storage devices themselves. As such, these mass storage devices are able to communicate with each other to perform mirroring, spatial data diversity, automatic backups, data metering, data compression/encryption, and a wide variety of information cooperation procedures not possible with the prior art. These features make installation, maintenance, and data management significantly less complex and expensive as compared to the prior art.

Data management features are further extended to include brokering and metering. Authentication and security measures ensure that commercial interests and data integrity are maintained, and they compliment the system's ability to extend content beyond centralized servers. Finally, the addition of geopositioning information in the X-Drives creates the ability for data migration to ensure spatial diversity, and to serve content from the regions of most frequent access.

### BACKGROUND OF THE INVENTION

As applied to the general problem of distributed data storage, the concept of global optimization permits the generation of data storage systems that act autonomously of traditional computer systems, allowing data storage to become a distributed function of computing networks.

### DESCRIPTION OF THE PRIOR ART

The prior art teaches generally as illustrated in FIG. 49 (4910) and FIG. 50 (5010) that data storage is generally tightly integrated into a given computer system and/or network. This creates problems with respect to expandability as well as requiring a great deal of human intervention to properly manage the data storage resource. As data storage systems grow in this prior art paradigm, human management demands grow exponentially, and quickly become the controlling cost issue in the design and overall cost of such data storage systems.

### OBJECTIVES OF THE INVENTION

Accordingly, the objectives of the present invention are (among others) to circumvent the deficiencies in the prior art and affect the following objectives:

(1) Permit distributed data storage systems to act autonomously of computer networks, providing automated backup, data mirroring, data redundancy, and quality of service functions.

(2) To permit data to be delocalized without compromising security such that access times and survivability are optimized.

(3) To permit data to be access controlled and metered for commercial purposes.

(4) To permit information to physically migrate with its users as they travel.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

### Generic Functional Model (0100)

The generic function model used by the present invention as illustrated in FIG. 1 (0100). Here the present invention is embodied as an Intellectual Property (IP) Brokering system that acts as a customer (0120) conduit for customer requirements (0121) which are fractured into brokered IP requests (0131) to IP agents (0130) which actually generate deliverable IP (0132) to meet the customer requirements (0121). This results in a delivered IP system (0141) that is ultimately integrated into a customer product (0140). The IP brokering system as described is unique in that it permits global and system wide optimization of all customer requirement requests as well as optimization of IP agent resources to generate a globally optimized system that targets optimization of the customer utility function (a combination of all important customer goals, including as examples cost, time to market, etc.).

### IP Agents

Key to the methodology used by the present invention is the ability of the IP brokering system (0110) (that may optionally be interfaced with a wide variety of existing enterprise management systems supporting one or more operating entities) to fracture customer requirements (0121) into multiple brokered IP requests (0131) that may be applied across multiple IP agents (0140). The term “IP Agent” (0130) in this context would mean any resource necessary to affect the realization of the customer requirements (0121). For example, this could be equipment, capital, human resources, technical skills, manufacturing capability, shipping resources, or any other resource necessary to affect the desired customer requirement (0121).

### Customer Requirements Projection (0200)

Rather than concentrating on the details of a particular industry as has been the trend in prior art optimization methodologies, the present invention abstracts the customer requirements (0121) as a set of basis vectors in the form of one or more brokered IP requests (0131) that may be mapped to a variety of IP agents (0130) that are capable of realizing the desired result based on customer requirements (0121).

The gist of the methodology utilized by the present invention from a mathematical perspective may be graphically illustrated as given in FIG. 2 (0200). Here the IP brokering system (0210) acts as a mapping agent between the customer requirements state space (0222) and the IP agent state space (0233). Note that the customer requirements state space (0222) may be fractured along a wide variety of system sub-components and other inter-related requirements and as such represents a series of requirements vectors that are not generally fixed, but which do represent a set of core requirements as well as desirable characteristics (0223). Similarly, the IP agent state space (0233) represents a series of available IP resource vectors that are not necessarily orthogonal and which may be augmented with other IP vectors if necessary (i.e., resources may be created where they do not already exist to fulfill a system requirement) (0234).

The coordination of the mapping and projection functions between the customer requirements state space (0222) and the IP agent state space (0233) is the gist of the IP brokering system (0210). Additionally, the expert system which is an integral portion of the IP brokering system permits a wide variety of fracturing and optimization algorithms to be applied to both the customer requirements state space (0222) and the IP agent state space (0233) to affect optimal global system dynamics across customers, projects, and available system resources. Additionally, the system as taught may include feedback to permit the power/utility of the system to grow with time as additional fracturing facets (0223), customer information, and/or state space creation (0234) permits additional degrees of freedom with respect to overall system optimization to be achieved.

### Customer Requirements Fracturing (0300)

An exemplary embodiment of the present invention customer requirements fracturing philosophy is graphically illustrated in FIG. 3 (0300). Note that from a mathematical perspective, this procedure is best described as first requesting the customer (0320) to generate customer requirements (0321) that are generally integrated into a customer requirements state space (0322). This is followed by a fracturing process by the IP brokering system (0310) that produces a fractured set of IP requirements (0311). The fracturing process may granularize the IP requirements in the customer requirements state space (0322) into a wide variety of possible options, each capable of inspection for optimal performance characteristics.

Once fractured, the IP requirements are mapped to available IP agent basis vectors (0334) that are obtained by creating an IP agent state space (0333) from available IP agent (0330) resources. Once mapping is complete, the fractured IP requirements (0311) may be projected onto the available IP agent basis vectors (0334) to produce a generated IP agent projection (0312) that represents what IP agent resources will be used and when they will be used to achieve optimal utility function characteristics as desired by the customer (0320). Note that inherent in this process is the integration of the customer utility function definition within the customer requirements state space (0322) and its incorporation into the fractured IP requirements (0311) by the IP brokering system (0310).

Also inherent in this optimization process is the capability to provide feedback (0313) to the customer (0320) and/or internal feedback (0314) to the IP brokering system (0310) to permit recursive optimization to achieve global optimization across all customers, customer products, and IP agent utilization.

### Generalized Method (0400)

The generalized data flows illustrated in FIG. 3 (0300) may be embodied in a generalized IP brokering method as illustrated in FIG. 4 (0400). This method generally involves the following steps:

(1) Entering and/or refining customer requirements (0401);

(2) Generating a customer requirements state space (0402);

(3) Fracturing the customer requirements state space into a series of customer requirements vectors (0403);

(4) Identifying available IP agents and their associated IP agent state space vectors and optionally extending the IP agent state space if necessary (0404);

(5) Mapping the fractured customer requirements vectors to a set of available IP agent state space vectors (0405), which involves a selection of IP agent state space vectors that are capable of meeting customer requirements;

(6) Projecting the fractured customer requirements to the mapped set of IP agent state space vectors (0406), which involves specific temporal and spatial allocation of IP agent resources;

(7) Determining if an optimal customer utility function has been achieved, and if not, proceeding to one of steps (1)-(6) (0407);

(8) Reporting calculated optimal IP agent vector projections and permitting these optimal IP agent vector projections to be further refined by proceeding to step (1) (0408); and

(9) Optionally determining if the customer is satisfied and if not, proceeding to step (1) (0409).

One skilled in the art will quickly recognize that these steps may be augmented, reduced, combined, and/or resequenced without loss of generality in the teachings of the present invention.

### Integration of Fractured Customer Requirements (0500)

Note also that the present invention permits global integration of either the customer requirements state space and/or the fractured customer requirements state space in order to achieve a level of global optimization not possible in the prior art. This concept is illustrated graphically in FIG. 5 (0500) as an example of how the method illustrated in FIG. 4 (0400) may be expanded to improve efficiency.

As illustrated in FIG. 5 (0500), the present invention anticipates that in some preferred embodiments a single IP brokering system (0510) will serve multiple customers (0521, 0522, 0523) that in turn have associated customer requirements state spaces (0531, 0532, 0533). These customer requirements state spaces (0531, 0532, 0533) can be individually process by the IP brokering system into fractured customer requirements state spaces or these state spaces can be integrated into a single combined fractured customer requirements state space (0540).

The use of a combined fractured customer requirements state space (0540) permits additional levels of global optimization to occur both among different customers (0521, 0522, 0523) and/or their associated customer requirements state spaces (0531, 0532, 0533). By integrating the fractured state space vectors, this permits a greater number of mapping/projections to occur between the combined fractured customer requirements state space (0540) and the IP agent state space (0550). These additional mapping/projection possibilities raise the potential that some of these combinations may better serve the utility function goals of the customers (0521, 0522, 0523) as a whole as compared to solutions which concentrate on the individual needs of a given customer at the expense of all other customers.

As described previously, the result of the IP brokering system (0510) after the projection process is complete is a series of IP agent projections (0561, 0562, 0563). As mentioned in the previous sections, these may be used recursively by the customers (0521, 0522, 0523) and/or the IP brokering system (0510) to further optimize the resulting utilization of IP agent state space vectors (0550).

### Distributed Network Architecture (0600)

As illustrated in FIG. 6 (0600), the present invention (0610) may be advantageously applied to situations in which the Internet or some other communications media (0620) is used on a regional, national, and/or international level to permit brokering of IP from customers (0630) having a plethora of IP requirements (0631) that are fractured and then brokered to IP agents (0640) as brokered IP requests (0641). The IP agents (0640) may have disparate geographic spatial diversity and generate deliverable IP (0642) that is then transported to the customer (0630) in the form of a functional delivered IP system (0632).

While the IP agent (0630) as defined herein is an abstract concept that can as applied be considered to include any resource, several preferred embodiments of the present invention utilize spatially diverse designers (0650) (and/or other resources such as computer programmers, engineers, electrical engineers, mask layout designers, software engineers, and/or technicians, etc.) as well as manufacturers (0660) to realize the individual brokered IP (0641) from the fractured customer requirements (0631) in an attempt to produce a deliverable IP system (0632) having an optimal customer utility function value. One skilled in the art will quickly be able to map the concept of an IP agent (0640) to a wide variety of other resources not illustrated in FIG. 6.

### Abstraction/Fracturing Paradigm (0700)

While the present invention may be thought of as a useful “automated salesman” of sorts from the customer's perspective, it may in some environments be considered an even more valuable tool from the contacted supplier's (sourcing or integrating entity) perspective. To the sourcing company at the top of the supply pyramid, the present invention represents a competitive means of discovering and squeezing efficiencies out of the supply chain, managing internal costs, schedules, and utilization of resources, optimization of forecasting and planning, partner and growth strategies, employee compensation, to name a few exemplary scenarios.

A brief example of how this is accomplished on a system level is illustrated in FIG. 7 (0700). Here the IP brokering system (0710) acts as a gateway to coordinate the transformation of customer (0720) generated requirements (0730) that are generally abstract in nature into realized IP delivered systems. The fracturing of abstract customer requirements (0720) may involve a level of classification by the IP brokering system (0710) that is completely transparent to the customer (0720) but integral to overall improvements in efficiency for the resulting customer utility function and/or delivered IP system.

The generation of a combined fractured requirements state space (0740) by the IP brokering system (0710) incorporating the desired outcomes for multiple customers and/or multiple customer jobs increases the potential for synergy and efficient utilization of IP resources among a single customer as well as multiple diverse customers. The capability of the IP brokering system to generate independent multiple sets of fractured customer requirements state spaces (0740) is transparent to the customer (0720) and permits the customer (0720) to concentrate on what the desired function of the delivered IP system is and not how that function is in fact realized. This abstraction/fracturing paradigm that is implemented by the IP brokering system is key to minimizing the complexity of a customer design while simultaneously providing for levels of system and customer utility function optimization heretofore not achievable with the prior art.

Similarly, the ability of the IP brokering system (0710) to both map the combined fractured customer requirements state space (0740) onto existing IP agent state spaces (0750) and/or extend these state spaces to include new IP to optimally meet the abstract customer requirements (0730) further enhances the fracturing capability of the IP brokering system (0710) and increases the level of abstraction permissible by the customer (0720).

Finally, the projected IP system solutions (0760) permissible by combining and optimizing the fractured customer requirements (0740) and the available/created/extended IP agent state spaces (0750) permits a large number of system configurations to be inspected for optimal compliance with the customer utility function and/or other system efficiencies. The optional ability for the resulting IP agent projections (0760) to be fed back into the IP brokering system (0710) for analysis and further refinement means that local minimum optimums are less likely to be the sole result presented to the customer for final acceptance. Instead, the goal of the IP brokering system (0710) is the identification and quantification of global optimums in terms of the customer utility function, available resources, and spatial/temporal system constraints.

### Integration With Existing Enterprise IT (0800)

As illustrated in FIG. 8 (0800), the present invention as embodied in an IP brokering system (0810) may be integrated into a wide variety of existing enterprise information technology (IT) systems to permit optimization of multiple customer(s) (0821, 0822) and their associated product(s) (0831, 0832). While one skilled in the art will quickly understand how the teachings of the present invention may be incorporated into and interfaced with a wide variety of existing IT subsystems, some exemplary systems anticipated by the present invention include but are not limited to marketing (0841), sales (0842), design (0843), IP suppliers/agents (0844), contractors (0845), finance (0846), manufacturing (0847), management (0848), human resources (HR) (0849), and a plethora of third party tools (0850) including but not limited to exemplary systems such as 12 demand planners, CRM systems, SAS tools, and the like.

### Human Resources (HR) Integration (0900)

Overview

As an exemplary application in which the present invention interfaces to human resources (HR) and integrates employee skills and performance into a global product optimization strategy is illustrated generally in FIG. 9 (0900) and will now be discussed in detail.

System Data Flow

In this preferred embodiment, the IP brokering system (0910) permits an employee (0920) to interface with a human resources agent (0930) that creates an employee database (0940) that may include a wide variety of information pertinent to the employee, such as education, skills, past projects, available calendar, etc., and performance data associated with any or all of these metrics. This quantification of employee information in a database (0940) initially created by the human resources agent (0930) permits the IP brokering system (0910) to match available IP agents (in the form of employee skills) to customer (0950) requirements in the form of IP agent projected vector(s) (0960). Key to an optimal overall customer utility function is the efficient mapping of human resources (0920) to customer requirements in the form of IP agent vectors (0960).

Performance Quantification

Once a given customer project is complete, the customer utility function (0970) is generated and compared against the actual employee performance metric (0980). This comparison permits the IP brokering system the ability to determine the actual performance of the employee (0920) as compared to the projected performance. This permits the employee database (0940) to be updated with both project and performance information.

Compensation Feedback

Key to the integration process with human resources (0930) is the ability to update employee salary and compensation (0990) information based on the actual performance of the employee. This feedback permits an independent and accurate assessment of employee performance that is tied directly to productivity and performance with respect to delivered IP, and permits an accurate methodology to implement employee bonuses and other compensation.

Employee/Contractor Parallel

An ancillary benefit of this preferred embodiment is that it permits a contractor to be substituted for the employee (0920) with no loss of generality. In this situation the contractor can be compensated based on his/her performance as compared with the customer utility function (0970) and the actual contractor performance (0980).

Human Resources Optimizations

The disclosed interaction between an IP brokering system (0910) and a human resources agent (0930) can permit the following human resources optimizations to occur:

Hiring and firing can be driven based on both performance and customer requirements for given skill sets.

Human resources can monitor the utilization of people, equipment, etc., in order to optimize overall system cost.

The system as described can be used to drive hiring based on location, skills, etc.

Retraining of employees can be driven based on projected skill set needs.

Capital purchases for employee support equipment (computers, software, etc.) can be driven based on projected needs.

Forecasting and budgets can be driven based on both the projected skill set needs as well as other management inputs.

Actual employee contribution (in terms of money contributed to the bottom line) can be quantified and used to drive compensation and bonus structures.

Selection of locale in which to generate IP can be based on a multitude of factors beyond the analysis of typical human resources management. This would, for example, permit a determination of whether IP should be generated locally or farmed out to an overseas IP agent.

The ability to broker IP permits some IP to be gathered outside the confines of a given corporate structure. This ability permits an analysis to be conducted as to whether a given IP agent should be an employee or a contractor. This permits a just-in-time dynamic approach to contracting that is not available within the prior art.

For international entities, this paradigm permits true globalization of IP agents with coordinated optimization of global customer utility functions.

Supply chains for the creation of IP can be created dynamically and are altered with time to evolve automatically to provide optimum methodologies. This feature is especially important as technology rapidly changes and the human resources necessary to implement the technology shift spatially and temporally.

One skilled in the art will no doubt realize other advantages to the present invention as they relate to human resource issues in the context of brokered IP agents.

### Third Party IP (1000)

As illustrated in FIG. 8 (0800), the present invention has a wide degree of interface capability. As mentioned in the previous section, the present invention in some embodiments may incorporate management of human resource elements. Additionally, the present invention in some embodiments permits IP agents (such as engineers and the like) to be compensated for the use and/or reuse of their IP blocks. In this capacity the present invention brokers IP internally to reach the goal of customer satisfaction in the form of optimal customer utility functions and permits individual IP agent contributors to submit IP outside the confines of a traditional corporate employer/employee relationship. This paradigm also permits a customer to pick and choose IP and only the IP necessary to meet a given project need and simultaneously gives IP agent contributors an avenue for revenue generation for their contributed IP.

This paradigm is illustrated graphically in the exemplary illustration of FIG. 10 (1000). Here the IP brokering system (1010) operates as normal, but the IP agent (1020) (engineer, technical specialist, etc.) interacts with an IP registration agent (1030) to create an IP rights database (1040) that permits the IP to be defined and access rights to be associated with the IP. This may include royalty rates, permissible users/non-users, simulated performance, etc.

The IP brokering system (1010) utilizes this IP rights database (1040) as just another available IP agent when translating customer (1050) requirements to IP agent projected vector(s) (1060). As discussed previously, the customer utility function (1070) is generated on project completion (or simulation of project completion) and compared to the IP performance metric (1080) (which might be cost, time to market, integrated circuit die size, or any other important metric). This information is then used to both update the IP rights database (1040) and/or generate a royalty database (1090) used to pay the IP agent (1020) for his/her contribution.

Note that once the IP registration agent has created the IP rights database (1040) for the IP agent (1020), the IP agent (1020) may continue to receive royalties (1090) as their IP is reused in multiple customer (1050) applications.

### Distributed Design Paradigm (1100)

Expanding on the concepts illustrated in FIG. 10 (1000), the present invention may be used as a vehicle to support fully distributed design environments in exemplary applications such as application specific integrated circuit (ASIC) design. A typical embodiment of this paradigm is illustrated in FIG. 11 (1100) and will now be discussed in detail.

Referencing FIG. 11 (1100), within this distributed design context the IP brokering system (1110) interacts with customers (1120) to generate a set of IP agent projected vectors (1130). These vectors typically involve functional specifications for a given electrical circuit that is to be embodied in integrated circuit form. These functional requirements are fractured into subcircuit elements and transferred to a set of web-based or other distributed network tools (1140) responsible for the coordination of the actual design of each subcircuit element.

The web-based tools (1140) if properly developed permit traditional design tasks such as schematic capture and IC mask layout to occur without the need for software licenses for the remote users of these products. This permits a wide variety of IP agents to have access to design software for free or minimal cost, thus eliminating any barrier to entry for contract designers to contribute IP to the brokering system. As such, the web-based design tools (1140) permit functional requirements (1141) to be funneled to IP agent circuit designers (1150) who are typically (but not necessarily) electrical engineers. These individuals generate schematics (1142) that represent the logical embodiment of the functional specification requirements (1141) supplied by the IP agent projected vectors (1130).

The schematic (1142) thus produced is then held by the web-based design tools (1140) and subsequently fractured and/or farmed out to one or more mask layout personnel (1160). Note that in this context both the circuit designer (1150) and the mask layout personnel (1160) are brokered IP agents that may be freely assigned based on their skill level, cost, performance, and a whole host of other criterion by the IP brokering system (1110) to achieve maximum system efficiency.

Subsequent to the transfer of a schematic (1143) to a mask layout designer (1160), a physical IC layout (1144) is generated and transferred back to the web-based design tool (1140). Note that in this context the circuit designer (1150) and mask layout designer (1160) may communicate via e-mail (1170) or other mechanism to finalize design details or transfer other important design information. However, in this context the control of the IP is held by the web-based design tools (1140), precluding theft of same by either the circuit designer (1150) or mask layout designer (1160).

The advantage of this system is clear in that it fractures the implementation of large system designs across functional areas that can be spatially diversified (across countries if necessary) to optimize human capital resource utilization as well as customer utility functions. Note that security concerns regarding IP either created or reused in this context can easily be addressed by implementing specific access safeguards within the IP rights database (1040) mentioned previously. Issues such as IP checkout, usage flags, ownership, licensing, access, and other rights management issues can be addressed by suitably constructing the IP rights database (1040) to handle these concerns.

### Temporal Predictor Interface (1200)

One powerful potential interface to the IP brokering system as illustrated in FIG. 8 (0800) is that of a temporal predictor interface. Normally, the IP brokering system may be thought of as a system that takes fixed CURRENT customer requirements and maps/projects these to a set of fixed CURRENT available resources in terms of IP agents. However, there is no constraint within the present invention to limit the temporal scope of the mapping/projection functions to CURRENT customer requirements and/or CURRENT IP agent resources.

The extension of the IP brokering concept to non-current temporal mapping/projections requires some attempt to gauge or quantify future trends in a wide variety of important system parameters. As illustrated in FIG. 12 (1200), a trend predictor module incorporating feedback can be integrated into the basic IP brokering system with no loss of generality.

As illustrated in FIG. 12 (1200), the IP brokering system (1210) can be augmented with future trend data in the form T(k+1) by first incorporating a past trend database (1220) containing T(k-1) trend information. This trend data (1220) is then fed into a function matrix (1230) having a plethora of function elements that analyze the trend data on a linear and/or non-linear basis. These functional projections are then combined by a set of IP agent prediction vectors (1240) which combine selected outputs of the function matrix (1230) to generate the predicted value T(k+1) that is fed to the IP brokering system (1210) for use in generating a set of projected IP agent vectors. The system as illustrated may incorporate a switch matrix (1250) or other equivalent mechanism to provide feedback to the function matrix (1230) to enable the system to extend its predictive capabilities beyond simple linear trend formulations.

A wide variety of prediction mechanisms incorporating neural nets, fuzzy logic, linear algebra, curve fitting, and the like are amenable to application in the system as described in FIG. 12 (1200). Note that the trend data (1220), function matrix (1230), and IP agent predictor vector(s) (1240) may vary considerably based on the type of information being predicted. While the present invention makes no limitation on the type of information that can be used as trend data within the context of the IP brokering concept, several exemplary trend formulations include the following:

Cost of capital;

Interest rates;

Stock market trends (DOW industrial average, NASDAQ 100 average, trends in particular technology stocks);

Trends in the performance of competitor's stock and/or income;

Trends in the performance of customer's stock and/or income;

Availability of human resources (often keyed to availability and cost of particular skill sets, such as computer programmers, etc.);

College graduation rates based on technology area (setting trends in future available technical resources);

Immigration quotas for given technology areas;

Trends in the geographic migration patterns of employees with particular skill sets (census data, etc.);

Trends in housing prices and cost of living (indicating barriers to migration of skill sets to the local geographic area);

Tax rate trends based on geography (indicating areas of optimal expansion and low corporate overhead);

International employment rates, skill sets, costs of transportation, costs of training, available skill sets (to set alternatives to possible exporting of manufacturing and/or other functions currently performed within a given country);

Cost of system block creation based on type of IP contained within the block (i.e., relative tradeoffs in using software vs. hardware to solve a given systems problem);

Trends in individual product prices (i.e., average selling price of a given type of technology across the product lifetime);

Trends in employee performance;

Trends in manufacturing yield; and/or

Trends in the cost of raw materials.

One skilled in the art will quickly be able to take the teachings of the present invention and extend this list to a wide variety of other scenarios.

### Calendar Management (1300)

One aspect of the present invention that may be present in some embodiments is the concept of temporal calendar management. As illustrated in FIG. 13 (1300), the disclosed IP brokering system (1310) may interface with a number of customers (1321, 1322, 1323) who are all simultaneously making customer requests for projected IP vectors that correspond to a solution to a given set of customer requests (project designs, etc.). This can cause difficulty if more than one set of projected IP agent vectors consumes a given IP agent for a given time period. For example, it would generally be undesirable to schedule the resources of an electrical engineer to design a particular electronic circuit for a given week in the year when the engineer was either on vacation or committed to work on another design for another customer.

The solution to this problem is to incorporate calendar management for all IP agent resources. This is accomplished by permitting the IP brokering system (1310) to act as an interface between the customers (1321, 1322, 1323) and a database interlock manager (1330) that accesses the IP agent vector library database (1340) in a coordinated manner to ensure that resources are properly allocated according to a coordinated calendar (1350) or other scheduling system. The database interlock manager (1330) also permits “checkout” of IP agent resources and prioritization of customer requests based on other factors such as non-recurring expense monies provided by customers, projected customer revenue, size of the project, time-to-market, or other system constraints.

### Outsourcing of Brokered IP Requests (1400)

As illustrated in FIG. 14 (1400), the present invention as embodied in an IP brokering system (1410) may interact with a communications media (1420) to select among a variety of IP agents based on cost and other customer utility function constraints. The system as anticipated in some preferred embodiments specifically anticipates brokered IP agent requests being funneled to IP libraries that are in stock with respect to a given customer or supplier (1430);

IP libraries that are licensed from outside vendors (1440);

IP cells that are created by employers of the customer (1450); and/or

IP cells that are created by contractors based on an automated bidding system (1460).

One skilled in the art will recognize that these approaches can be combined in any number of ways to affect realization of the customer requirements while simultaneously optimizing the customer utility function using the teachings of the present invention.

### Optimization Method (1500)

Key to the benefits of the present invention is the use of a generalized optimization method as illustrated in FIG. 15 (1500) that attempts to optimize the customer requirements to available IP agents based on one or more customer utility function(s). The general procedure (1500) begins with entry of a customer preference profile (1510) that indicates various customer characteristics that are to be considered overriding considerations for all system design decisions. This interview process permits global characteristics that define a customer classification (cost sensitivity, performance sensitivity, etc.) to be defined.

This is followed by definition of one or more customer utility function(s) (1520) that define metrics to be used to determine the logical distance between a set of projected IP agent vectors and the desired resulting system that the customer wants. Note that these utility functions can include parameters associated with product cost, speed, performance, power consumption, die size, packaging, time to market, piece cost, and/or a wide variety of other target characteristics. Additionally, the utility function permits weighting of these utility function parameters and also interactions between the parameters to be quantified. The goal of the IP brokering system is to generate a set of resulting projected IP agent vectors that meets the customer requirements with an optimal customer utility function.

Once the customer utility function has been defined (1520), the customer requirements with respect to an individual product or set of products can be entered (1530) and fractured to create a customer requirements state space.

At this point the IP brokering system can identify, locate, and/or map appropriate IP agent basis vectors that can meet the customer state space requirements (1540). In some cases the IP brokering system may scavenge the Internet or some other resource looking for IP agents that meet the customer requirements state space. In other cases these requirements may be fulfilled from existing IP libraries or alternatively they may be brokered out for custom design by contractors or corporate IP agent vendors.

Once the mapping operation is complete, one or more sets of potential IP agent basis vectors has been selected that meet the customer requirements. At this point the customer requirements state space vectors (which may be in some cases be multiply defined) is projected against the IP agent state space to generate a projected IP agent vector space that satisfies the customer requirements (1550). These vectors are optimized based on the customer utility function and then presented to the customer for review or alternatively the system employs recursion to improve on the optimized IP agent state space.

### Information Flow (1600)

As illustrated in FIG. 16 (1600), the present invention may be embodied in the form of an expert system (1610) that interacts with a customer (1620) who generates a knowledge database (1630) comprising customer information and other preference data in the form of a multi-attribute model. The customer (1620) in this context also may create a requirements database (1630) for a given design or product to be produced.

The expert system (1610) in this context integrates the customer knowledge database (1630) and the design requirements database (1640) and matches this to an available technologies database (1650) that often incorporates available IP agents capable of fulfilling the customer design requirements (1640) and customer preferences (1630). The expert system (1610) also takes into account existing architectures (1660) and other existing structures known to the expert system (1610) in order to optimize the selection of IP agent technologies (1650) to generate a solution that meets the customer's utility function requirements.

Of critical importance in this process is the integration of an optimization engine (1670) into the analysis portion of the expert system (1610) to permit a wide variety of optimization techniques to be utilized in order to both meet the customer's utility function requirements in the form of an optimized IP vector projection (1680) but also provide feedback (1690) to the customer (1620) in the form of recommended design alternatives in order to promote a more efficient system implementation. This is especially important in system contexts that may be overconstrained or ones in which multiple solutions make a unique solution impossible.

### BRIEF DESCRIPTION OF THE DRAWINGS

For a fuller understanding of the advantages provided by the invention, reference should be made to the following detailed description together with the accompanying drawings wherein:

FIG. 1 illustrates a global overview of the present invention and its system context as an IP brokering agent;

FIG. 2 illustrates the fracturing of customer requirements state space into one or more functionally equivalent IP agent state space(s);

FIG. 3 illustrates how customer requirements are organized into a customer requirements state space and then fractured and mapped to available IP agent basis vectors and subsequently projected onto these basis vectors to generate one or more IP agent solution projections;

FIG. 4 illustrates an exemplary IP brokering method;

FIG. 5 illustrates the integration of multiple customer requirements state spaces in the form of a combined fractured customer requirements state space in order to achieve overall system efficiencies not possible with the prior art;

FIG. 6 illustrates an exemplary distributed network system application in which the present invention permits global brokering of IP agent resources to affect customer requirements;

FIG. 7 illustrates the ability of the present invention to permit abstraction of customer requirements and isolation of the fracturing details of the final system solution from the customer;

FIG. 8 illustrates how the disclosed IP brokering system may be interfaced to a wide variety of other IT applications;

FIG. 9 illustrates how the disclosed IP brokering system may be used to augment human resources planning and employee/contractor compensation;

FIG. 10 illustrates how the disclosed IP brokering system may provide for IP reuse and royalty generation by third party IP agents outside the traditional corporate environment;

FIG. 11 illustrates an exemplary use of web-based design tools to fracture and isolate various IP agents who work on a given fractured system design in an integrated fashion;

FIG. 12 illustrates an exemplary system incorporating the use of trend data into the IP brokering decision making process;

FIG. 13 illustrates exemplary calendar management;

FIG. 14 illustrates the capability of the present system to select an IP agent based on customer utility function optimization;

FIG. 15 illustrates a generalized flowchart of an exemplary embodiment of an IP brokering optimization method useful in some preferred embodiments of the present invention;

FIG. 16 illustrates generalized information flow and exemplary databases useful in some preferred embodiments of the present invention;

FIG. 17 illustrates an exemplary system embodiment of the present invention as applied to ASIC design and manufacturing;

FIG. 18 illustrates exemplary customer inputs to the requirements/capabilities database used by some preferred embodiments of the present invention to drive IP agent vector selection;

FIG. 19 illustrates an exemplary embodiment of the present invention as applied to an ASIC integration method;

FIG. 20 illustrates an exemplary embodiment of the present invention as applied to an ASIC functional requirements definition method;

FIG. 21 illustrates an exemplary SOC definition method useful in some preferred embodiments of the present invention;

FIG. 22 illustrates an exemplary SOC functional data flow definition;

FIG. 23 illustrates an exemplary SOC interconnect signal flow definition;

FIG. 24 illustrates an exemplary SOC package signal flow definition;

FIG. 25 illustrates an exemplary technology selection method flowchart useful in some preferred embodiments of the present invention;

FIG. 26 illustrates an exemplary IP selection method flowchart useful in some preferred embodiments of the present invention;

FIG. 27 illustrates an exemplary die/cost estimator metric flowchart useful in some preferred embodiments of the present invention;

FIG. 28 illustrates an exemplary attributes estimator metric flowchart useful in some preferred embodiments of the present invention;

FIG. 29 illustrates an exemplary die size/attributes estimator metric flowchart useful in some preferred embodiments of the present invention;

FIG. 30 illustrates an exemplary digital area estimator metric flowchart useful in some preferred embodiments of the present invention;

FIG. 31 illustrates an exemplary analog area estimator metric flowchart useful in some preferred embodiments of the present invention;

FIG. 32 illustrates an exemplary mixed-signal area estimator metric flowchart useful in some preferred embodiments of the present invention;

FIG. 33 illustrates an exemplary IP block selection method flowchart useful in some preferred embodiments of the present invention;

FIG. 34 illustrates an exemplary IP block parameter definition method flowchart useful in some preferred embodiments of the present invention;

FIG. 35 illustrates an exemplary global IP cell parameter definition method flowchart useful in some preferred embodiments of the present invention;

FIGS. 36-39 illustrate a exemplary IP cell-specific parameter definition method flowcharts useful in some preferred embodiments of the present invention;

FIG. 40 illustrates an exemplary CPU parameters definition method flowchart useful in some preferred embodiments of the present invention and exemplary of embodiments of a wide variety of IP cell parameter methods;

FIG. 41 illustrates a prior art MCU architecture incorporating FPGA configuration structures;

FIG. 42 illustrates an embodiment of the present invention as applied to an integrated SOC Ethernet interface;

FIG. 43 illustrates an embodiment of the present invention as applied to an integrated SOC Ethernet-to-IDE/SCSI interface;

FIG. 44 illustrates an embodiment of the present invention as applied to an integrated SOC IDE/SCSI-interface-to-integrated-drive-electronics control system;

FIG. 45 illustrates an embodiment of the present invention as applied to an integrated SOC Ethernet-to-integrated-drive-electronics control system;

FIG. 46 illustrates an embodiment of the present invention as applied to an integrated SOC wireless-network-to-integrated-drive-electronics control system;

FIG. 47 illustrates an exemplary set-top-box entertainment system possible using the integration techniques taught by the present invention;

FIG. 48 illustrates an exemplary video calibration system possible using the integration techniques taught by the present invention;

FIG. 49 illustrates an exemplary contrast between the prior art and the present invention in the context of prior art directly attached storage;

FIG. 50 illustrates an exemplary contrast between the prior art and the present invention in the context of prior art network attached storage;

FIG. 51 illustrates an exemplary contrast between the prior art and the present invention in the context of prior art RAID architectures;

FIG. 52 illustrates exemplary logical file construction in the context of an exemplary spatially diverse X-Drive application;

FIG. 53 illustrates exemplary portable data mobility in the context of an exemplary X-Drive system application;

FIG. 54 illustrates an exemplary X-Drive system incorporating global positioning system (GPS) spatial location identification;

FIG. 55 illustrates an exemplary X-Drive method flowchart indicating an exemplary disk drive configuration sequence;

FIG. 56 illustrates an exemplary high-level file access methodology and system associated with the integration of preferred embodiments of X-Drives into an enterprise data consumer environment;

FIG. 57 illustrates an exemplary hospital care management system implemented using the teachings of the present invention;

FIG. 58 illustrates an exemplary hospital care management method implemented using the teachings of the present invention;

FIG. 59 illustrates an exemplary compute resource brokering system implemented using the teachings of the present invention;

FIG. 60 illustrates an exemplary compute resource brokering method implemented using the teachings of the present invention;

FIG. 61 illustrates a generalized conceptual view of consumer electronics markets as may be applicable to exemplary uses of the present invention;

FIG. 62 illustrates exemplary projected network-attached-storage (NAS) market growth;

FIG. 63 illustrates exemplary projected set-top-box market growth;

FIG. 64 illustrates exemplary projected digital TV market growth.

FIG. 65 illustrates an exemplary embodiment of the present invention as applied to a hospital management application;

FIG. 66 illustrates an exemplary embodiment of the present invention as applied to a data migration application;

FIG. 67 illustrates the prior art technologies used to implement a software distribution application;

FIG. 68 illustrates an exemplary embodiment of the present invention as applied to a software distribution application;

FIG. 69 illustrates an exemplary embodiment of the present invention as applied to a data brokering/metering application;

FIG. 70 illustrates an exemplary embodiment of the present invention as applied to a data brokering/metering application incorporating encryption;

FIG. 71 illustrates an exemplary embodiment of the present invention as applied to a secure multimedia distribution application;

FIG. 72 illustrates an exemplary embodiment of the present invention as applied to a data/software checkpoint/rollback application;

FIG. 73 illustrates the generalized architecture of the present invention;

FIG. 74 illustrates an exemplary embodiment of the present invention as applied to situations in which the X-Drives are geographically and/or spatially diverse;

FIG. 75 illustrates an exemplary data storage configuration method flowchart useful in some preferred embodiments of the present invention;

FIG. 76 illustrates an exemplary data storage access method flowchart useful in some preferred embodiments of the present invention;

FIG. 77 illustrates an exemplary embodiment of the present invention as applied to data distribution;

FIG. 78 illustrates an exemplary data distribution method flowchart useful in some preferred embodiments of the present invention;

FIG. 79 illustrates an exemplary embodiment of the present invention as applied to data brokering and metering;

FIG. 80 illustrates an exemplary data brokering and metering method flowchart useful in some preferred embodiments of the present invention;

FIG. 81 illustrates an exemplary video display calibration method flowchart useful in some preferred embodiments of the present invention.

### DETAILED DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of an DISTRIBUTED DATA STORAGE SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Definitions

Throughout the discussion in this document the following definitions will be utilized:

System Blocks/Procedural Steps Not Limitive

The present invention may be aptly described in terms of exemplary system block diagrams and procedural flowcharts. While these items are sufficient to instruct one of ordinary skill in the art of the teachings of the present invention, they should not be strictly construed as limiting the scope of the present invention. One skilled in the art will be aware that system block diagrams may be combined and rearranged with no loss of generality, and procedural steps may be added or subtracted, and rearranged in order to achieve the same effect with no loss of teaching generality. Thus, it should be understood that the present invention as depicted in the attached exemplary system block diagrams and procedural flowcharts is for teaching purposes only and may be reworked by one skilled in the art depending on the intended target application.

Personal Computer Not Limitive

Throughout the discussion herein there will be examples provided that utilize personal computer (PC) technologies to illustrate the teachings of the present invention. The term ‘personal computer’ should be given a broad meaning in this regard, as in general any computing device may be utilized to implement the teachings of the present invention, and the scope of the invention is not limited just to personal computer applications.

Internet/Intranet Not Limitive

Throughout the discussion herein the terms Internet and Intranet will be used generally to denote any network communication system or environment. Generally the term Intranet will denote communications that are local to a given system or user, and Internet will describe communications in a more distant locale. One skilled in the art will recognize that these terms are arbitrary within the contexts of modern communication networks and in no way limitive of the scope of the present invention.

The present invention specifically anticipates that in some implementations the GUI development framework (and/or its runtime component) will communicate with the data used to drive the GUI over the Internet. Thus, the application driving the user interface may reside on one computer system and the data used for presentation and control may be contained somewhere else on another computer system and be accessed via any number of networking protocols. The physical medium used to affect this communication may be any number of network interfaces, including but not limited to the use of serial ports to communicate with various network elements and the like. Data residency may be in any number of forms well known in the art, including but not limited to hard disk drives, CDROMs, DVDs, etc.

Application Programming Interface (API) Not Limitive

While the present invention may be in part implemented using standard Application Programming Interfaces (APIs) such as Software Development Kits (SDKs) and the like, there is no requirement that the present invention be implemented using these tools. Note also that the framework of the present invention may be incorporated into standard toolkits and the like which may or may not be integrated into an API framework for use in standard software development frameworks.

Graphical User Interface (GUI) Not Limitive

While the present invention may be in part implemented using a standard Graphical User Interface (GUI) such as that available in Microsoft® and Linux® Operating systems, there is no requirement that the present invention be implemented using these tools. The GUI presented herein may be rearranged to have a different order, different labels, colors, types of controls, and other ergonomic features without loss of generality in the teachings of the present invention.

Operating System Not Limitive

Additionally, while the present invention may be implemented to advantage using a variety of Microsoft® operating systems (including a variety of Windows™ variants), nothing should be construed to limit the scope of the invention to these particular software components. In particular, the system and method as taught herein may be widely implemented in a variety of systems, some of which may incorporate a graphical user interface. Some examples of these include HP-UX™, LINUX™, SOLARIS, and UNIX™ (and its variants), among others.

Data Files/Structures Not Limitive

The present invention may be embodied in a variety of data files/structures in some preferred embodiments. However, the form of such data files/structures as described herein is only exemplary. One skilled in the art would quickly realize that a wide variety of other data files/structures could be used equivalently in this application. Therefore, no data file/structure contained herein should be interpreted as limiting the scope of the present invention.

ASIC/SOC Not Limitive

The terms “application specific integrated circuit (ASIC)” and “system-on-a-chip (SOC)” as used herein should be given their broadest interpretation to include any system functionality which may be decomposed into constituent sub-systems comprising analog, digital, and the like IP blocks. In general the term ASIC/SOC could mean any integrated circuit (IC) design incorporating IP from either existing libraries or IP created specifically for a design, modified for a design, or brokered using some other method as described herein.

### Enabling Technology

Overview

The present invention anticipates the integration of analog and digital systems on a single integrated circuit (IC). One common problem with attempts to achieve this level of mixed-signal integration in the past has been the constant problem of digital noise injection into proximal analog system blocks through either the substrate and/or power supply/ground connections on the integrated circuit.

Preferred Embodiment Using VCPRS

While there are a wide variety of solutions to this problem, one preferred in the context of the present invention is the use of integrated voltage-current-power regulator/switches as described in U.S. Utility patent application by Kevin Mark Klughart for “INTEGRATED VOLTAGE/CURRENT/POWER REGULATOR/SWITCH SYSTEM AND METHOD”, Ser. No. 09/809,611, docket KEI-VRM-002U, filed Mar. 15, 2001, and submitted to the USPTO with Express Mail Label EF100540238US, and incorporated herein by reference.

This patent application illustrates a technique wherein a given integrated circuit sub-system or area can be provided with switched power using a MOSFET or other pass device that is positioned on top of and/or below the active sub-system. This permits the power within the sub-system to be regulated independent of the power supplied to remaining portions of the integrated circuit. This scheme as applied to ASIC/SOC design and placement as described herein permits the noise coupling between analog and digital subsystems to be minimized thus permitting tighter integration of analog and digital subsystems on the same integrated circuit.

VCPRS Not Limitive

Since this cited patent application has yet to be published or made public as of the date of filing of the disclosed ASIC/SOC system and method herein, the prior art does not teach the integration of this methodology with any brokered IP design system to achieve optimized ASIC/SOC functionality/cost based on customer requirements. While the technique disclosed in the VCPRS patent Ser. No. 09/809,611 is preferred in some embodiments of the present invention, it is not mandatory that this technique be utilized to realize the benefits of the teachings of the present invention.

Pass Device Integration

It should also be noted that the cited patent application also permits the integration of high power pass devices on the same substrate as analog and digital subsystems with little or no process changes, the present invention anticipates the following additions to the VCPRS patent disclosure that may permit some preferred embodiments of the present invention to be optimally implemented:

Low Temperature Epitaxy

The use of low temperature epitaxy if for situations in which the pass device is fabricated after any chip interconnect is deposited. In this context, some preferred embodiments may require 400 degrees Celsius as the ceiling fabrication temperature since barrier metals can change phase composition above this point, and aluminum (Al) melts around 450 degrees Celsius. This technique is possible, as evidenced by the reference article http://vacuum-solutions.com/main/article/1/18/10. In this context a super low deposition rate may be preferred.

Flip-Chip Mounting

The use of flip-chip (chip-on-chip) mounting regulators to integrate vertically will work perfectly, and may be less expensive to implement than a fully integrated approach. Some illustrations of this technique can be found at http://www.ultratech.com/about/presentations/wlp taiwan/MS_Lin.PDF.

A more exotic, but ideal approach in some preferred embodiments may be found at http://www.infotech.tu-chemnitz.de/-microtec/eng/press/annualrep00/pdf/special_reportl.pdf.

Preferred Embodiment Using CRIPT

The present invention in some embodiments may incorporate an encryption and/or compression methodology in on of several preferred embodiments targeted towards the mass storage market. While there are a wide variety of solutions to this problem, one preferred in the context of the present invention is the use of CRIPT compression/encryption as described in U.S. Utility patent application by Kevin Mark Klughart for “SYSTEM AND METHOD FOR DATA COMPRESSION AND ENCRYPTION”, Ser. No. 09/330,942, docket KEI-CRIPT-003, filed Jun. 11, 1999, and submitted to the USPTO with Express Mail Label EM267139727US, and incorporated herein by reference.

The compression/encryption technique detailed in this patent application is particularly useful in some preferred embodiments of the present invention as it is space/time efficient, highly resilient to cryptographic attack, and can be implemented with a minimal hardware complement.

### System Overview

Preferred Application Environment

One preferred commercial application for the present invention is in the design and manufacturing of custom application specific integrated circuits (ASICs). Since this application is heavily dependent on the integration of intellectual property (IP) that often comes from a wide variety of sources (some international), the need to tightly integrate this process has been a long felt need in the industry which has yet to be met by any system or method in the prior art.

System Components

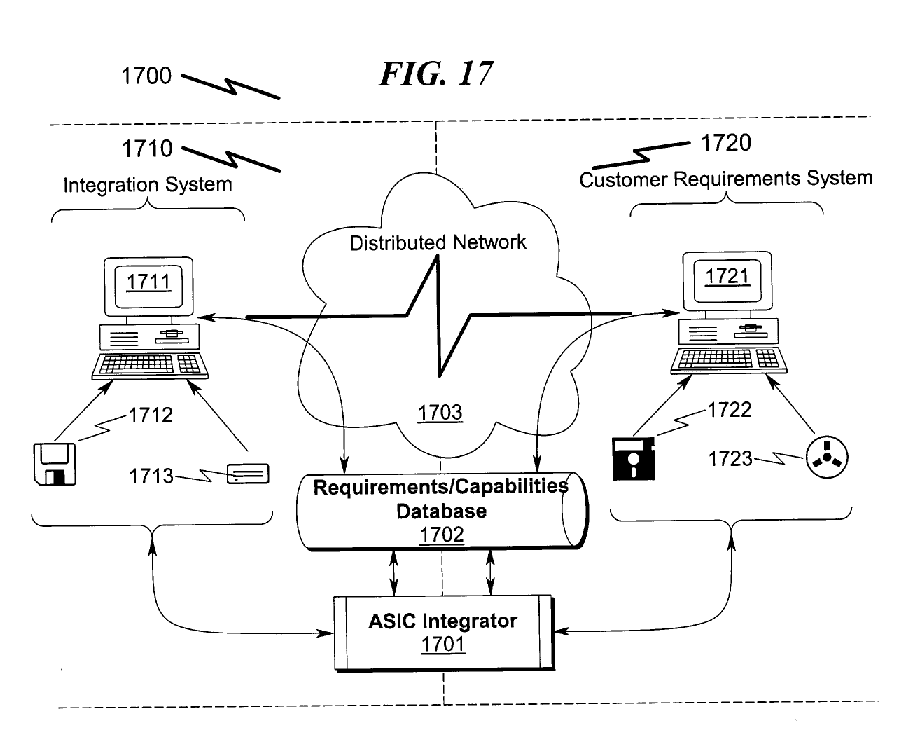

As illustrated in FIG. 17 (1700), the ASIC application of the present invention generally incorporates an ASIC integrator (1701) module that generally conforms to the definition of an IP brokering system as described previously. The requirements/capabilities database (1702) generically represents the databases associated with the previously discussed IP brokering system. Within this context, a distributed network (1703) is used to tie the integration system (1710) with the customer requirements system (1720), and it is assumed that all of these systems may be spatially diverse.

The IP brokering system (1701) in this context is embodied in software running on computers (1711, 1721) used to communicate with design specialists (IP agents) and/or customers. A wide variety of computer readable media (1712, 1713, 1722, 1723) is anticipated as being compatible with either of these systems.

The spatial diversity possible with this system architecture permits customers to distribute the generation of IP (integrated circuit design and associated mask layout functions) across national or international boundaries and thus affect cost reductions in areas where skilled labor is expensive. This methodology also permits fracturing of IP agent resources and application of these resources to situations that maximize their efficiency.

Customer Requirements Input

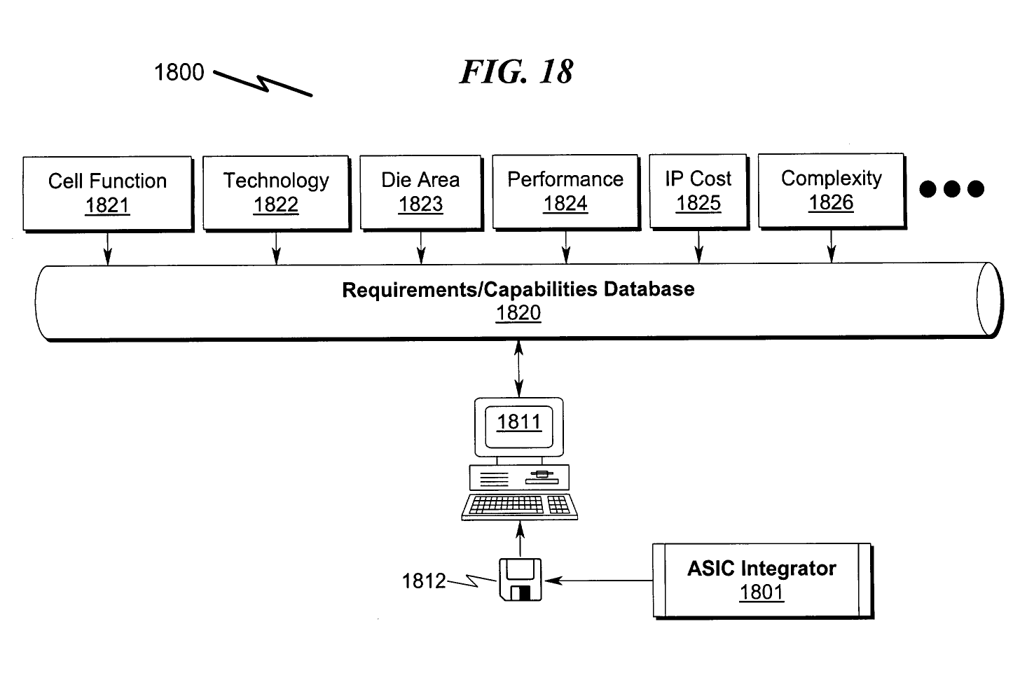

Referencing FIG. 18 (1800), the ASIC integration preferred embodiment of the present invention permits the ASIC integrator (1801) as embodied on a computer system (1811) running appropriate software (1812) to generate a requirements/capabilities database (1820) in response to customer requirements inputs.

This database (1820) can include a wide variety of requirements, including but not limited to the following:

cell function (1821);

technology (1822);

die area (1823);

performance (1824);

IP cost (for brokered/licensed IP) (1825);

complexity (1826); and

other factors.

One skilled in the art will no doubt be able to take the teachings of the present invention and expand this list considerably.

### Method Overview

General Method (1900)

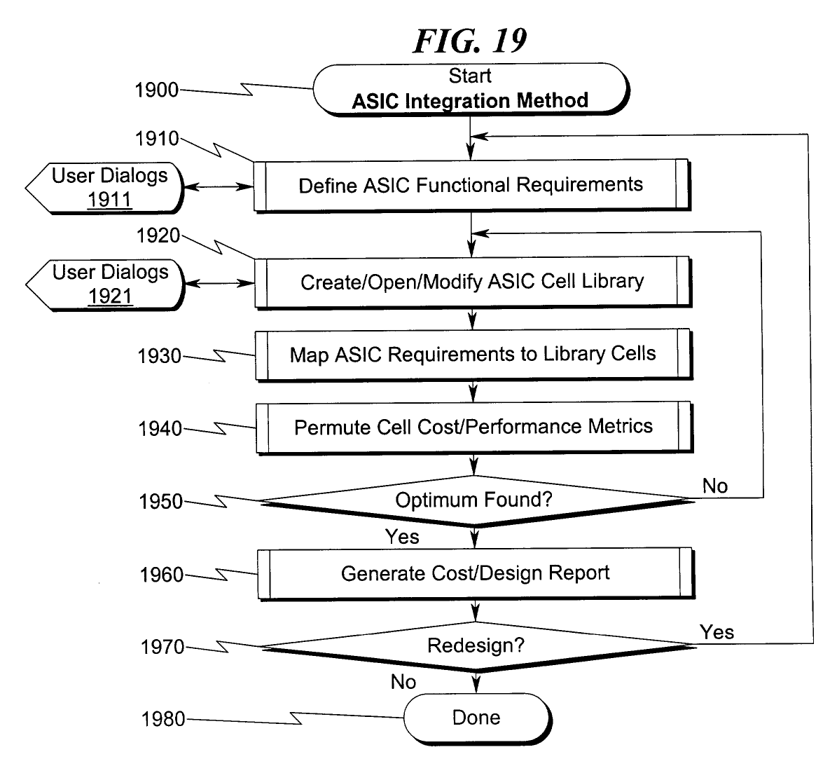

Referencing FIG. 19 (1900), a preferred embodiment of the present invention as applied to ASIC system design starts with customer entry of ASIC functional requirements (1910) via the use of user dialogs (1911). This is followed by accessing/creating an ASIC cell library (1920) via user dialogs (1921) to determine architectures or components that may be suitable for the customer.

Once the general system requirements are defined, the system maps the ASIC requirements to library cells (1930) and permutes cell cost/performance metrics (1940) until an optimum system solution is found (1950). Once an optimum solution is found, a cost/design report is generated (1960) which represents the projected IP agent vector solution. If necessary, this step may be followed by redesign (1970).

Functional Requirements (2000)

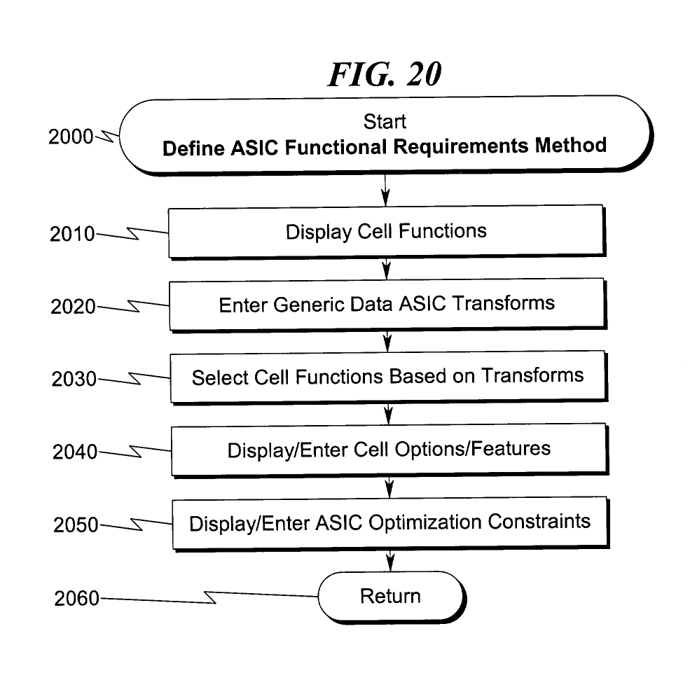

As illustrated in FIG. 20 (2000), the definition of functional requirements for a given ASIC design may be done interactively with the customer by first displaying available cell functions (2010) and allowing the customer to enter generic ASIC transforms (2020) for his desired system function. The IP brokering system then selects cell functions based on desired customer transforms (2030), and permits the customer to display/select any cell options (2040) and/or optimization constraints (2050).

### Preferred Application: System-On-A-Chip (SOC) Design

### Overview (2100)

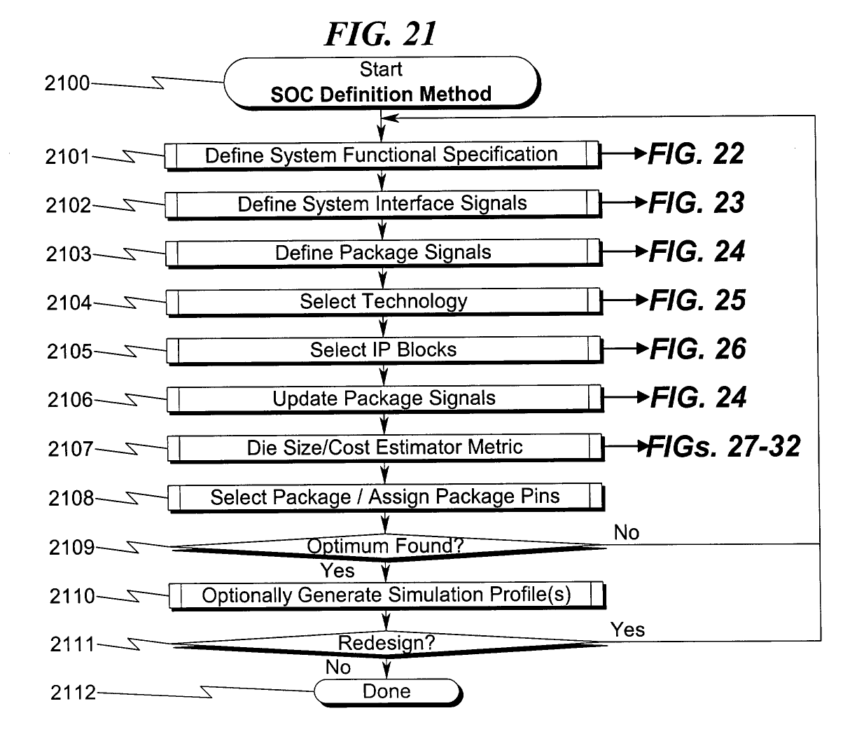

As illustrated in FIG. 21 (2100), the present invention may be integrated into a System-On-A-Chip (SOC) design methodology that includes the following steps:

(1) defining the system functional specification (2101);

(2) defining system interface signals (2102);

(3) defining package signals (2103);

(4) selecting appropriate technology (2104);

(5) selecting appropriate IP blocks to implement the functional specification (2105);

(6) updating package signals to correspond to current IP block selections (2106);

(7) calculating die size/cost using an estimator metric (2107);

(8) selecting an appropriate package based on die size and assigning package pins (2108);

(9) determining if the design is optimal and if not proceeding to step (1) (2109);

(10) optionally generating simulation profiles to simulate the design (2110);

(11) determining if a redesign is necessary and if so proceeding to step (1) (2111).

One skilled in the art will recognize that these steps may be added to or subtracted from and rearranged with no loss of generality. These steps will now be explained in more detail.

### Defining System Functional Specification (2200)

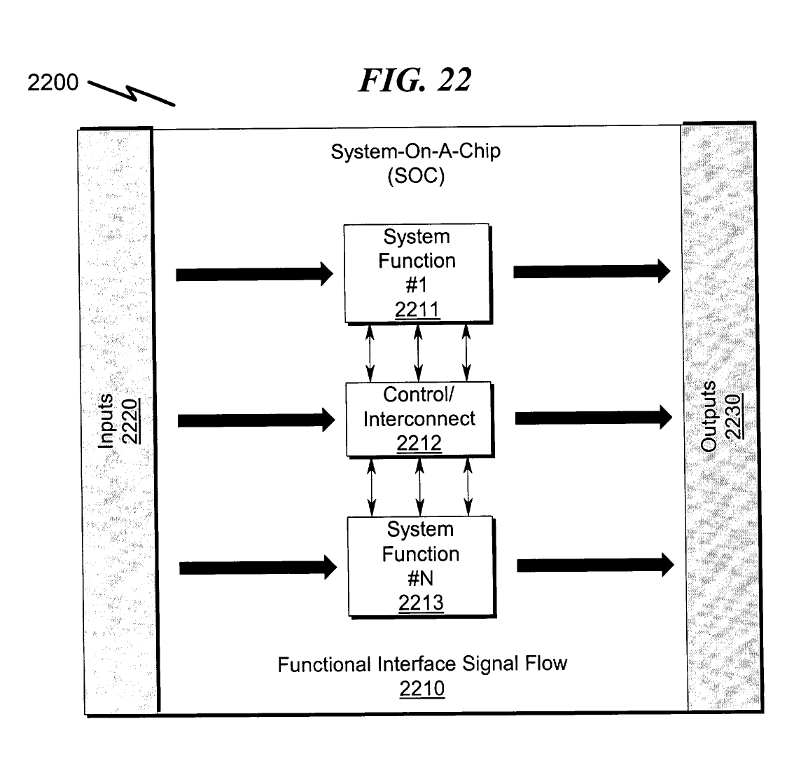

As illustrated in FIG. 22 (2200), the process of defining a SOC system functional specification generally involves defining one or more system functions (2211, 2213) and associated interconnect (2212) that take system function inputs (2220) and generate required system function outputs (2230).

### Defining System Interface Signals (2300)

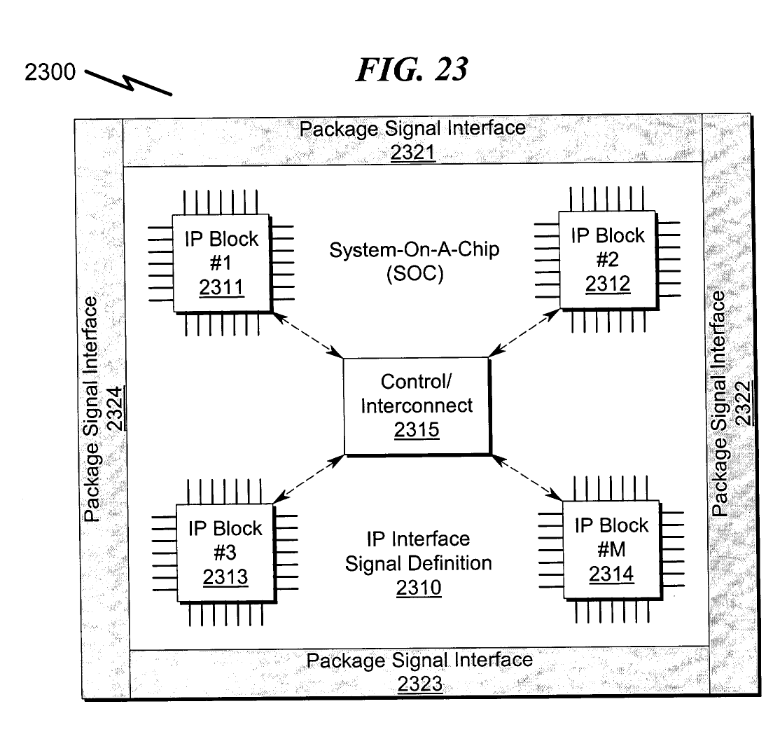

As illustrated in FIG. 23 (2300), the process of defining SOC interface signals generally involves defining an IP interface signal definition (2310) comprising signals associated with one or more IP blocks (2311, 2312, 2313, 2314) and/or IP block interconnect (2315). This process generally defines internal chip signals and their associated interconnections.

### Defining Package Signals (2400)

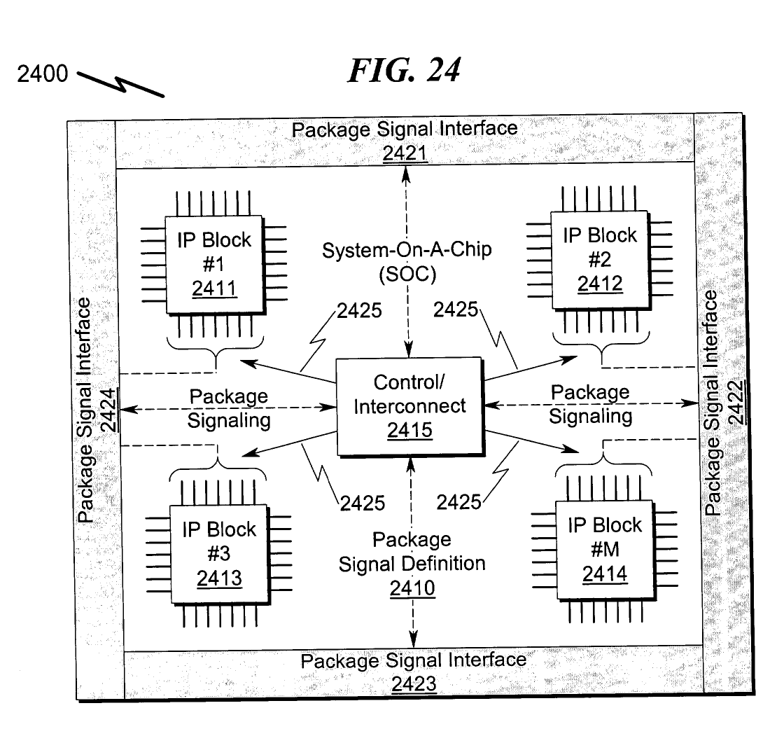

As illustrated in FIG. 24 (2400), the process of defining SOC package signals generally involves defining an package signal definition (2410) comprising signals associated with one or more IP blocks (2411, 2412, 2413, 2414) and/or IP block interconnect (2415) and their interface to a package signal interface (2421, 2422, 2423, 2424). This process generally defines external chip signals and their associated interconnections.

### Selecting Technology (2500)

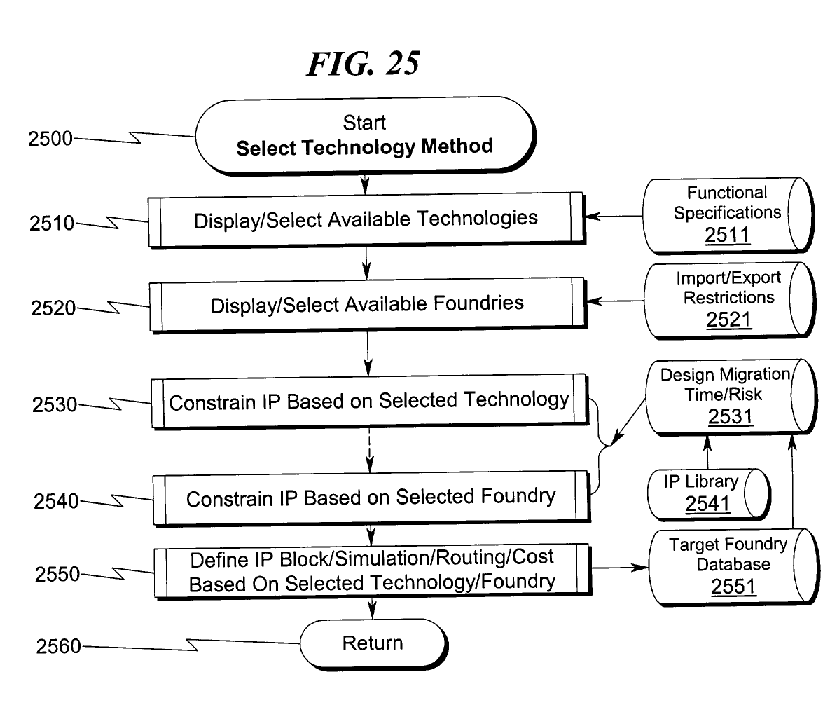

As illustrated in FIG. 25 (2500), the process of selecting technology to meet design requirements generally involves the following steps:

(1) displaying and/or selecting available technologies (2510) based on the system functional specifications (2511);

(2) displaying and/or selecting available foundries (2520) to fabricate the system based on import/export restrictions (2521);

(3) constraining the selected IP blocks based on the selected technology (2530) using information from a design migration time/risk database (2531);

(4) constraining the selected IP blocks based on the selected foundry (2540) using information from a design migration time/risk database (2531);

(5) defining IP block/simulation/routing/cost factors based on the selected technology/foundry (2550) and using this information to update a target foundry database (2551).

One skilled in the art will recognize that these steps may be added to or subtracted from and rearranged with no loss of generality.

It is informative to note that the constraints on technology/foundry (2530, 2540) are premised on information retrieved from the IP library (2541) which indicates what capabilities are required for a given design as well as previous incarnations of the target foundry database (2551) and design migration time/risk factors (2531). This process can be iterative if necessary. The use of historical data to quantify the time-to-market and associated design risks with a given approach permits the present invention to better quantify the true cost of a given design methodology as well as permit overall lower cost for a given product design.

### Selecting IP Blocks (2600)

Overview

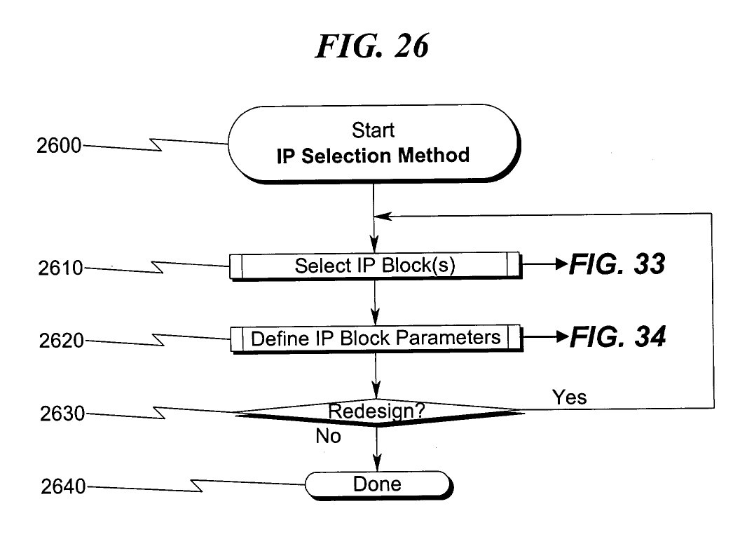

As illustrated in FIG. 26 (2600), the process of selecting IP blocks to meet design requirements generally involves the following steps:

(1) selecting one or more IP blocks from a given available suite (2610) (or determining that a given IP block must be created); and

(2) defining IP block configuration parameters (2620) for each selected IP block.

One skilled in the art will recognize that these steps may be added to or subtracted from and rearranged with no loss of generality. These steps will now be explained in more detail.

Cell Selection Method (3300)

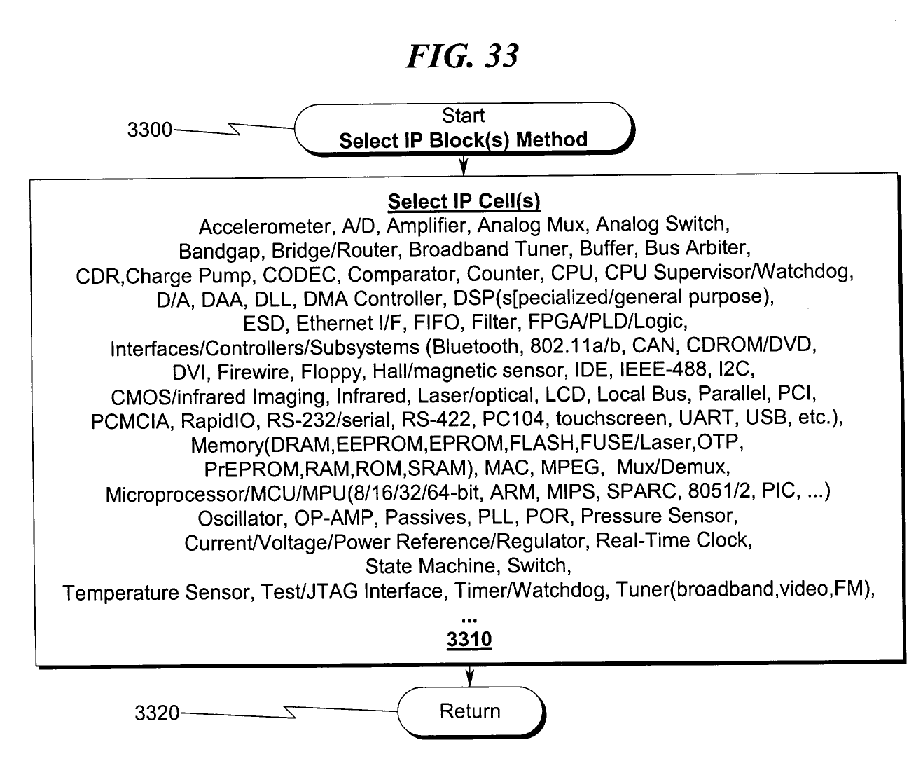

As illustrated in FIG. 33 (3300), the process of selecting IP cell blocks to meet design requirements generally involves selecting from a variety of pre-defined IP cells (3310) that may include a wide variety of IP elements. These may include IP cells that are pre-defined, contracted for development, or modified from prior designs. One skilled in the art will recognize that the list of available IP cell blocks provided in FIG. 33 (3310) is only exemplary and may be readily expanded as needed given any particular functional system specification.

Parameter Definition Method (3400)

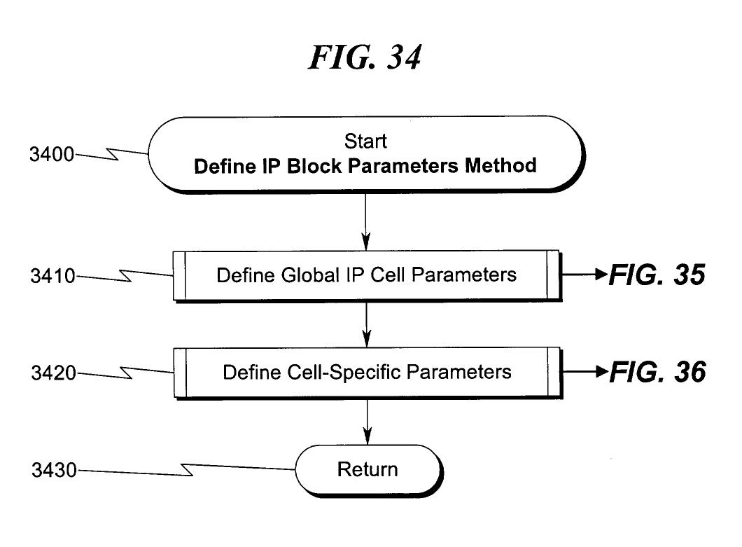

As illustrated in FIG. 34 (3400), the process of defining specific IP block parameters generally involves the following steps:

(1) defining global IP cell parameters (3410) that are general in nature; and

(2) defining cell-specific parameters (3420) for each selected IP block.

One skilled in the art will recognize that these steps may be added to or subtracted from and rearranged with no loss of generality. These steps will now be explained in more detail.

Global IP Cell Parameters (3500)

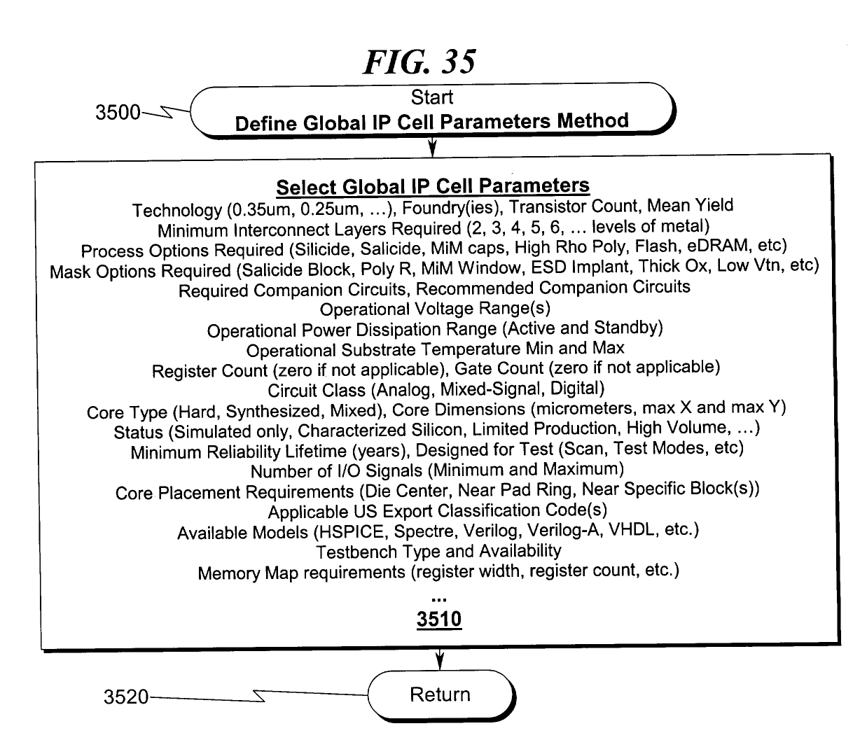

As illustrated in FIG. 35 (3500), the process of defining global IP block parameters generally involves the selection of a variety of general parameters that are applicable to most if not all IP cells (3510). These global parameters are generally structured to provide an overall technology framework for the given design. One skilled in the art will recognize that the cell parameters listed in FIG. 35 (3510) are exemplary and may be expanded as needed based on individual system design constraints.

Cell-Specific Parameters (3600, 3700, 3800, 3900)

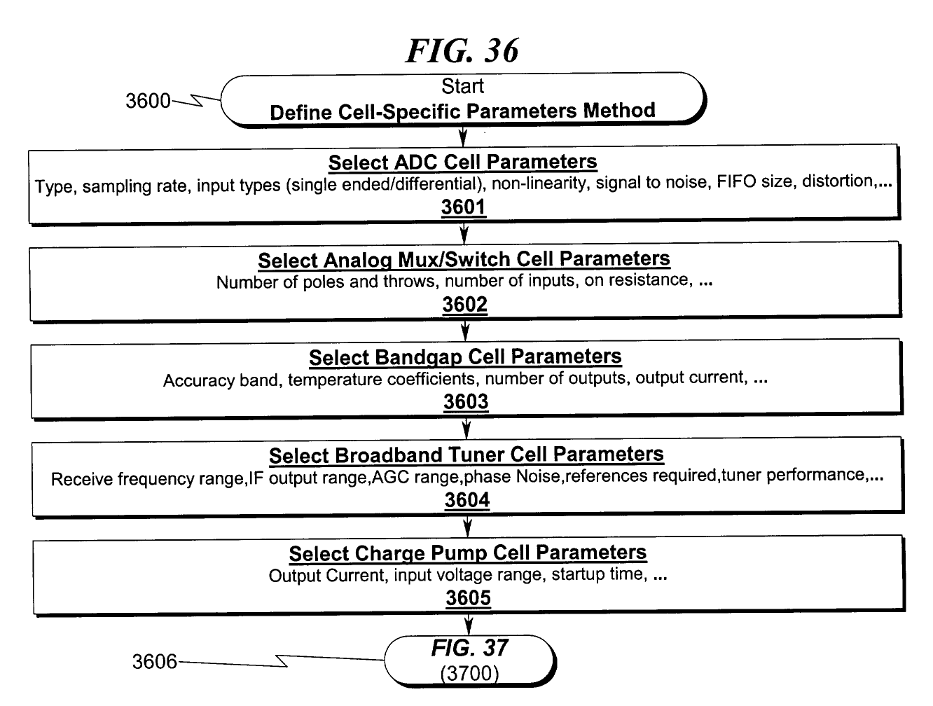

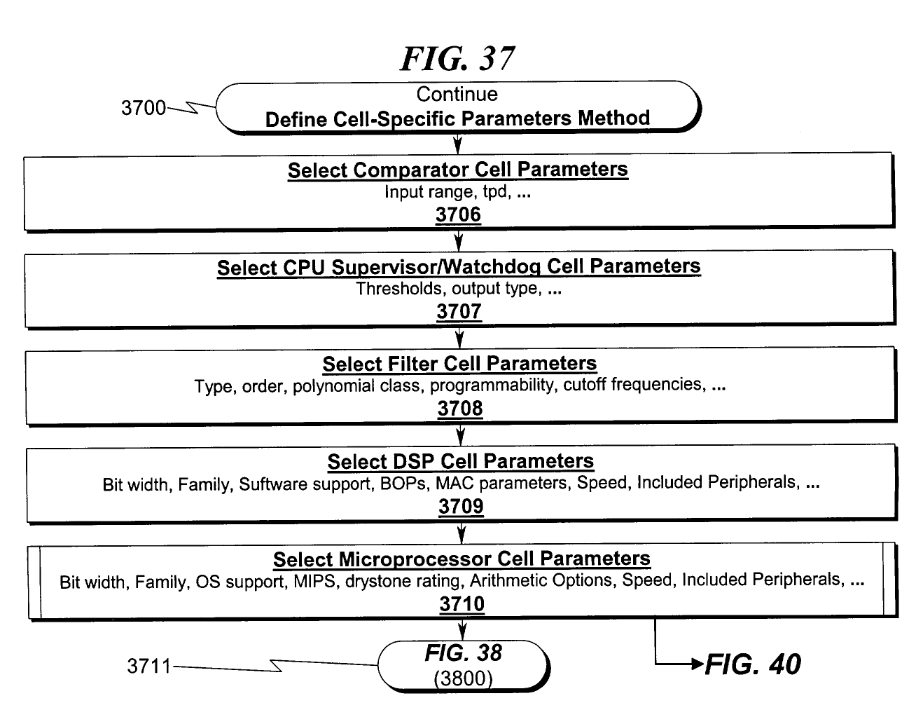

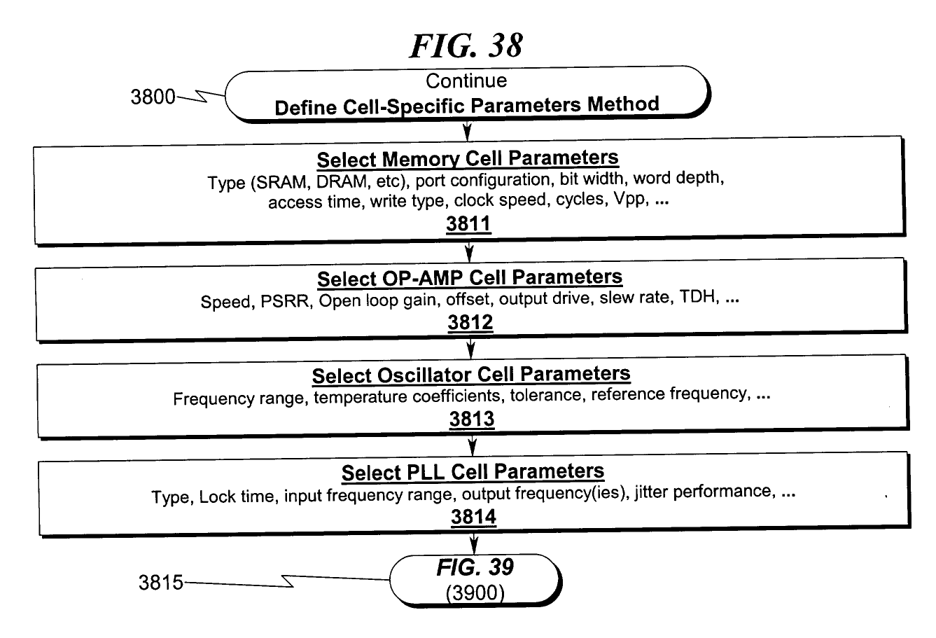

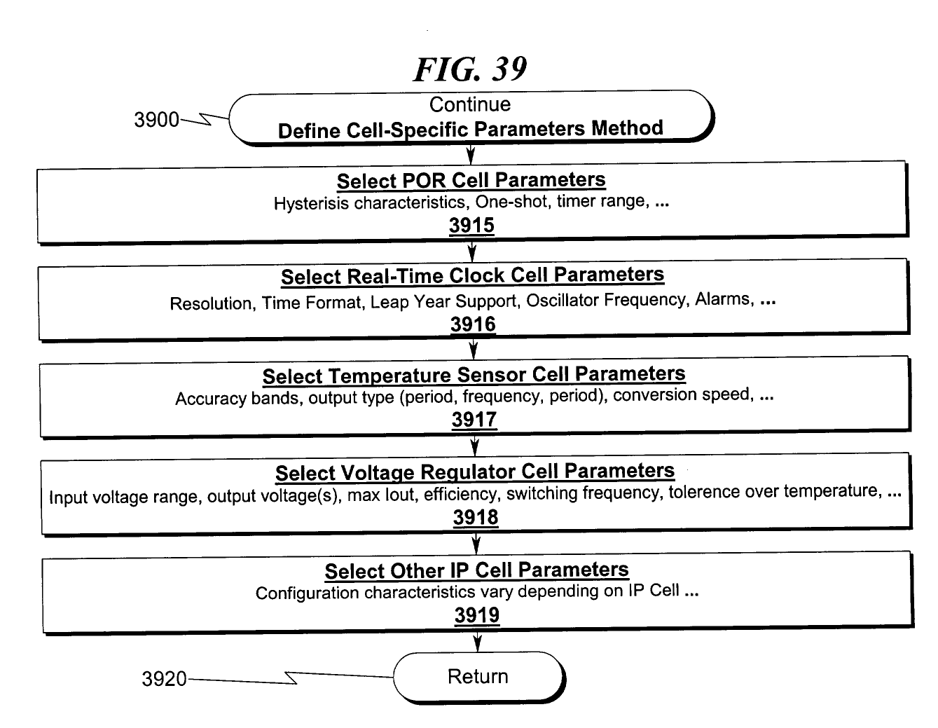

As illustrated in FIG. 36 (3600), FIG. 37 (3700), FIG. 38 (3800), and FIG. 39 (3900), cell specific parameter definition may include but not be limited to the following types of cells:

(1) ADC cell parameters (3601);

(2) Analog mux/switch cell parameters (3602);

(3) Bandgap cell parameters (3603);

(4) Broadband tuner cell parameters (3604);

(5) Charge pump cell parameters (3605);

(6) Comparator cell parameters (3706);

(7) CPU supervisor cell parameters (3707);

(8) Filter cell parameters (3708);

(9) DSP cell parameters (3709);

(10) Microprocessor cell parameters (3710);

(11) Memory cell parameters (3811);

(12) OP-AMP cell parameters (3812);

(13) Oscillator cell parameters (3813);

(14) PLL cell parameters (3814);

(15) Power-On-Reset (POR) cell parameters (3915);

(16) Real-Time Clock (RTC) cell parameters (3916);

(17) Temperature Sensor cell parameters (3917);

(18) Voltage Regulator cell parameters (3918); and

(19) Selecting parameters for other IP cells (3919).

One skilled in the art will recognize that these cell parameter definitions are only exemplary and may be added to or subtracted from and rearranged with no loss of generality.

Exemplary Cell-Specific Parameter Method (4000)

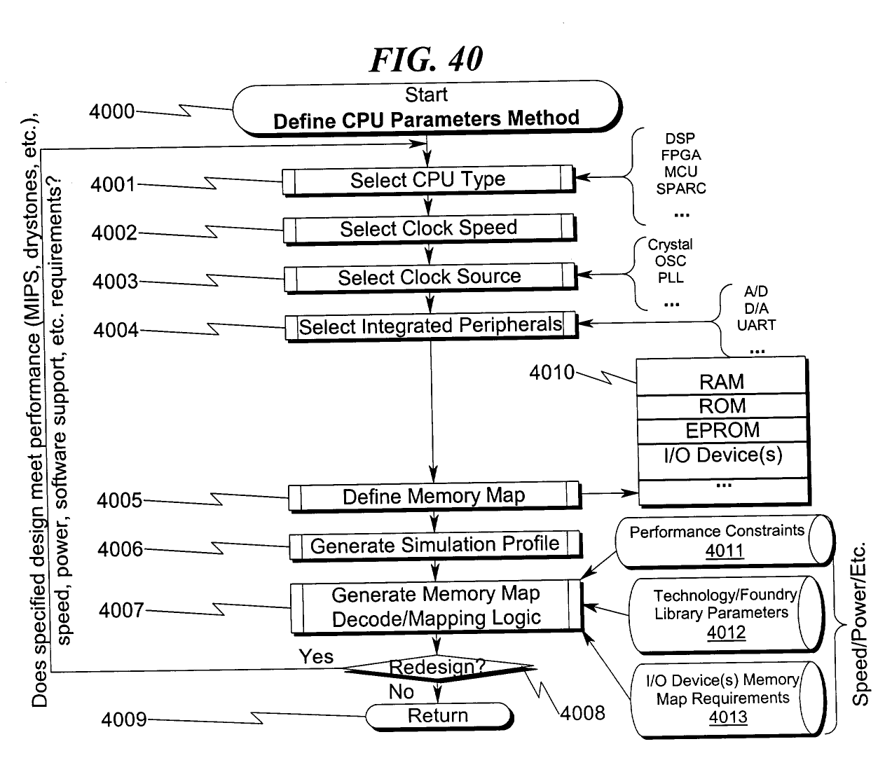

As illustrated in FIG. 40 (4000), an exemplary cell parameter definition method as applied to the definition of CPU parameters might include the following steps:

(1) Selecting the CPU type (4001);

(2) Selecting the CPU clock speed (4002);

(3) Selecting the CPU clock source (4003);

(4) Selecting integrated peripherals (UART, timers, etc.) that are associated with the CPU core (4004);

(5) Defining a memory map for the CPU (4005);

(6) Generating a simulation profile for the CPU (4006);

(7) Generating a memory map and appropriate decode/mapping logic to integrate the IP blocks into the CPU periphery (4007); and

(8) Determining if a redesign is necessary and if so proceeding to step (1) (4008).

One skilled in the art will recognize that these steps may be added to or subtracted from and rearranged with no loss of generality. While this flowchart details an exemplary method as applied to the definition of CPU parameters, one skilled in the art will recognize that this is exemplary of cell definition techniques that may be applied to any IP cell, given the parameters associated with the cell and the design options available to the customer.

Note that the use of a memory map definition (4010) in conjunction with step (5) (4005) permits a system designer to abstract the desired system configuration and then with associated performance constraints (4011), technology/foundry library parameters (4012), and/or I/O device memory map requirements (4013) permits the present invention to automatically generate appropriate decoding logic (4007) and memory mapping logic to integrate the CPU peripherals and other system components into an integrated SOC system without the need for manual design. This significantly improves both the design cycle time and overall confidence that the system as constructed will function properly in the first manufactured integrated circuit.

### Updating Package Signals (2400)

Note that the assignment of package signals as illustrated in FIG. 24 (2400) may require updating as indicated in FIG. 21 (2106) as a result of technology (2104) and IP block selection (2105). This optional reconfiguration may be required as a result of IP block selection because each IP block may have specific signal requirements (power supplies, control signals, reference signals, etc.) that are specific to the implementation of the IP block and therefore cannot be evaluated and tied to a physical package interface pin until the final IP block selection has been made.

### Die Size/Cost Estimator Metric (2700)

Overview

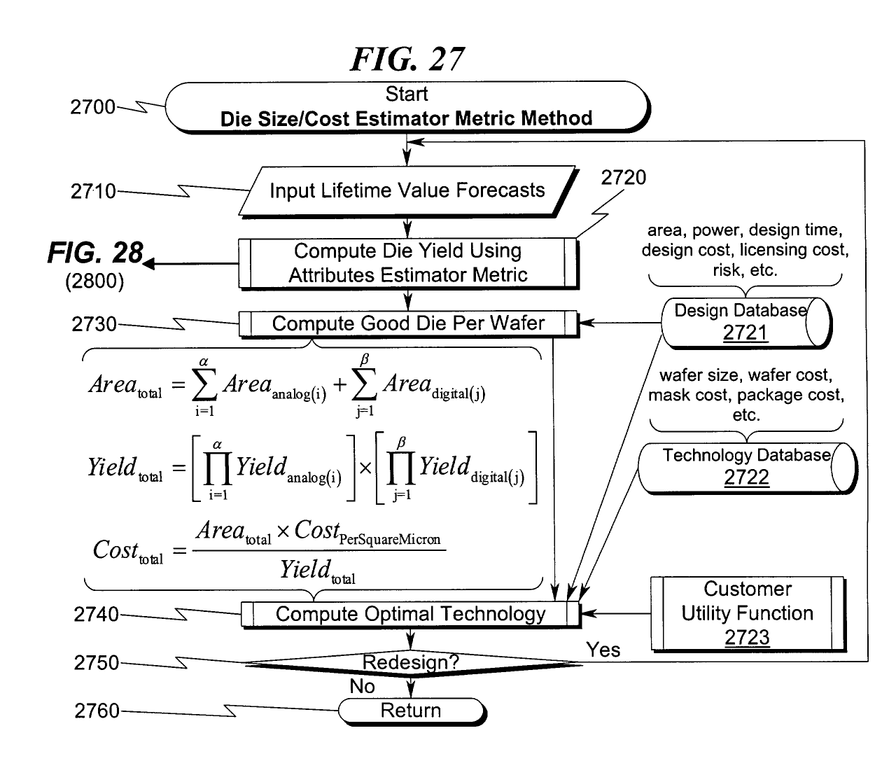

As illustrated in FIG. 27 (2700), an exemplary die size/cost estimator metric method might include the following steps:

(1) Entering lifetime value forecasts for the given target product (2710);

(2) Compute die yield using an attributes estimator metric (2720);

(3) Computing good die per wafer (2730);

(4) Computing optimal technology to implement the desired customer function (2740);

(5) Determining if a product redesign is necessary and if so proceeding to step (1) (2750).

One skilled in the art will recognize that these steps may be added to or subtracted from and rearranged with no loss of generality.

The significance of step (1) (2710) is that the product sales/volume forecasts may dictate which design approaches are economically viable. For example, if the product volumes are low, then a high-technology fabrication process having mask lithography costs of US$250,000 may be prohibitive, and a low-technology fabrication process having mask lithography costs of US$30,000 may be the only economically viable alternative.

As indicated in FIG. 27 (2700), the area, yield, and cost factors are generally calculated from more primitive function calls using the following equations:

$$\begin{matrix}{Area}_{total} = {\sum }_{i = 1}^{α} {Area}_{analog ( i )} + {\sum }_{j = 1}^{β} {Area}_{digital ( j )} & ( 1 ) \\ {Yield}_{total} = [ {\prod }_{i = 1}^{α} {Yield}_{analog ( i )} ] \times [ {\prod }_{j = 1}^{β} {Yield}_{digital ( j )} ] & ( 2 ) \\ {Cost}_{total} = \frac{{Area}_{total} \times {Cost}_{PerSquareMicron}}{{Yield}_{total}} & ( 3 )\end{matrix}$$

As will be detailed later, the methods as described attempt to fracture the IP integration problem into analog and digital primitives, and individually apply area and yield calculations to both partitions with additions for interconnect overhead and routing efficiency.

The remainder of the blocks illustrated in FIG. 27 (2700) will now be discussed in detail.

Attributes Estimator Metric (2800)

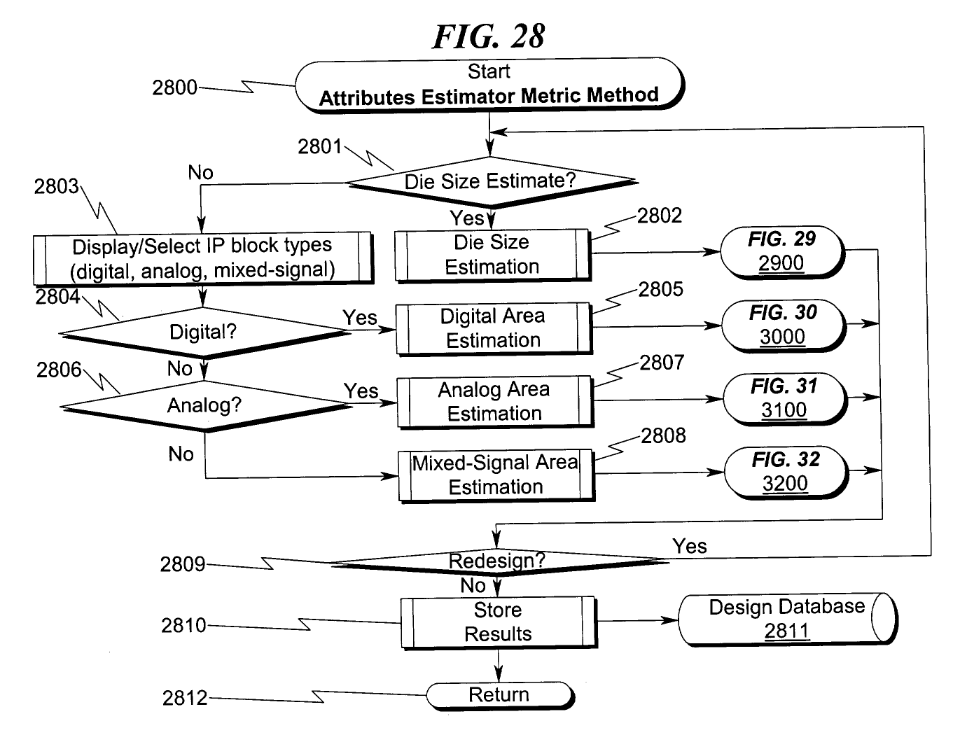

As illustrated in FIG. 28 (2800), an exemplary chip/die attributes estimator metric method might include the following steps:

(1) Determining if a die size estimate is required, and if not, proceeding to step (3) (2801);

(2) Calculating a die size estimate and proceeding to step (9) (2802);

(3) Displaying and/or selecting IP block types used in the target design (2803);

(4) Determining if the selected IP block type is digital, and if not, proceeding to step (6) (2804);

(5) Calculating a digital area estimation and proceeding to step (9) (2805);

(6) Determining if the selected IP block type is analog, and if not, proceeding to step (8) (2806);

(7) Calculating an analog area estimation and proceeding to step (9) (2807);

(8) Calculating a mixed-signal area estimation and proceeding to step (9) (2808);

(9) Determining if a product redesign is necessary and if so proceeding to step (1) (2809);

(10) Storing the results of the estimator metric (2810) in a design database (2811).

One skilled in the art will recognize that these steps may be added to or subtracted from and rearranged with no loss of generality. These steps will now be explained in more detail.

Die Size Estimator Metric Method (2900)

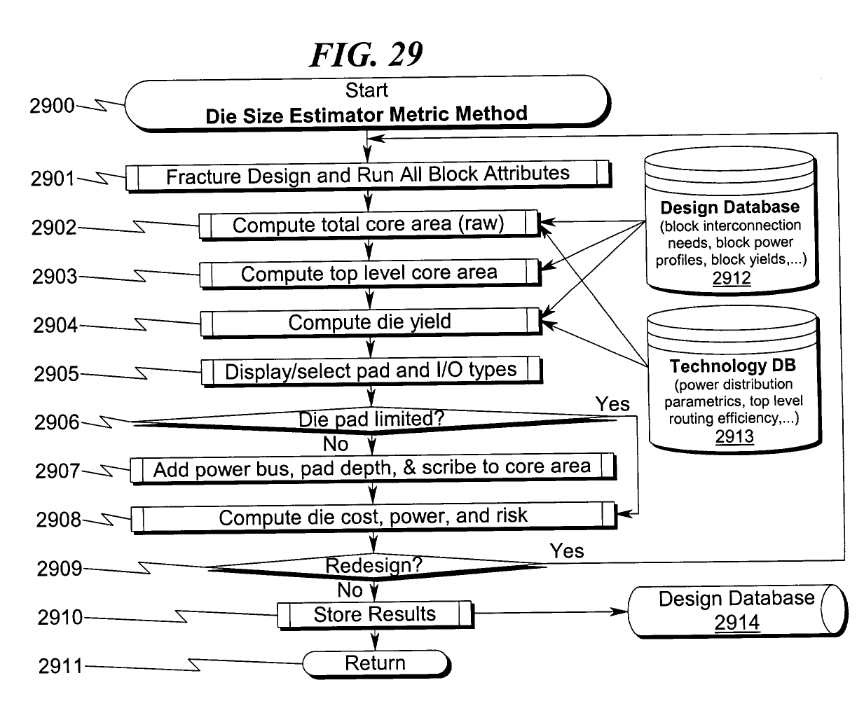

As illustrated in FIG. 29 (2900), an exemplary die size estimator metric method might include the following steps:

(1) Fracturing the design and running all block attributes to determine an exploded area estimate of all system IP components (2901);

(2) Computing total core area of the IP system as a raw estimate (2902) using information from a design database (2912) and/or a technology database (2913);

(3) Computing top level core area including system interconnect (2903) using information from a design database (2912);

(4) Computing die yield for the given total and top level core areas (2904) using information from a design database (2912) and/or a technology database (2913);

(5) Displaying and/or selecting bonding pads and/or I/O types for package interconnection (2905);

(6) Determining if the selected design is I/O package pad limited (the chip area is dictated by interface I/O package pads rather than IP block area) and if so, proceeding to step (8) (2906);

(7) Calculating total chip area by adding power bus, pad depth, and scribe information to previously calculated core area (2907);

(8) Calculating the die cost, power consumption, and design/fabrication/manufacturing risk associated with the final design (2908);

(9) Determining if a product redesign is necessary and if so proceeding to step (1) (2909);

(10) Storing the results of the estimator metric (2910) in a design database (2914).

One skilled in the art will recognize that these steps may be added to or subtracted from and rearranged with no loss of generality.

Digital Area Estimator Metric Method (3000)

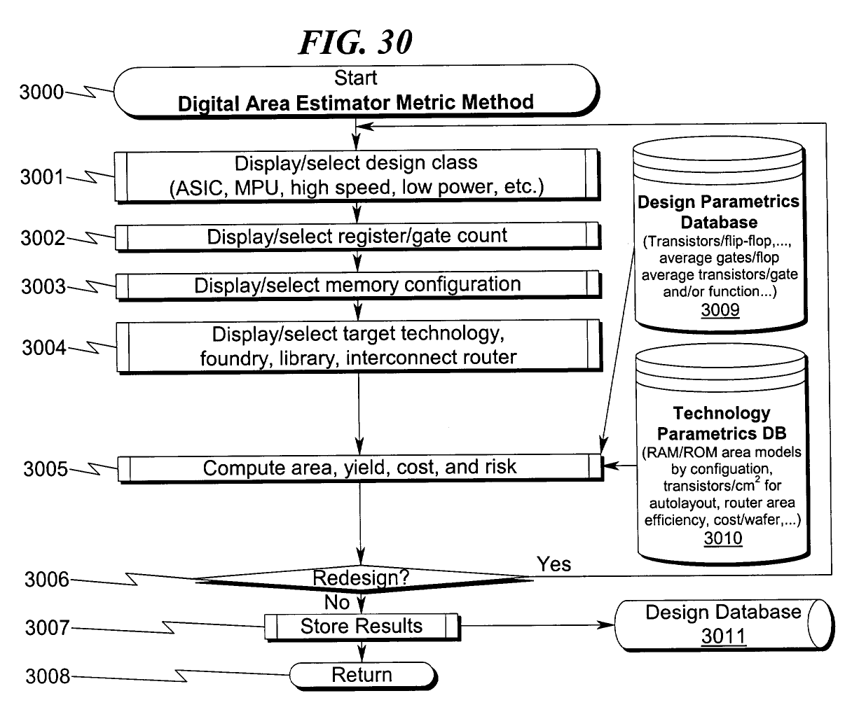

As illustrated in FIG. 30 (3000), an exemplary digital area estimator metric method might include the following steps:

(1) Displaying and/or selecting the design class for the given functional specification (ASIC, MPU, high speed, low power, small die area, low cost, etc.) (3001);

(2) Displaying and/or selecting the register count for the design (3002);

(3) Displaying and/or selecting the memory configuration for the design (3003);

(4) Displaying and/or selecting the target technology, foundry, library, and/or interconnect router for the design (3004);

(5) Calculating the die area, yield, and design/fabrication/manufacturing risk associated with the final design (3005) using information from a design parametrics database (3009) and/or a technology parametrics database (3010);

(6) Determining if a product redesign is necessary and if so proceeding to step (1) (3006);

(7) Storing the results of the estimator metric (3007) in a design database (3011).

One skilled in the art will recognize that these steps may be added to or subtracted from and rearranged with no loss of generality.

Analog Area Estimator Metric Method (3100)

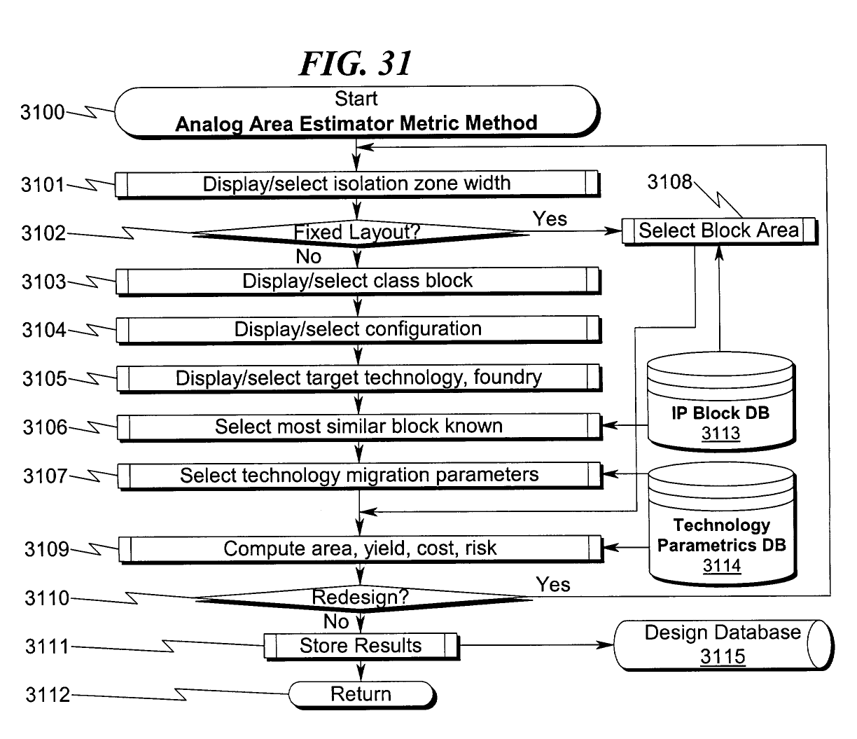

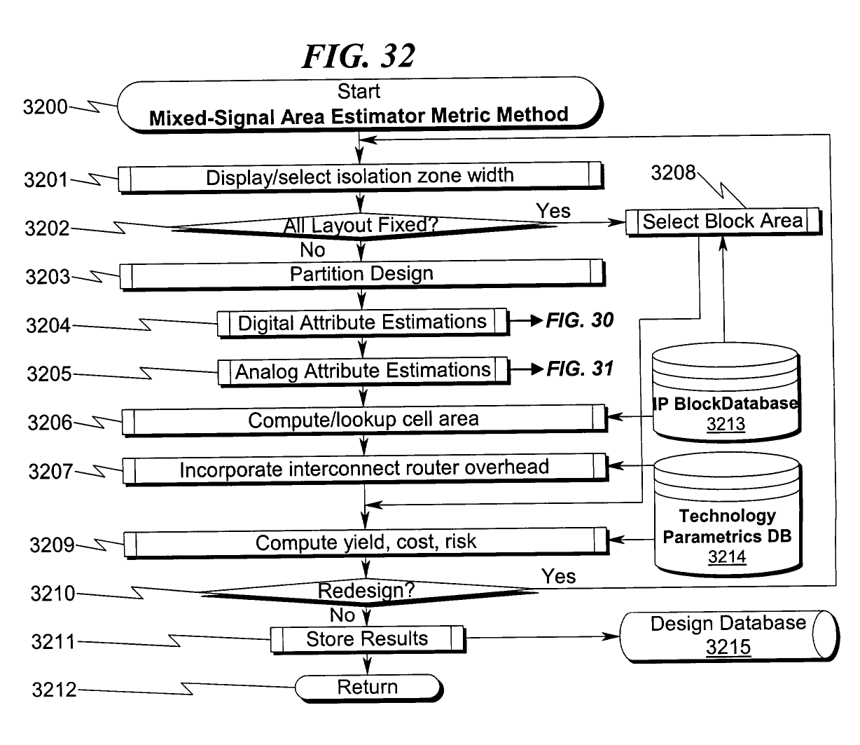

As illustrated in FIG. 31 (3100), an exemplary analog area estimator metric method might include the following steps:

(1) Displaying and/or selecting an isolation zone width for the design to minimize noise coupling to the analog circuitry (3101);

(2) Determining if the analog IP block has a fixed layout, and if so, proceeding to step (8) (3102);

(3) Displaying and/or selecting the class (functional category) for the analog block such as OP-AMP, D/A converter, voltage regulator, etc.), and their associated design considerations (3103);

(4) Displaying and/or selecting the analog configuration for the given IP blocks (number of A/D conversion bits, regulator compliance, speed, power, etc.) to permit determination of potential matches to the system requirements (3104);

(5) Displaying and/or selecting the target technology and/or foundry for the system design (3105);

(6) Displaying and/or selecting analog IP blocks that are most similar to the system being designed (3106) using an IP blocks information database (3113);

(7) Selecting technology migration parameters to define potential paths for higher performance and/or higher integration levels (3107) using a technology parametrics database (3114) and proceeding to step (9);

(8) Selecting a predetermined and/or parameterized IP block area (3108) from an IP block information database (3113);

(9) Calculating the die area, yield, cost, and design/fabrication/manufacturing risk associated with the final design (3109) using a technology parametrics database (3114);

(10) Determining if a product redesign is necessary and if so proceeding to step (1) (3110);

(11) Storing the results of the estimator metric (3111) in a design database (3115).

One skilled in the art will recognize that these steps may be added to or subtracted from and rearranged with no loss of generality.

Mixed-Signal Area Estimator Metric Method (3200)

As illustrated in FIG. 29 (2900), an exemplary mixed-signal area estimator metric method might include the following steps:

(1) Displaying and/or selecting an isolation zone width for the design to minimize noise coupling to the analog circuitry (3201);

(2) Determining if the analog IP block has a fixed layout, and if so, proceeding to step (8) (3202);

(3) Partitioning the system design in to analog IP and digital IP blocks for further analysis (3203);

(4) Calculating digital IP block areas using an appropriate attribute estimation metric (3204);

(5) Calculating analog IP block areas using an appropriate attribute estimation metric (3205);

(6) Computing and/or looking up IP cell areas for known IP cell blocks (3206) using an IP blocks information database (3213);

(7) Calculating interconnect router overhead (3207) using a technology parametrics database (3214) and proceeding to step (9);

(8) Selecting a predetermined and/or parameterized IP block area (3208) from an IP block information database (3213);

(9) Calculating the die area, yield, cost, and design/fabrication/manufacturing risk associated with the final design (3209) using a technology parametrics database (3214);

(10) Determining if a product redesign is necessary and if so proceeding to step (1) (3210);

(11) Storing the results of the estimator metric (3211) in a design database (3215).

One skilled in the art will recognize that these steps may be added to or subtracted from and rearranged with no loss of generality.

### Preferred Application: Disk Drive Interface

### Prior Art Contrast (4100)

The present invention may be advantageously applied to ASIC/SOC disk drive interfaces in a wide variety of contexts. Before beginning a discussion of these preferred embodiments, it is instructive to review the state of the prior art.

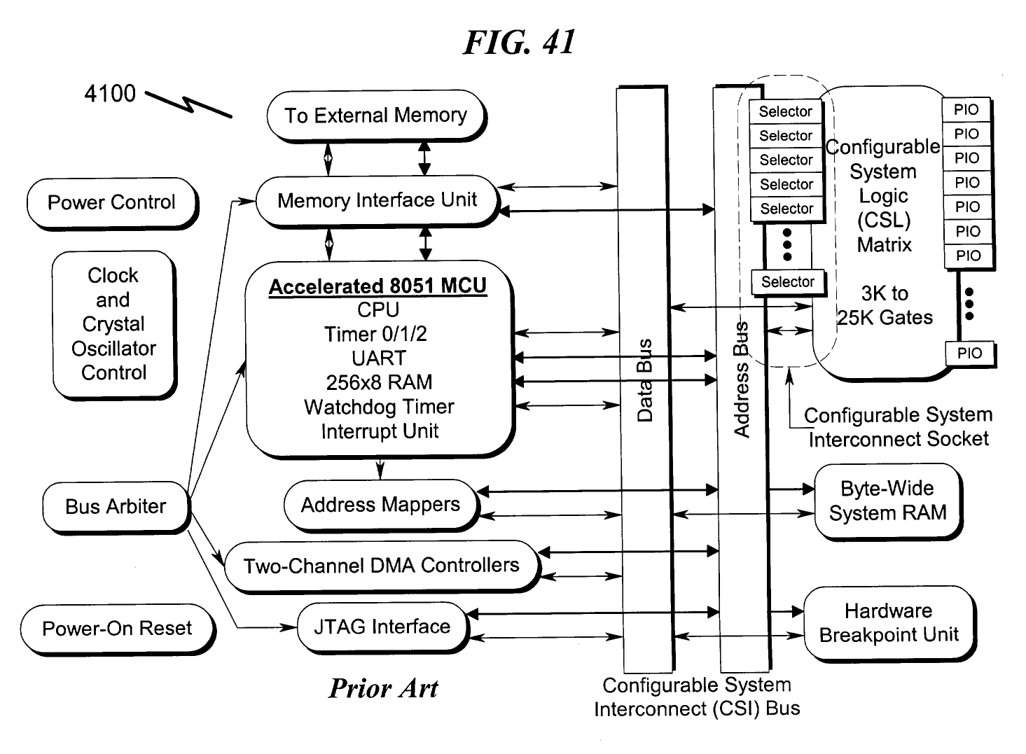

The approach taken by the prior art in the integration of analog and digital blocks on a single IC is best illustrated in FIG. 41 (4100). Here it can be seen that a variety of elements such as power control, oscillator control, power-on reset, bus arbiters, timers, UARTs, DMA controllers, RAM, and logic are placed on a single integrated circuit in a fixed system configuration.

The state of the prior art with respect to reconfigurability in or design modification in this context is generally limited to situations where some configurable system logic (CSL) matrix or some other FPGA-type array is integrated on chip and permits some minimal amount of reconfiguration either in the field or at the factory. This configuration, while easy to manufacture, is severely limited with respect to customer requirements in that specific system components needed may not be present in the SOC, and additionally some components that are not required are included irrespective of customer requirements.

Thus, the gist of the prior art is that to achieve optimal levels of manufacturing and associated design resources, fixed sets of system functions are integrated on a single chip in an attempt to meet a wide variety of customer demands and requirements. While this may make sense for some large volume manufacturers, it makes the integration of these SOC subsystems into larger systems more difficult and lacks cost effectiveness for large volume production efforts.

The present invention breaks with this paradigm by permitting exact customer requirements to be mapped to brokered IP blocks that are then integrated into a single chip SOC that is both efficient and economically designed, integrated, manufactured, and tested. Furthermore, the full integration of simulation tools and automatically generated simulation profiles permits these SOC components to be designed at a higher architectural level than previously possible.

### Overview

The remainder of this section will discuss a typical application of the present invention teachings as applied to integrated disk drive interfaces and controllers. Traditional disk drive interfaces and controllers incorporated a variety of components such as head preamplifiers, servo motor controls, spindle motor controls, data separators, ECC error correction devices, interface logic support, and memory. Traditional design methodologies dictated that due to the high digital and motor noise associated with this environment, that these system blocks generally be implemented in separate integrated circuits.

The following sections discuss a variety of preferred system contexts in which the present invention is capable of higher levels of integration than possible with the prior art. Specifically, the present invention teaches that a SOC can be fabricated that incorporates all the hard disk drive electronics on a single chip, incorporating both the analog and digital as well as power devices required for motor and servo control. This level of integration is not possible with the prior art, both because optimized levels of integration possible with the present invention are not available, as well as because techniques used to promote SOC integration are not taught by the prior art. Additionally, the use of VCPRS techniques as integrated into the present invention design techniques permits higher performance and higher levels of integration than possible using the prior art.

### SOC Integrated Ethernet Interface (4200)

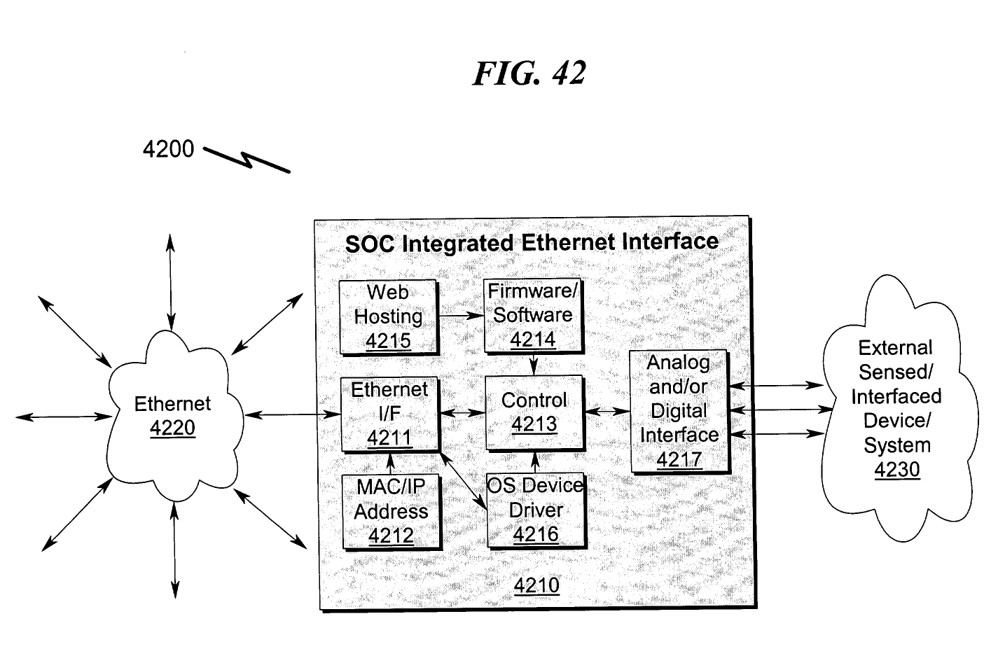

As generally illustrated in FIG. 42 (4200), one embodiment of a SOC as taught by the present invention teachings is an integrated Ethernet interface (4210) that permits an Ethernet (4220) physical interface to communicate with a generalized external sensed/interface device/system (4230).

Note the level of integration in this embodiment. The Ethernet (4220) communicates with an on-chip interface (4211) having a MAC address (4212) and integrated interface control logic (4213). Additionally, the use of on-board firmware/software (4214) and/or web hosting (4215) in conjunction with operating system drivers (4216) permit a much higher level of integration and architecture development than possible with existing Ethernet interface hardware. The outside-world interface (4217) could incorporate any number of analog and/or digital interfaces as assembled by the IP brokering system described herein.

The present invention specifically anticipates that the integrated SOCs described herein (4210, 4310, 4410, 4510, 4610) could be integrated in a cable and/or connector assembly for direct coupling to an external device such as a disk drive, Ethernet, or other peripheral interface.

### SOC Ethernet IDEISCSI Interface (4300)

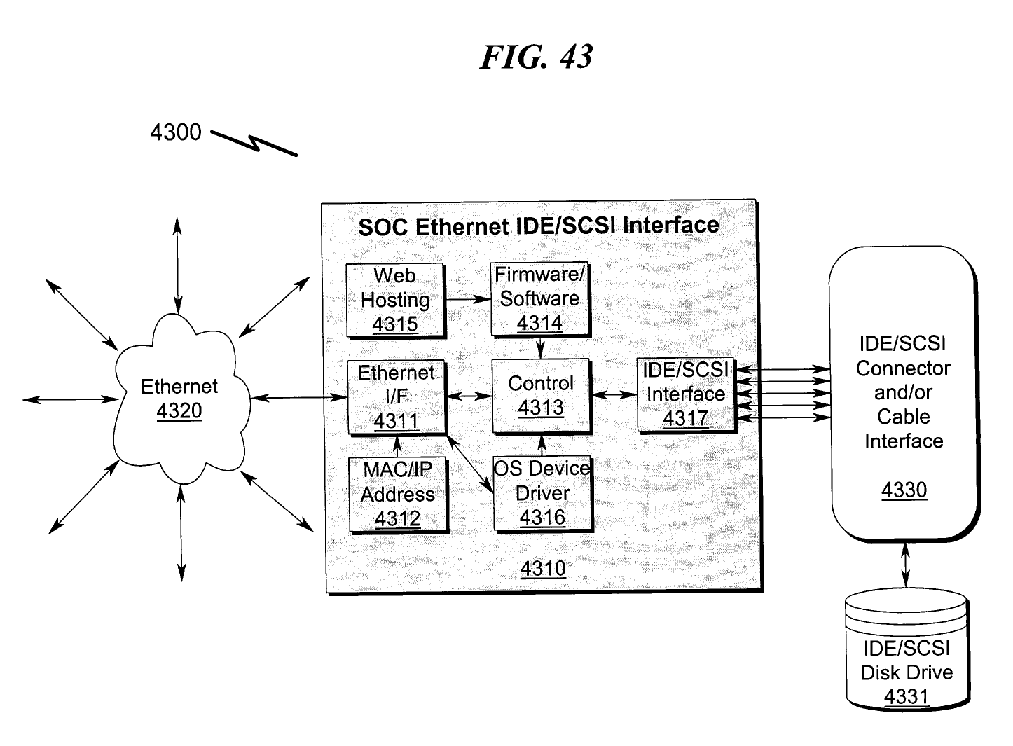

As generally illustrated in FIG. 43 (4300), another embodiment of a SOC as taught by the present invention teachings is an integrated Ethernet IDE/SCSI interface (4310) that permits an Ethernet (4320) physical interface to communicate with an IDE/SCSI connector and/or cable interface (4330) and ultimately an IDE/SCSI disk drive (4331).

Note in this embodiment the high level of software integration possible permits existing IDE/SCSI disk drives (4331) to be directly tied to the Ethernet (4320) and thus be made available on a network-wide basis without the need for additional software or operating system support. The obvious advantage in this application is that existing IDE/SCSI disk drives may be converted for use with Ethernet access without additional hardware or software support.

### SOC IDE/SCSI Disk Drive Interface (4400)

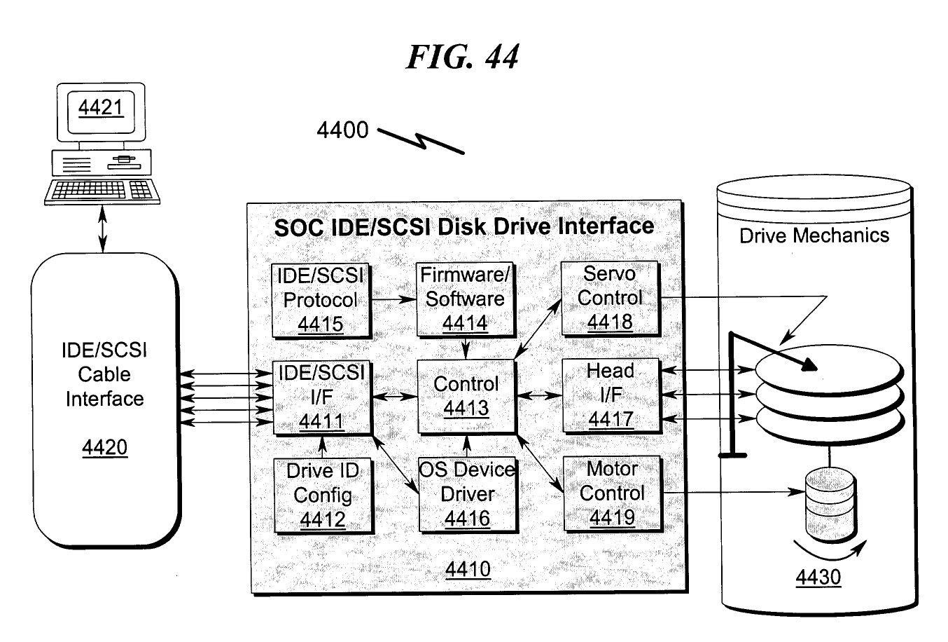

As generally illustrated in FIG. 44 (4400), another embodiment of a SOC as taught by the present invention teachings is an integrated IDE/SCSI Disk Drive interface (4410) that permits an IDE/SCSI (4420) physical interface to communicate with disk drive mechanics (4430).

Note in this embodiment the high level of software integration possible permits tight integration of head interfaces (4417), servo control (4418), and/or motor control (4419) on a single chip under the control of on-board firmware/software (4414), operating system drivers (4416), and/or control logic (4413). Protocols to support IDE/SCSI (4415) and other disk drive interface formats are anticipated. The IDE/SCSI interface (4411) and associated configuration/control/diagnostics (4412) are of course determined based on the target drive interface being emulated.

The obvious advantage in this application is that existing IDE/SCSI disk drive mechanics may be cost reduced by using a single SOC to implement all drive functions at a higher architectural level than is currently possible with the prior art.

### SOC Ethernet Disk Drive Interface (4500)

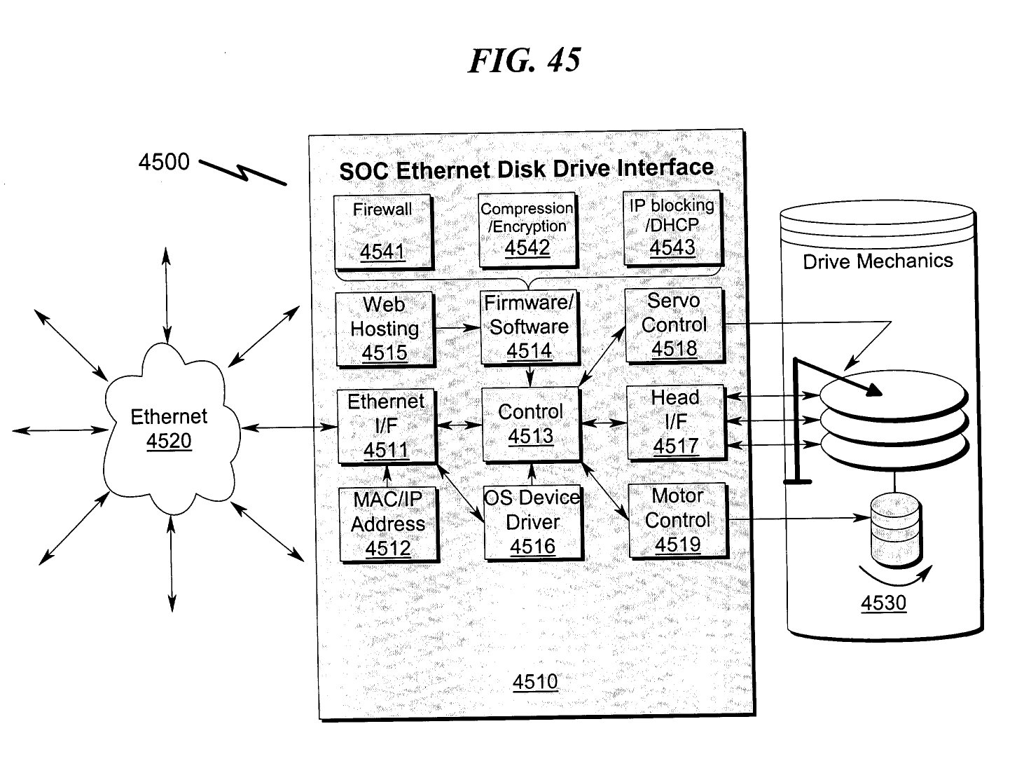

As generally illustrated in FIG. 45 (4500), another embodiment of a SOC as taught by the present invention teachings is an integrated Ethernet Disk Drive interface (4510) that permits an Ethernet (4520) physical interface to communicate with disk drive mechanics (4530).

Note in this embodiment extends the integration level of FIG. 44 (4400) by incorporating an on-chip Ethernet interface (4511) in conjunction with additional firmware/software (4514) which may include a firewall (4541), compression and/or encryption (4542), and/or IP blocking and/or DHCP (4543).

The obvious advantage in this application is that this design approach permits a single chip solution to attaching mass storage (of any variety) directly to a distributed network such as Ethernet. The prior art does not teach this level of integration and instead tends to place functionality for higher-level drive access functions in remote systems. The present invention integrates these functions in the disk drive to both reduce costs and improve system performance by permitting distribution of the data access function to the individual disk drive elements in a distributed storage array network.

### SOC Wireless Disk Drive Interface (4600)

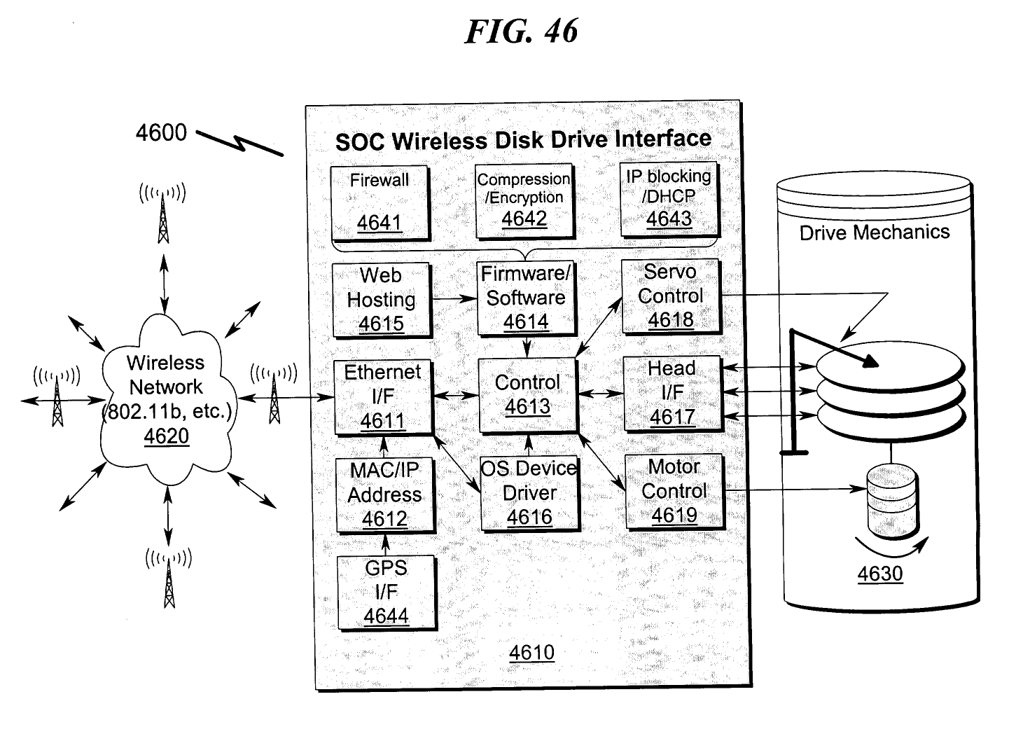

As generally illustrated in FIG. 46 (4600), another embodiment of a SOC as taught by the present invention teachings is an integrated Wireless Disk Drive interface (4610) that permits a wireless network (4620) physical interface to communicate with disk drive mechanics (4630).

Note in this embodiment extends the integration level of FIG. 45 (4500) by incorporating an on-chip wireless interface (4611) which permits a greater degree of mobility with respect to the target drive mechanics (4630) than possible with the prior art. This configuration also permits for mobile mass storage devices to communicate in a wireless fashion with a wide variety of existing communication systems and networks.

The obvious advantage in this application is that this design approach permits greater data mobility than previously possible. Additionally, the incorporation of optional GPS systems (4644) on-chip permits tracking of the data device as it migrates geographically.

### Preferred Application: SOC Set-Top-Box

### Overview (4700)

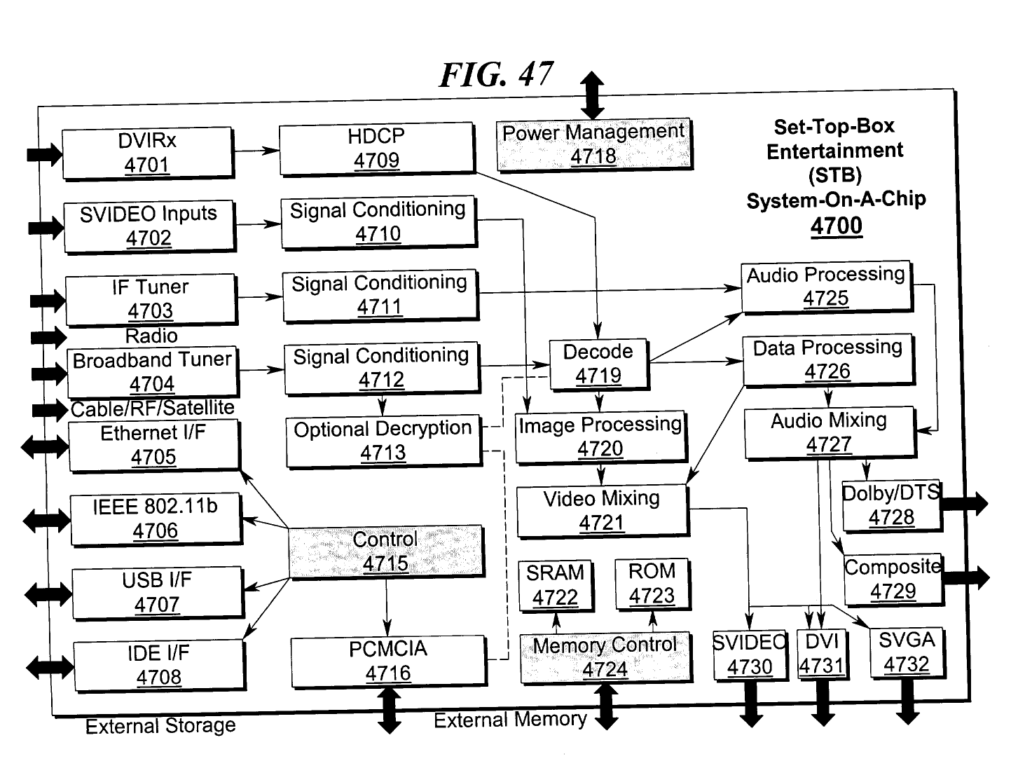

As generally illustrated in FIG. 47 (4700), another embodiment of a SOC as taught by the present invention teachings is an integrated Set-Top-Box audio/video interface that integrates a wide variety of analog and digital functions (4701, 4702, 4703, 4704, 4705, 4706, 4707, 4708, 4709, 4710, 4711, 4712, 4713, 4715, 4716, 4718, 4719, 4720, 4721, 4722, 4723, 4724, 4725, 4726, 4727, 4728, 4729, 4730, 4731, 4732) together on a single chip that heretofore had to be integrated using PCB and separate IC techniques.

### Preferred Application: Digital Video Interface

### Overview (4800)

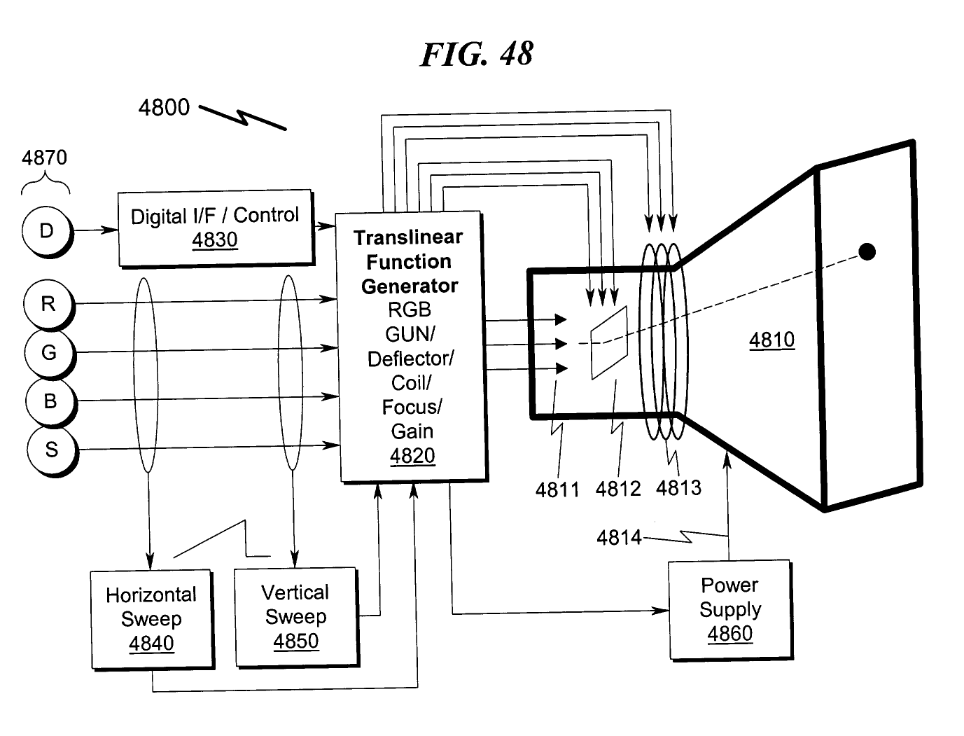

As generally illustrated in FIG. 48 (4800), another embodiment of a SOC as taught by the present invention teachings is an integrated video display calibrator which permits a CRT or other display device (4810) to be calibrated with respect to a variety of exemplary performance parameters such as gun intensity (4811), deflector voltages (4812), coil current (4813), focusing, and power supply potential (4814). The adjustment of these parameters as taught by the prior art is a highly nonlinear analog problem and is generally accomplished using coils, variable capacitors, and other like techniques.

The present invention teaches that complete linearization and calibration of display device (4810) can be achieved via the use of a translinear function generator (4820) that is configured via use of a digital interface control circuit (4830). This approach uses digital control (4830) of a translinear function array (4820) that takes two dimensional inputs from horizontal (4840) and vertical (4850) sweep generators to make gain adjustments in gun (4811), deflector (4812), coil (4813), and power supply (4860) values. The R/G/B/S inputs normally associated with a standard video input are individually processed by the translinear array (4820) so as to provide for completely independent control and calibration of all three composite video signals.

Key advantages to the present invention approach as compared to the prior art include the ability in some circumstances to integrate all the high voltage drive electronics on a single silicon chip as well as the capability of improving CRT an other display yields by compensating for weak or non-conforming display pixels by adjusting the transfer function of the translinear array (4820). This level of control and compensation is completely absent in the prior art. Finally, the integration level provided by this approach far exceeds anything available in conventional analog and/or digital television and video display technologies currently available. With the advent of large screen televisions and display devices, there is a long-felt need for complete integration of all video display/calibration functions that has yet to be met by the prior art.

### System

As generally illustrated in FIG. 48 (4800), the video display calibrator embodiment (4800) of the present invention includes a digital interface and control means (4830), translinear function generator means (4820), horizontal sweep generator means (4840), and vertical sweep generator means (4850). These are connected as illustrated in FIG. 48 wherein the digital interface and control means (4830) permits control of the translinear function generator means (4820) through a digital interface, the translinear function generator means (4820) accepts input from the horizontal sweep generator means (4840) and the vertical sweep generator means (4850), and the translinear function generator means (4820) makes time-varying gain adjustments to the inputs (4811, 4812, 4813) of the video display means (4810).

### Method (8100)

The video calibrator system (8000) may also incorporate an exemplary method (8100), the steps of which include:

(1) configuring a translinear function generator through a digital interface (8101);

(2) accepting continuous input from a horizontal sweep generator into said translinear function generator (8102);

(3) accepting continuous input from a vertical sweep generator into said translinear function generator (8103);

(4) applying translinear functions in said translinear function generator to said horizontal sweep generator input and generating a translated horizontal sweep output (8104);

(5) applying translinear functions in said translinear function generator to said vertical sweep generator input and generating a translated vertical sweep output (8105);

(6) applying translinear functions in said translinear function generator to the results of said translated horizontal sweep output and said translated vertical sweep output and generating analog control signal outputs for a video display device (8106).

Optional Embodiments/Configurations

The video calibration method detailed above (8100) may be augmented in part or whole by any of the following modifications:

(1) The translinear function generator may under analog control.

(2) The translinear function generator may incorporate closed-loop performance feedback and auto-calibrates.

(3) The video display device may be a CRT.

(4) The video display device may be a LCD.

(5) The video display device may be a plasma display.

### Preferred Application: Network Attached Storage

### Overview

As illustrated generally in FIG. 43 (4300), FIG. 44 (4400), FIG. 45 (4500), and FIG. 46 (4600), the present invention directly anticipates the use of SOC integrated circuits to interface mass storage devices at a variety of integration levels and with a variety of interfaces. What is not apparent from FIGS. 42-46 is that by pushing this level of integration to a higher level than possible with the prior art a new level of functionality is possible in mass storage.

Historically speaking, the prior art generally taught that a computer system wanting to communicate with a mass storage device such as a hard disk drive, tape drive, or the like must have an interface card designed and manufactured to communicate with the mass storage device via the computer system bus. For example, in the beginning days of personal computers (PCs) much of the hard drive electronics, including drive interfacing logic, resided on a printed circuit board that plugged into the PC computer system expansion bus. As technology developed further, the drive interface logic was moved to the hard drive and standards such as SCSI (small computer systems interconnect) and IDE (integrated drive electronics) emerged. However, the technology stopped at this point, due to a variety of technology factors that prevented further levels of integration and additionally because mass storage device data formats were generally inextricably linked to particular operating systems and their particular file hierarchy and encoding formats.

### X-Drive OSI Model—Direct Hard Drive Interface (4900)

Prior Art (4910)

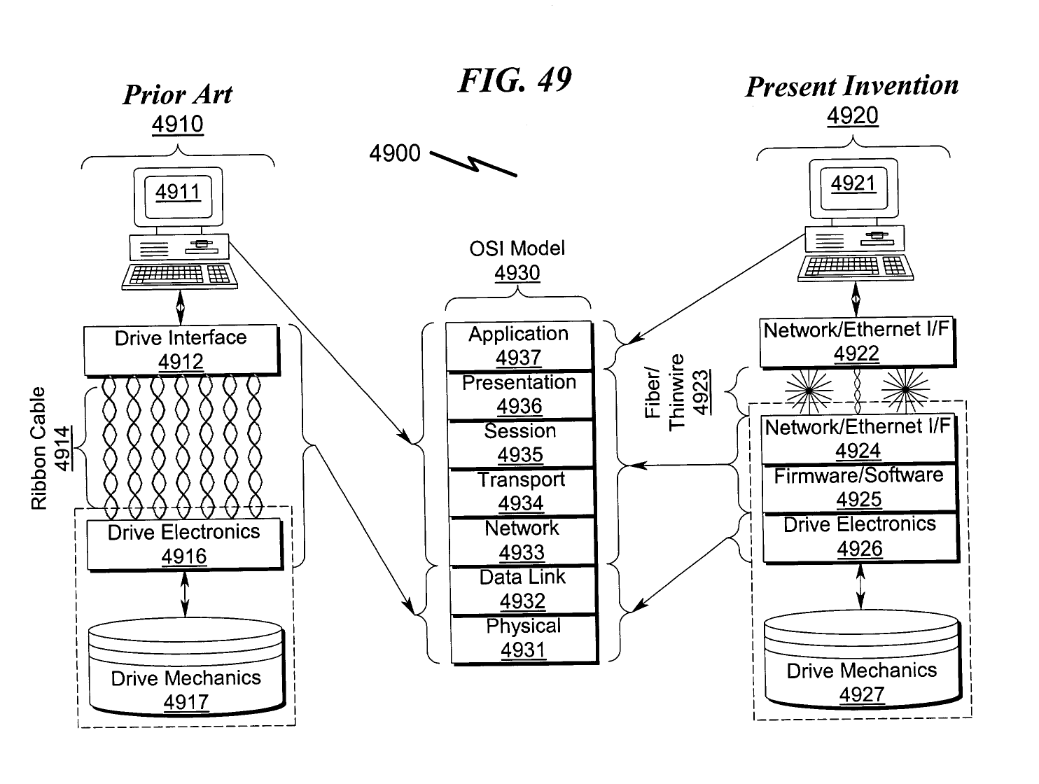

As illustrated in FIG. 49 (4900), the prior art (4910) generally taught that a computer system (4911) required the use of a drive interface (4912), ribbon cable (4914), and drive electronics (4916) to communicate with hard drive mechanics (4917) or a similar mass storage media. Note that in this case the drive electronics may be integrated with the drive mechanics, but this was the highest level of integration possible using prior art teachings.

Within this context, from an Open System Interconnect (OSI) Model (4930), the higher level OSI stack element comprising the Network (4933), Transport (4934), Session (4935), Presentation (4936), and Application (4937) are controlled by the computer system itself, with the lower physical (4931) and data link (4932) layers being incorporated within drive interface (4912), cabling (4914), and drive electronics (4916). This partitioning of the OSI Model is significant because it means that much of the work associated with managing the structure, information content, and access to the drive mechanics (4917) must be borne by the computer system (4911). Computer systems (4911) having heavy mass storage traffic or who have large numbers of drives to manage become significant performance bottlenecks using this architecture. Additionally, the requirement that each target disk drive use some form of parallel cabling (4914) with associated drive interface(s) (4912) creates a significant cable management as well as extensibility problem for large mass storage applications.

Present Invention (4920)

In contrast, the present invention embodiment (4920) illustrated (“X-Drive”) provides that the computer system (4921) communicates with all mass storage elements using a network interface (4922) that could be Ethernet, thin-wire, fiber, or some other technology (4923). In contrast to the prior art, the present invention teaches integration of the network interface (4924) into the mass storage device in conjunction with corresponding firmware/software (4925) to control both the network interface (4924) and associated drive electronics (4926). In this way the computer system and its associated hardware interface (4922) is totally relieved from concern over control of the drive mechanics (4927) which is now under oversight of local firmware/software (4925).

In contrast to the prior art (4910), the present invention (4920) restructures the Open System Interconnect (OSI) Model (4930) responsibilities for data control and access within this framework. In this scenario, only the Application level (4937) is the purview of the computer system (4921), with the other higher level OSI stack elements comprising the Network (4933), Transport (4934), Session (4935), and Presentation (4936) layers being controlled by the network interface (4924) and/or firmware/software (4925) within the mass storage device itself, with the lower physical (4931) and data link (4932) layers being incorporated within drive electronics (4926) in this context. This repartitioning of OSI responsibilities means that overhead associated with storage management is now made the direct responsibility of the mass storage device.

### X-Drive OSI Model—DASD RAID Controller (5000)

Prior Art (5010)

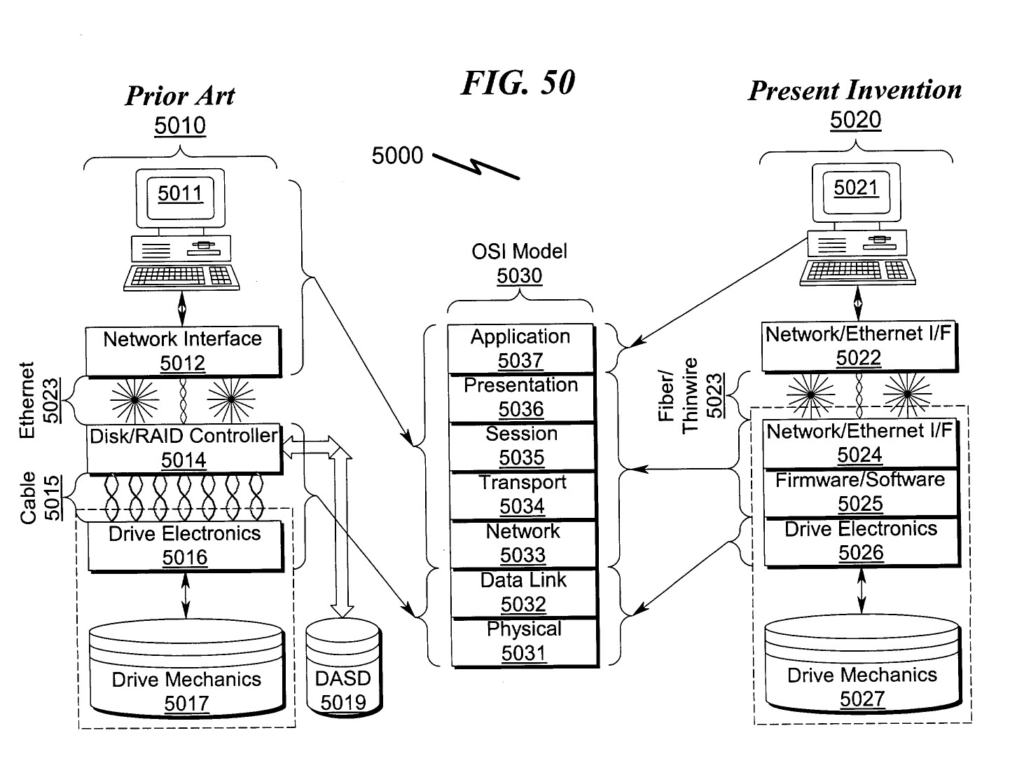

As illustrated in FIG. 50 (5000), the prior art (5010) also teaches that one or more hard drives incorporating drive electronics (5016) and/or drive mechanics (5017) can be interfaced to a disk/RAID controller (5014) that communicates to a computer system (5011) via a network interface (5012). These systems are generally designed to service “farms” of direct access storage devices (DASD) (5019) for enterprise wide computing applications.

However, the problem from an architecture standpoint in this environment is that the systems as described still relegate only the lower protocol levels such as Physical (5031) and Data Link (5032) to the controller (5014) and/or drive electronics (5016).

Present Invention (5020)

In contrast, the present invention (5020) (“X-Drive”) envelops the drive mechanics (5027) with firmware/software (5025) that incorporate higher levels of the OSI model such as the Network (4933), Transport (4934), Session (4935), and Presentation (4936) layers to ensure that the burden of supporting these layers is borne by the data storage unit and not the host computer system (5021).

### Drive-to-Drive Communication (5100)

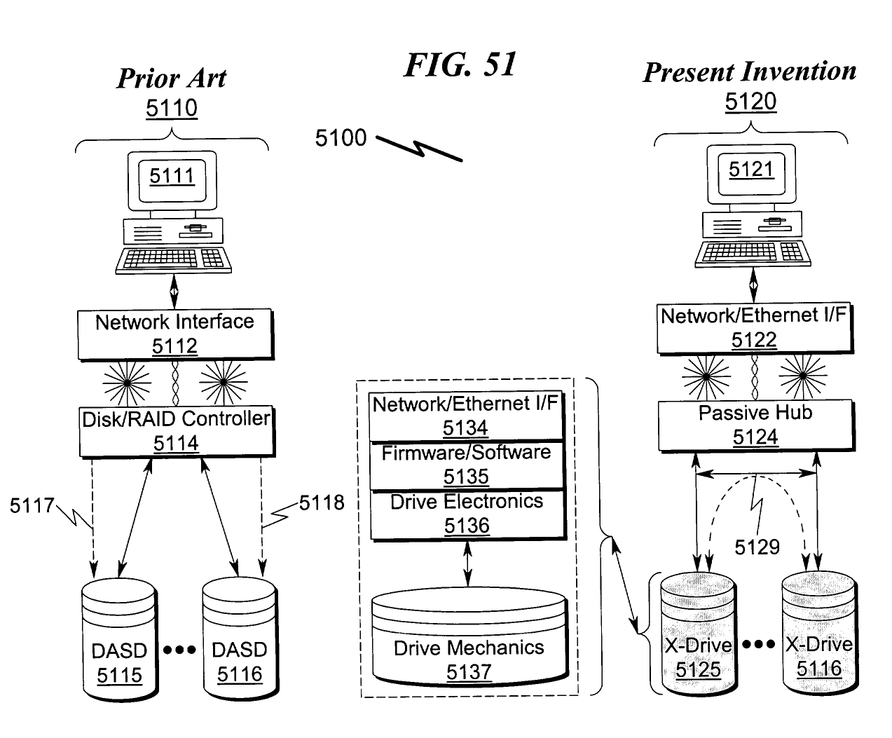

One aspect not apparent within the illustrations of FIG. 49 (4900) and FIG. 50 (5000) is that by distributing the higher levels of the OSI Model directly to the disk drive or mass storage device, it is possible to achieve peer-to-peer communication in a way not possible with the prior art. FIG. 51 (5100) illustrates this concept in terms of a RAID architecture.

Referencing FIG. 51. (5100), the prior art (5110) teaches that a computer may communicate via a network interface (5112) to a disk/RAID controller (5114) that controls one or more direct access storage devices (DASD) (5115, 5116). RAID functionality is generally achieved by having the RAID controller (5114) directly communicate with the DASD (5115, 5116) to synchronize and backup data (5117, 5118). This requires active intervention of the RAID controller (5114) and also presents a point of failure for the storage system.

In contrast, the prior art (5120) teaches that instead of a RAID controller (5114), a passive and/or active hub and/or router (5124) can be utilized. In this circumstance, all the RAID functionality is contained within the integrated disk drives (5125, 5126) (“X-Drive(s)”) by virtue of the embedded firmware/software (5135) detailed previously. This integration of higher OSI model protocol levels within the disk drive (5125, 5126) permits DIRECT communication (5129) between the disk drives (5125, 5126) without the need for intervention of any RAID controller (5114). The resulting system has a higher reliability and maintainability since no central point of failure exists. Furthermore, the disk drives (5125, 5126) may be relocated without any impact on RAID functionality, as long as the disk drives (5125, 5126) have access to each other via some networking/communications means.

### Spatial Diversity (5200)

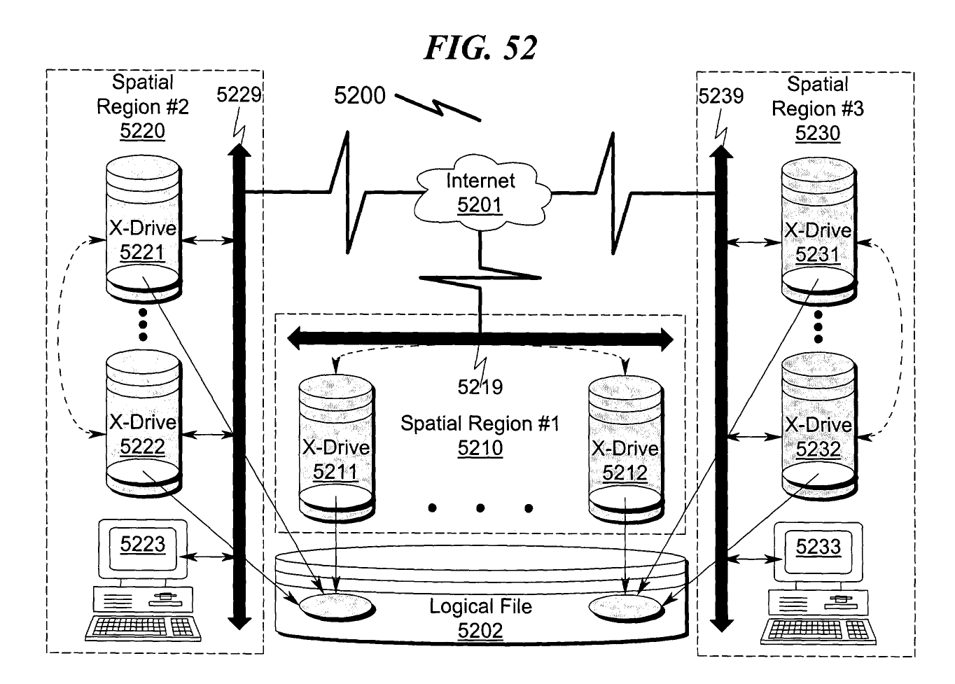

As illustrated generally in FIG. 52 (5200), the present invention teaches that X-Drives may be incorporated into spatially diverse regions (5210, 5220, 5230) supported by corresponding communication backbones (5219, 5229, 5239). This spatial diversity permits groups of spatially diverse drives (5211, 5212, 5221, 5222, 5231, 5232) to contain pieces of a logical file (5202) that comprises a given data set that may be accessed by a variety of computer systems (5223, 5233) who are either a part of these regions or who access the network via a cooperative Internet (5201) or other communications network.

This form of spatial diversity is significantly different than taught in the prior art because the cooperative nature between the spatially diverse X-Drives (5211, 5212, 5221, 5222, 5231, 5232) themselves is the key to providing for access to the logical data file (5202) information by any authorized computer system (or other peer) on the network. What is significantly different in this topology as compared to prior art teachings is that each X-Drive in this topology has information concerning its spatial geographic location and can thus automatically ensure that data comprising the logical file (5202) is backed up on multiple X-Drives in a spatially diverse fashion. This ensures that no single point of failure in the system prevents access to the information within the logical data file (5202).

### Portable Data Mobility (5300)

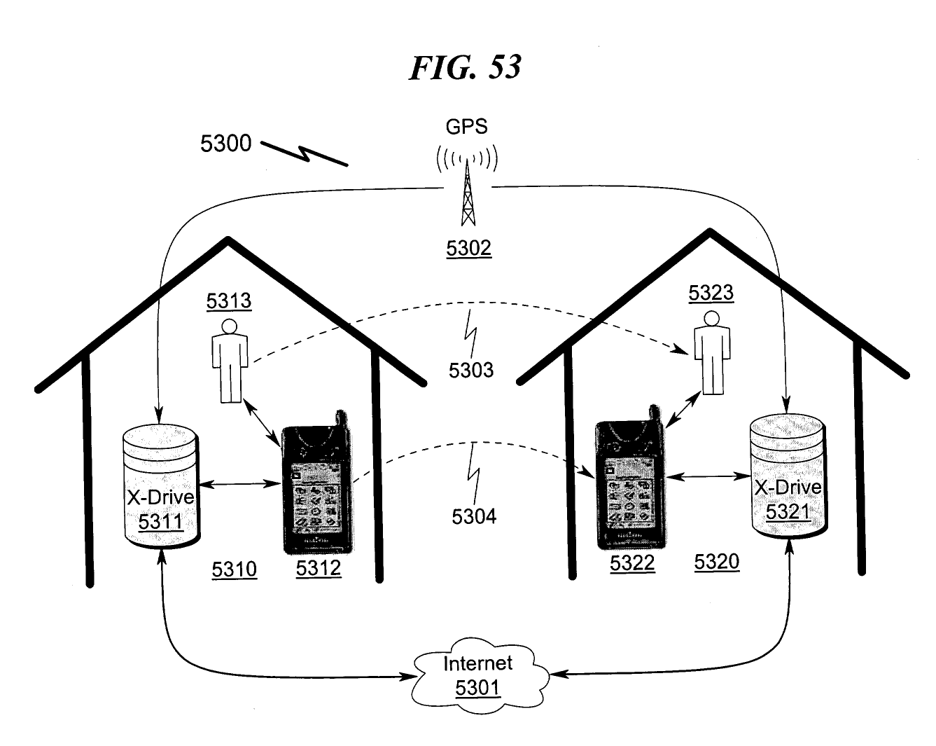

The concept of spatial diversity as illustrated in FIG. 52 (5200) may be expanded as illustrated in FIG. 53 (5300) to include portable data mobility over a spatially diverse (5310, 5320) geographic context. In this configuration, spatially diverse X-Drives (5311, 5321) cooperate over the Internet (5301) or some other communications media to synchronize data and provide data redundancy, backup, and/or spatially diverse data sets. Note that in this configuration as with most X-Drive configurations, the X-Drives (5311, 5321) communicate directly with each other over the communications media (5301) and have no need of a supervising disk or RAID controller to implement data access functions.

In the context illustrated in FIG. 53 (5300), a portable data access/display device (5312, 5322) may migrate (5304) from one locale (5310) to another locale (5320) or alternatively the data consumer (5313, 5323) may migrate (5303) from one locale (5310) to another locale (5320). The data access/display device in this context is anticipated to be a portable computer, PDA, palmtop computer, or any other access/display device or the like.

A key element in this configuration is the use of GPS information (5302) which is incorporated into each X-Drive (5311, 5321) to permit the drives to both realize their spatial diversity but also determine the optimal methodology of permitting rapid data access to the display device (5312, 5322) depending on which customer (5313, 5323) is accessing the logical data file. The ability to tag the X-Drives with GPS geographic data permits either the X-Drive (5311, 5321) to move geographically or the data access/display device (5312, 5322) to move geographically with equal ease. While a preferred communication method between the X-Drive (5311, 5321) and the data access/display device (5312, 5322) is wireless, the present invention is not limited to this communications method.

One significant advantage to this type of architecture is that it permits the data access/display device (5312, 5322) to have no local mass storage but rather leverage intelligent X-Drives (5311, 5321) to access distributed data over the Internet (5301) or some other communications media. Thus, laptops and the like could be made significantly lighter with corresponding lower power consumption given that they would not necessarily need to have hard drive storage for operating system and other data. This advantage is especially important for PDAs, pocket organizers, MP3 music players, digital cameras, and other types of consumer electronics that are sensitive to weight and size constraints.

### Spatial Location Identification

Exemplary System (5400)

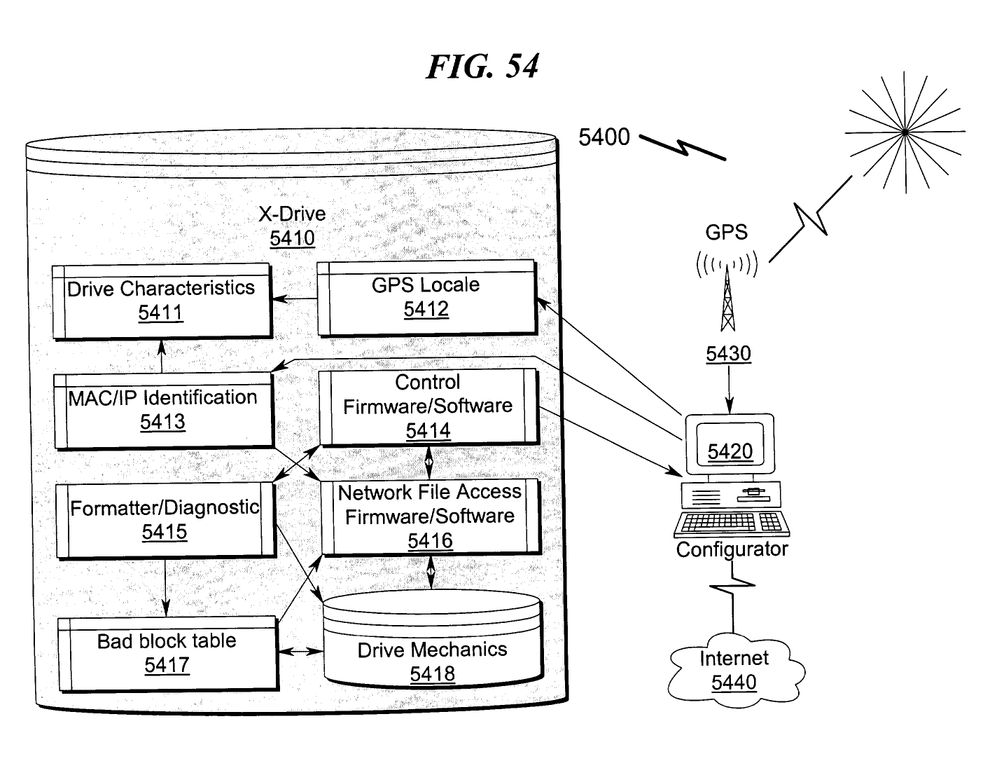

As indicated previously and illustrated in FIG. 54 (5400), several preferred embodiments of the present invention incorporate spatial location identification in the form of GPS positioning information in the X-Drive itself to facilitate automatic spatial data redundancy, backup, and a variety of advanced data access methodologies not presently available in the prior art. This concept will now be discussed in detail.

Within the context of network attached storage, an X-Drive (5410) as configured in FIG. 54 (5400) might include internal data storage for drive characteristics (5411) (size, speed, etc.), GPS locale (5412) (longitude/latitude, etc.), network MAC/IP identification (5413), as well as control firmware/software (5414) to communicate with a configuration computer (5420) that could provide GPS information either from a local GPS positioning system (5430) or the Internet (5440). Note that the MAC/IP address (5413) may also be configured remotely. Upon initial installation, the X-Drive (5410) would activate a formatter/diagnostic function (5415) to configure the drive bad block table (5417) after evaluating the status of the actual drive mechanics (5418).

Once configured with proper MAC/IP addresses and/or GPS information, the X-Drive now has information that uniquely identifies it as a separate storage entity with a corresponding spatial position relative to all other storage elements in the network. These two pieces of information may be used, for example, to ensure that the contents of a logical file are stored both locally and automatically on a spatially diverse mirror X-Drive. Furthermore, as a given file on one X-Drive is updated, it is automatically refreshed on the corresponding spatially diverse X-Drive. Issues such as file sharing, including record locking, are also anticipated to be elements of some preferred embodiments of this architecture.

Exemplary Method (5500)

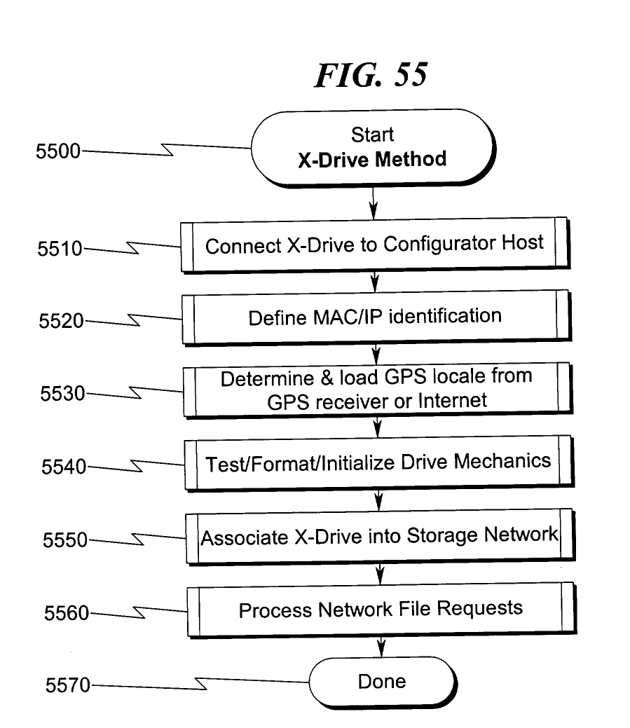

As illustrated in FIG. 55 (5500), the exemplary system of FIG. 54 (5400) can be implemented using an exemplary method that might incorporate the following steps:

(1) Connecting the X-Drive to a configuration host or to an attached network interface (5510);

(2) Defining the MAC/IP identification for the X-Drive (5520);

(3) Determining the GPS locale from a GPS receiver or the Internet and loading this information into the X-Drive (5530);

(4) Testing and/or formatting and/or initializing the X-Drive drive mechanics (5540);

(5) Associating the X-Drive into a storage network (5550); and

(6) Processing network file requests from remote X-Drives and/or data consumers/brokers (5560).

One skilled in the art will recognize that these steps may be added to or subtracted from and rearranged with no loss of generality. Generally speaking, the major steps in the above method include drive identification, testing/formatting/initializing, and network association.

Note that a major advantage to the approach defined above is that no operator interaction is required other than the manual connection operation in step (1). This permits storage to be added with relative ease in large enterprise environments where skilled personnel are at a premium. Note also that while the X-Drive is generally preferred to target hard drives, the illustrated concept is general enough to be applied to any mass storage device or computer peripheral with no loss of generality.

### File Access Method (5600)

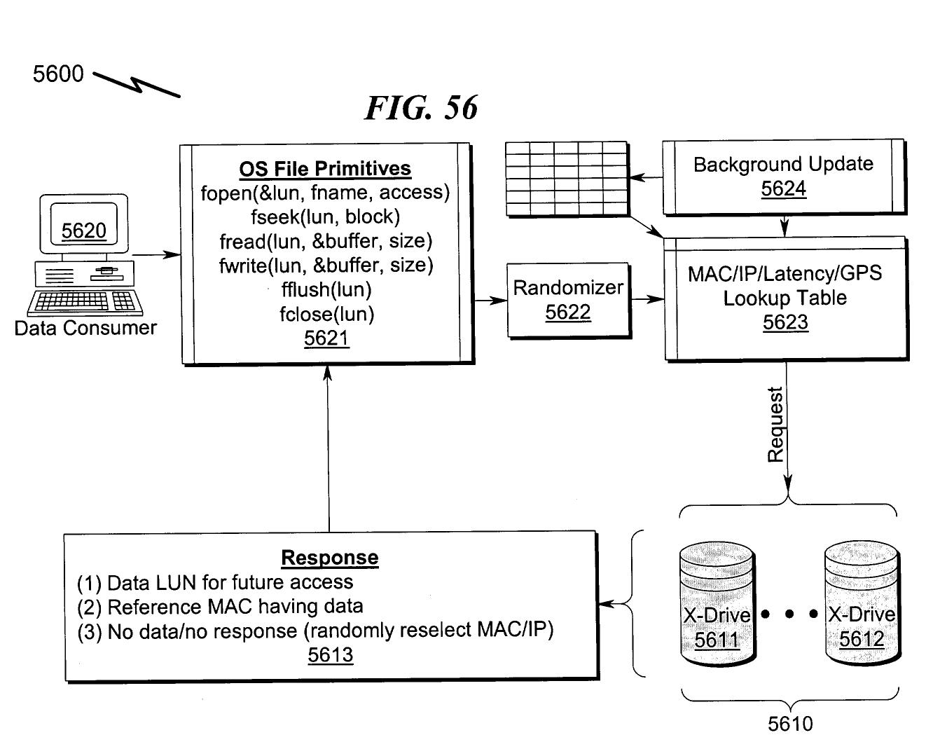

As illustrated in the exemplary system configuration of FIG. 56 (5600), the present invention teaches that an X-Drive (5610) storage area comprising one or more X-Drives (5611, 5612) can be used to implement file level data access across multiple computer systems (5620) in an enterprise environment. In this typical scenario, the data consumer (5620) utilizing a variety of standard operating system file primitives (5621) randomly selects (5622) an entry from a MAC/IP/Latency/GPS lookup table (5623) that is automatically updated by a background task (5624). This table provides MAC/IP and latency as well as GPS data for available X-Drives (5611, 5612).

Once a lookup table entry has been selected, the data access request is sent to the selected X-Drive (5611, 5612) who responds (5613) indicating that (1) the data has been located and a logical unit number is available for accessing the data, (2) the data is not available here, but available on yet another MAC address with corresponding LUN, or (3) no data is available or no response is possible in which case another randomly chosen MAC/IP address is selected. This scenario pushes the work associated with data lookup down to the disk drive level and relieves the data consumer (5620) from most of the housekeeping and data management functions associated with enterprise data management. Additionally, this level of integration also drastically reduces the manpower required to maintain data storage associated with the data consumer (5620). Mundane issues such as data mirroring, RAID, backups, data compression, disk defragmentation, etc. are handled automatically by the X-Drives on an individual and cooperative basis without the need for human intervention.

### Advantages

By pushing the integration level in the mass storage market higher, one would expect some of the following advantages to be present in one or more preferred invention embodiments:

Cost of peripherals such as hard drives would be lowered.

System reliability of mass storage devices would be increased due to lower chip count.

Power consumption for the overall system would be reduced and there would be greater potential for power saving measures by using power shutdown during idle periods of operation. VCPRS techniques mentioned previously would be especially useful in this context.

The data contained on a given mass storage device would become transparently available across operating system platforms and end-consumer interface devices. Since the proposed interface for the data on mass storage devices using the present invention is FILE based rather than SECTOR based as is the current state of the art, a given operating system or other interface would not be bothered by specific drive formatting or other factors, but would rather be just concerned with a proper path to the individual data file.

These exemplary advantages are not intended to limit the scope of the present invention but merely provide some exemplary advantages that in some circumstances serve to contrast the present invention with the prior art. One skilled in the art would no doubt determine other advantages that supplement this list.

### Preferred Application: Distributed Data Management

### Architecture

Overview (6500)

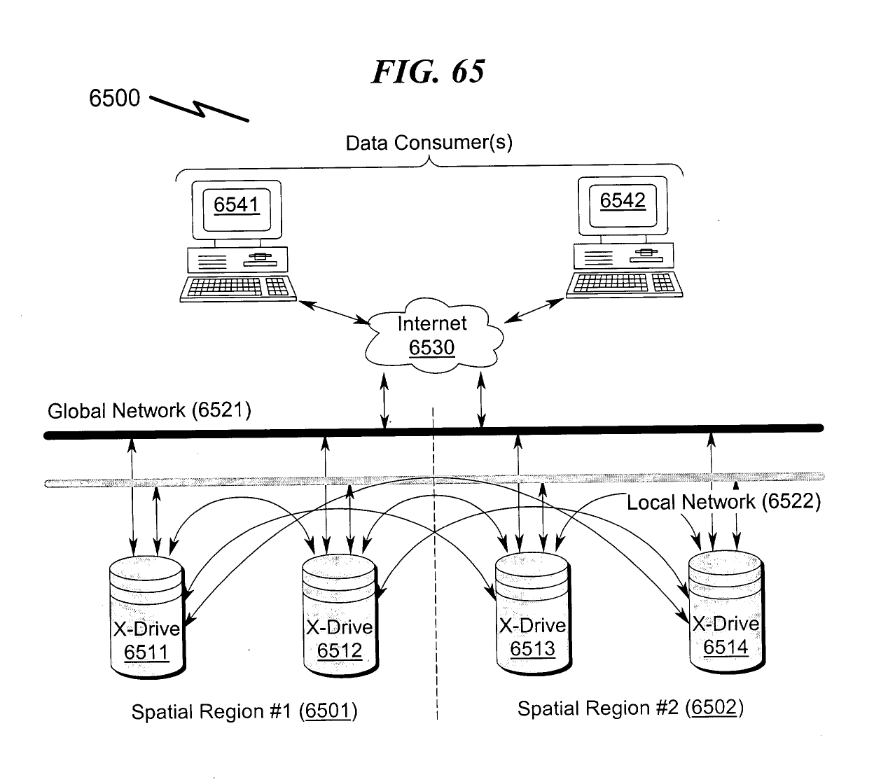

While the present invention may be applied in a variety of contexts, one preferred embodiment incorporates the use of previously described X-Drives in a distributed data management arrangement as illustrated in FIG. 65 (6500). In this context, a number of X-Drives (6511, 6512, 6513, 6514) may communicate via a global network (6521) and/or a local network (6522) to permit drive-to-drive communications outside the context of communication over the Internet (6530) to one or more data consumers (6541, 6542).

What is unique about this configuration (6500) as compared to the prior art is that each X-Drive (6511, 6512, 6513, 6514) may optionally incorporate multiple network interfaces to permit both a global network interface (6521) and a local network interface (6522). This permits redundant data access to each X-Drive (6511, 6512, 6513, 6514) should either network (6521, 6522) fail or become disabled. Thus, a single point of failure with respect to drive communications is eliminated.

Furthermore, the cooperation among each X-Drive (6511, 6512, 6513, 6514) at the drive level ensures that data is automatically mirrored, backups are automatically performed, and spatial data diversity (6501, 6502) is achieved. This level of failover/redundancy between diverse networks is necessary to support automatic disaster recovery in situations where natural disasters or terrorist attacks completely disable data access to a given geographic/spatial data center.

Note that one possible option in this scenario is to have automatic hardware/software failover in each X-Drive (6511, 6512, 6513, 6514) should the primary (6521) or secondary (6522) network interface fail. This would permit a graceful fallback in the event of a network system failure. Note that the cooperation between X-Drives (6511, 6512, 6513, 6514) occurs outside the context of a supervising operating system on the data consumers (6541, 6542).

Generalization (7300)

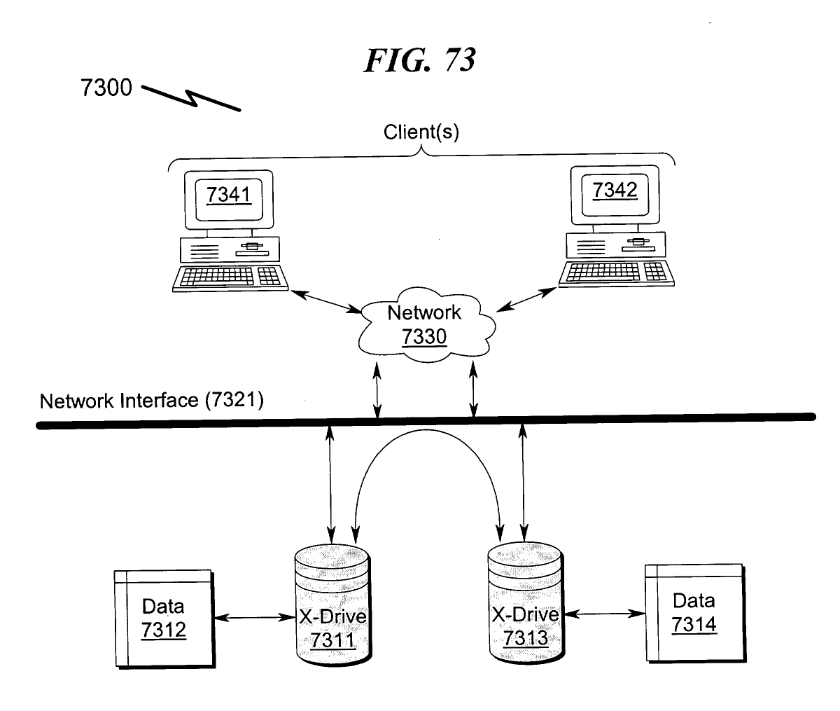

The architecture of the present invention may be generalized to that illustrated in FIG. 73 (7300), wherein a distributed data storage system comprising one or more X-Drives (7311, 7313) is connected (7321) to a network means (7330) to serve one or more clients (7341, 7342). In this configuration, the client means (7341, 7342) communicates to the X-Drive means (7311, 7313) through the network means (7330).

Within this configuration, the X-Drive means (7311, 7313) permits data (7312, 7314) resident on the X-Drive means (7311, 7313) to be accessed by the client means (7341, 7342) through the network means (7330). Key to the enhanced functionality of this configuration is the fact that the X-Drive means (7311, 7313) incorporates one or more OSI Model layers (Application, Presentation, Session, Transport, Network, Data Link, and/or Physical as detailed in FIG. 49 (4900) and FIG. 50 (5000)) to permit the X-Drive means (7311, 7313) to operate autonomously of the client means (7341, 7342). This autonomous operation of the X-Drive means (7311, 7313) permits the X-Drive means (7311, 7313) to be capable of controlling and brokering data access among multiple client means (7341, 7342) and/or X-Drive means (7311, 7313).

Geographic Diversity (7400)

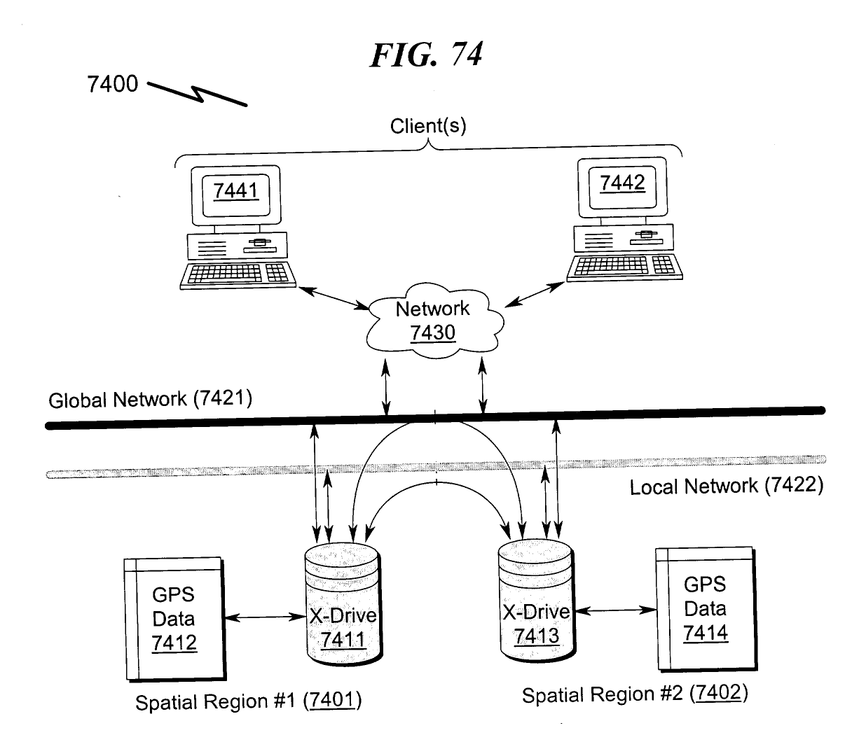

The architecture depicted in FIG. 73 (7300) may also take the form of a configuration as generally illustrated in FIG. 74 (7400) in which the X-Drives are geographically and/or spatially diverse. In this configuration (7400), a wide area network means (7430) spanning one or more spatial region means (7401, 7402) further comprising one or more local area network means (7422) connecting one or more X-Drive means (7411, 7414), each of the X-Drive means (7411, 7414) having local information regarding its geographic location (7412, 7414). This scenario permits the X-Drive means (7411, 7414) to incorporate a logical data means resident on the one or more X-Drive means (7411, 7414) which can logically be accessed by the client means (7441, 7442) by communicating with one or more of the X-Drive means (7411, 7414).

This architecture is common in that the wide area network means connects one or more spatial region means and permits one or more local area network means to communicate across the one or more spatial region means. Within this context, one or more X-Drive means are individually resident on one of said one or more local area network means, one or more client means are individually resident on one of said one or more local area network means; and the logical data means may be accessed by one or more client means via communication with one or more X-Drive means via one or more local area network means via the wide area network means.

System Variations

The above architectures (7300, 7400) may be augmented by any of the following enhancements/modifications:

(1) The network means may be either flat or hierarchical, and may employ standard networking equipment such as routers, switches, and hubs.

(2) The X-Drive means need not be in geographic proximity to the client means.

(3) The client means may be comprised of any combination and number of computers, information appliances, and other X-Drive means.

(4) The X-Drive means may coordinate RAID functionality with one or more additional X-Drive means.

(5) The X-Drive means may operate on a virtual storage area network using VPN tunnels or dedicated time division multiplexed channels to one or more additional X-Drive means.

(6) The X-Drive means may interoperate with one or more additional X-Drive means behind a router, switch, or hub.

(7) The X-Drive means may have multiple network ports for failover protection.

(8) The X-Drive means may have multiple network ports and perform routing and switching.

(9) The X-Drive means may simultaneously service a multitude of client means.

### Distributed Data Methods

Data Storage Configuration Method (7500)

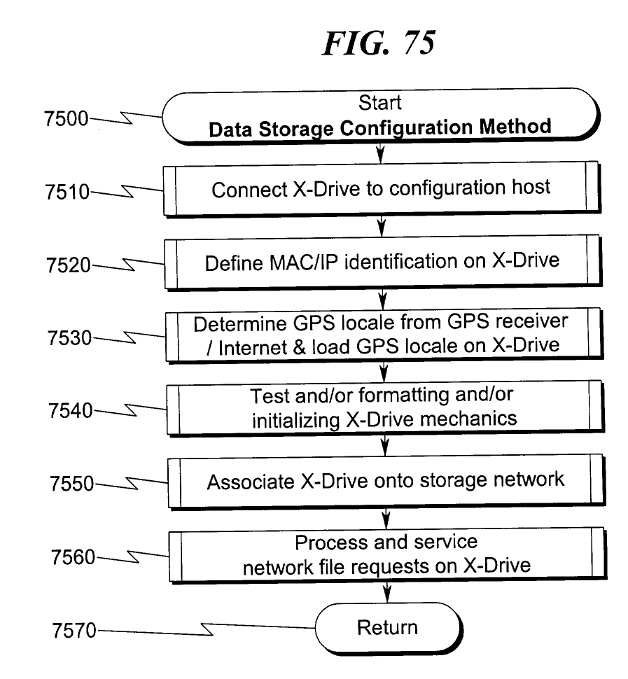

The architectures generalized above may implement a variety of data storage configuration methods, including that detailed in FIG. 75 (7500), which includes the following steps:

(1) connecting an X-Drive to a configuration host (7510);

(2) defining MAC/IP identification on said X-Drive host (7520);

(3) determining a GPS locale from a GPS receiver and/or the Internet and loading said GPS locale on said X-Drive host (7530);

(4) testing and/or formatting and/or initializing said X-Drive mechanics (7540);

(5) associating said X-Drive onto a storage network (7550); and

(6) processing and servicing network file requests on said X-Drive (7560).

Optional Embodiments

The method described above (7500) can incorporate any or all of the following optional elements to form additional preferred embodiments:

(1) The X-Drive may optionally move data to and from DASDs in clients for data migration.

(2) The X-Drive may optionally move data to and from DASDs in clients for data mirroring.

(3) The X-Drive may optionally move data to and from DASDs in clients for data backups.

(4) The X-Drive may perform background virus scanning, data compression, or other duties for clients using spare resources and bandwidth.

(5) The X-Drive may incorporate quality of service functionality.

(6) The X-Drive may incorporate packet routing functionality.

(7) The X-Drive may incorporate packet switching functionality.

(8) The X-Drive may incorporate firewall functionality.

(9) The X-Drive may encrypt and/or decrypt data at the media level.

Data Storage Access Method (7600)

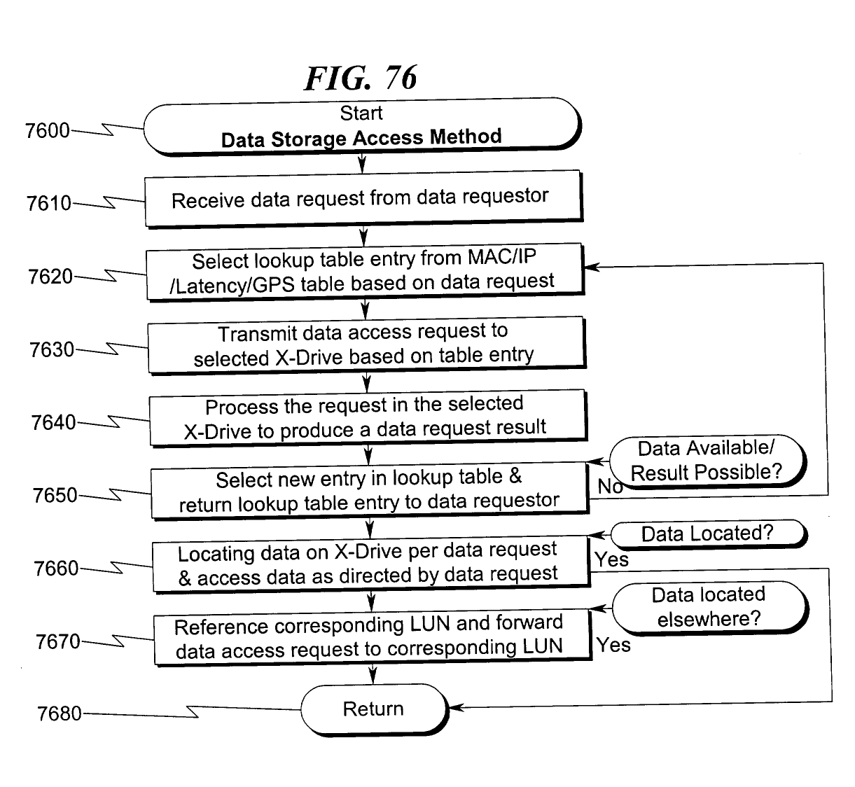

The architectures generalized above may implement a variety of data storage access methods, including that detailed in FIG. 76 (7600), which includes the following steps:

(1) receiving a data request from a data requestor (7610);

(2) selecting a lookup table entry from a MAC/IP/Latency/GPS table based on the data request (7620);

(3) transmitting a data access request to a selected X-Drive based on the table entry (7630);

(4) processing the request in the selected X-Drive to produce a data request result (7640);

(5) if the data request result is that no data is available or no response is possible, selecting a new entry in the lookup table and returning the lookup table entry to the data requester, and proceeding to step (2) (7650);

(6) if the data request result is that the data has been located and a logical unit number is available for accessing the data request, locating data on the X-Drive corresponding to the data request and accessing the located data as directed by the data request (7660); and

(7) if the data request result is that the data is not available on the X-Drive, but available on yet another MAC address with corresponding LUN, referencing the corresponding LUN and forwarding the data access request to the corresponding LUN (7670).

Optional Embodiments

The method described above (7600) can incorporate any or all of the following optional elements to form additional preferred embodiments:

(1) The lookup table may provide MAC/IP and latency data for available X-Drives.

(2) The lookup table may provide global positioning data for available X-Drives.

(3) The X-Drives may store data usage statistics including request time and geospatial information pertaining to both the requester and the requested data.

(4) The X-Drives may off-load data retrieval and management functions from clients.

(5) The X-Drives may cooperate with one another to achieve data processing and management goals.

(6) The logical file may be abstracted to the client by the targeted X-Drive.

(7) The logical file may be referenced by a centralized database.

(8) The logical file may be referenced by a distributed database.

(9) The logical file may be referenced by an instantaneous and temporary link.

(10) The logical file may be reconstructed on or migrated to the initiating X-Drive.

(11) The logical file may refer to block data within a larger entity, such as a database.

(12) The X-Drive may employ usage statistics and automatically migrate data to geospatial points of most frequent access.

(13) The X-Drive may optimize data migration against usage statistics, against resource availability, and against programmed quota, network traffic, security, and redundancy requirement rules.

(14) The X-Drives may be mobile.

(15) The X-Drives may further comprise mobile data centers.

(16) The clients and the requesters may be mobile.

(17) The X-Drives may communicate securely with one another using data encryption.

(18) The network interfaces and concentrators including routers, switches, and hubs employ X-Drives to cache network traffic.

(19) The X-Drives provide policy-managed “guest accounts” to facilitate data migration.

### Data Migration (6600)

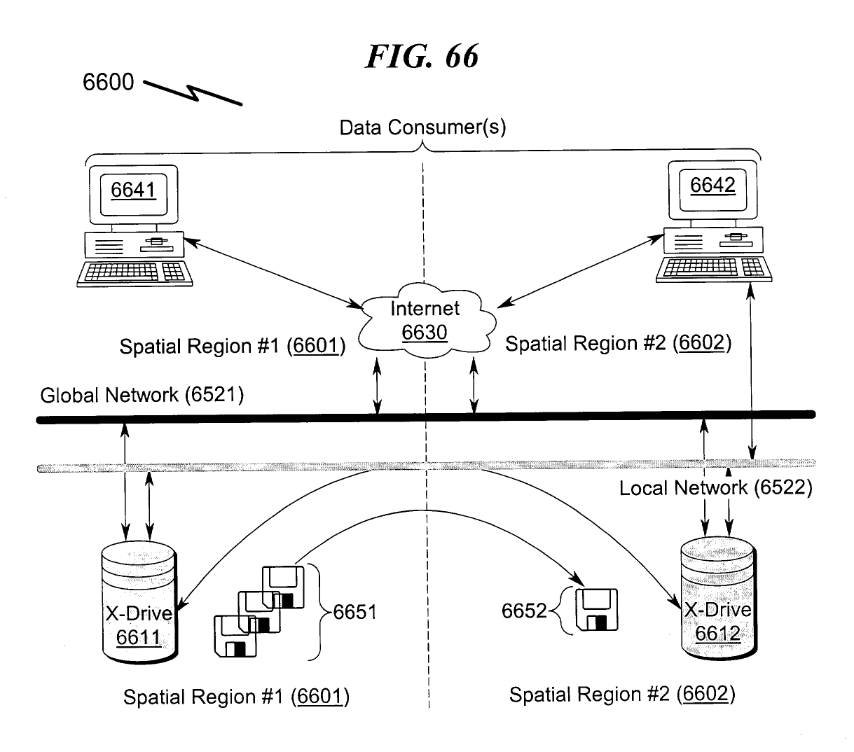

As illustrated in FIG. 66 (6600), the present invention also permits a new data storage concept, that of “data migration” to be implemented in the context of a distributed data network. In this context, multiple X-Drives (6611, 6612) are connected (via a spatially diverse network (6521, 6522) across multiple spatially diverse regions (6601, 6602). Within this context, multiple data consumers (6641, 6642) are located in their respective spatial regions (6601, 6602) or in nearby areas to these regions.

The concept of data migration utilizes the Internet (6630) or some other communication medium in conjunction with the mirroring features of the X-Drives (6611, 6612) to permit file migration of one or more files (6651) from the X-Drive (6611) in one spatial region (6601) to a correspondingly mirrored file (6652) on a second X-Drive (6612) in a second spatial region (6602). The advantage of this scenario is that even if data is initially generated by a data consumer (6641) in a first spatial region (6601), as the data is requested by a data consumer (6642) in a second spatial region (6602), the data is automatically “migrated” from the initial storage device (6611) in the first spatial region (6601) to a local storage device (6612) in the second spatial region (6602).

This “localization” of data access permits a higher reliability of access (fewer communication links relates directly to increased overall link reliability) while speeding data access as well. Furthermore, since this “localization” process may be temporally dictated or permanent, the long-term impact on the storage capacity of the X-Drive (6612) in the second spatial region (6602) may be minimized. Furthermore, the fact that the second X-Drive (6612) has of its own accord forced the spatial diversity of the data resident in the first X-Drive (6611) also increases the reliability of the first data consumer (6641) by providing an automatic backup of the existing data set (6651) on the first X-Drive (6611) as mirrored on the second X-Drive (6652).

Within this context it is anticipated by the present invention that in some preferred embodiments one or more X-Drives may be directly attached to a network router to serve as a large cache for frequency accessed data such as web pages and the like. The use of X-Drives in this context is superior to that of the prior art because the distribution methodology of the X-Drive architecture is superior to the file concentration topology utilized in most web-server disk farms. By distributing the data to a variety of distributed mass storage devices in the form of X-Drives, the present invention speeds access to individual web pages and also migrates data to the point of most frequent access. This routing assistance function may optionally have associated time and/or frequency considerations with respect to cache flushing and the like.

### Software Distribution

Prior Art (6700)

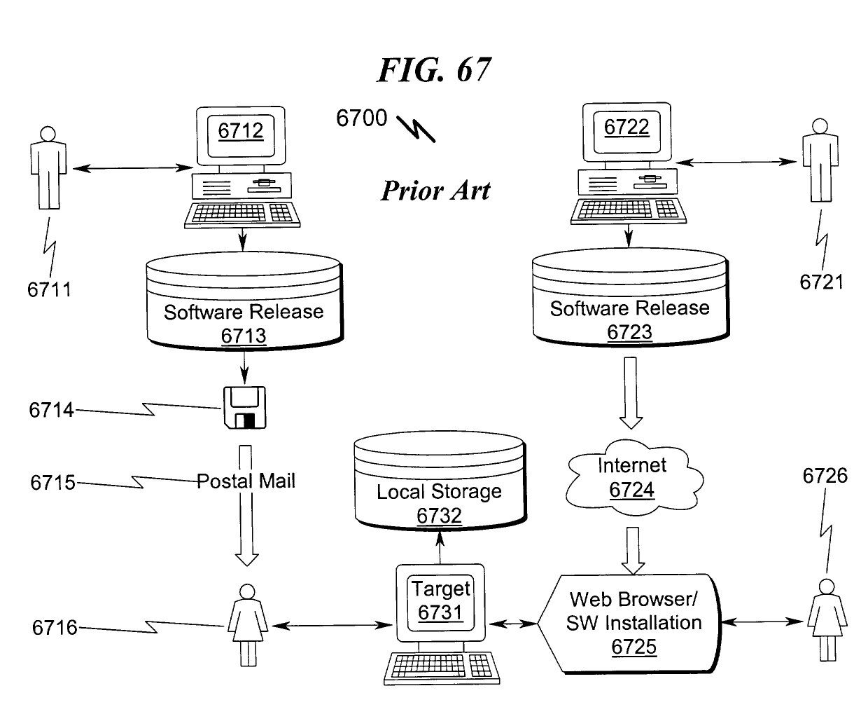

Before describing the application of the present invention to the problem of software distribution and configuration management it is instructive to review the prior art. As illustrated in FIG. 67 (6700), the prior art in this area generally revolves around two scenarios that will now be discussed in detail.

In the first scenario, a software developer (6711) develops software on a computer system (6712) that results in a software release (6713) that is embodied in a distribution medium (6714). This media (6714) is then mailed or otherwise physically transported (6715) to the software consumer (6716) who manually installs it on a target computer (6731) for placement on a local storage device (6732). The problems with this scenario include complexity of installation, possibility of media defects, issues regarding software maintenance, and a general high level of manual intervention that tends to drive up cost and lower system reliability.

In a second common scenario, the software developer (6721) develops software on a computer system (6722) that results in a software release (6723) that is then transported via the Internet or some other communications medium (6724) under control of a web browser or other software installation software (6725) under control of a software consumer (6726). This software release (6723) is then installed on a target computer (6731) for placement on a local storage device (6732). Note that the only improvement in this scenario is the elimination of the physical distribution media (6714). While this reduces software distribution costs, it does not address issues such as software maintenance, the need for human intervention (6726), and issues surrounding system failures due to software bugs in initial or maintenance releases of the software that is distributed.

In general, software vendors have failed to address these issues because the access and control mechanisms in charge of maintaining system security and integrity (i.e., the operating system or its sub-elements) are in many cases the items being modified as a result of the software installation. Thus, both prior art scenarios illustrated in FIG. 67 (6700) suffer from the possibility that a software installation or upgrade could totally corrupt the computer system software or the local storage (6732) to an extent making system booting or normal target system (6731) operation impossible. The present invention solves this dilemma by removing the responsibility for data integrity from the operating system and/or software vendor to a trusted entity that supports checkpointing and data journaling at a more fundamental level.

Exemplary Software Distribution Scenario (6800)

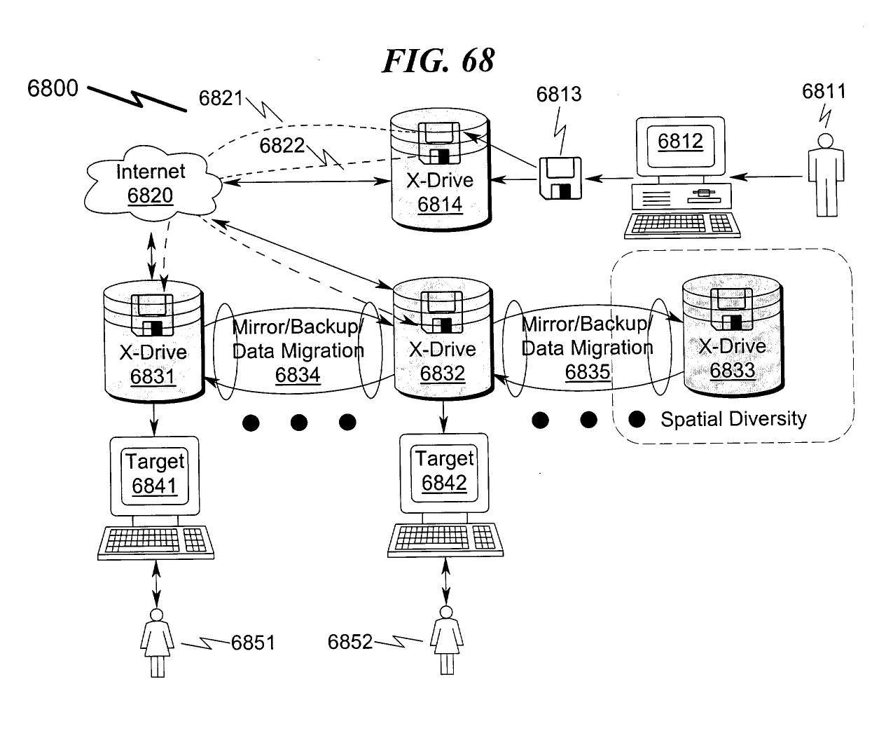

As illustrated in FIG. 68 (6800), the present invention anticipates a different software distribution paradigm. In this scenario, the software developer (6811) still interacts with a computer system (6812) to develop a software product (6813) for distribution, but this software product/application (6813) is stored on an X-Drive (6814) that communicates via the Internet or some other communications medium (6820) to one or more X-Drives (6831, 6832, 6833) that service corresponding target systems (6841, 6842) and associated software consumers (6851, 6852).

This scenario is systematically different from the prior art in that as the software is distributed to the X-Drive (6814) of the software developer (6811), it is automatically distributed to participating consumer X-Drives (6831, 6832, 6833) by virtue of mirror/backup and data migration software functionality (6834, 6835) present in all the X-Drives that cooperate with that of the software developer. In this scenario software updates are automatic, and require no intervention of the software consumer (6851, 6852). Furthermore, the software consumer has the ability to meter and/or control the level of software upgrades that will be performed to a given target system (6841, 6842). Additionally, should a software installation/upgrade cause a system failure in any target system (6841, 6842), the option to “rollback” the installation is available at the X-Drive level (6831, 6832, 6833) and need not require intervention from either the software developer or the software consumer (6851, 6852).

As indicated previously, the software distribution (6813) initially resides on the software developer X-Drive (6814), and is eventually migrated to one or more software consumer X-Drives (6831, 6832, 6833). In conjunction with the previously described data migration concept, once the software application (6813) is transferred to one software consumer X-Drive (6831), other software consumer X-Drives (6832, 6833) may gain access to this data through mirror/backup and/or data migration protocols (6834, 6835) to permit software distribution to be carried out in a trusted manner without intervention from the software developer (6811) or their associated X-Drive (6814). This increases the speed of software distribution by eliminating the software developer (6811) or their equipment (6812) as a single performance or access bottleneck, and leverages the software consumer (6851, 6852) hardware in the software distribution process.

### Data Distribution

Overview (7700)

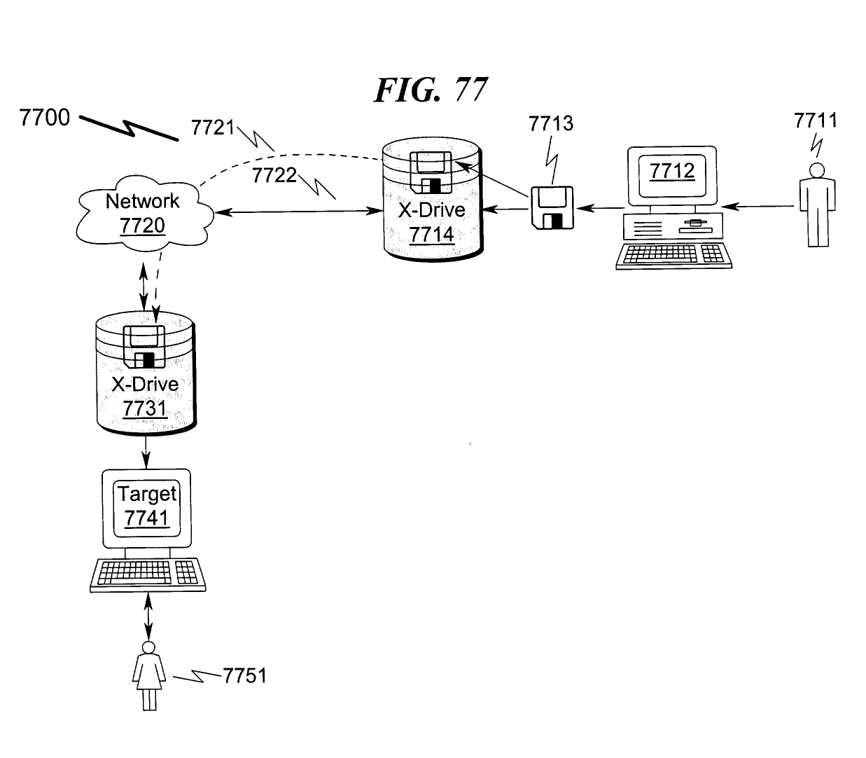

The present invention may be embodied in a data distribution system as illustrated in FIG. 77 (7700) wherein data content (7713) resident on an X-drive means (7714) is produced by one or more content publishers (7711) (or publisher controlled computer system(s) (7712)) and provided to target means (7741) over a network means (7720) for use by one or more data consumer(s) (7751). In this configuration the network means (7720) may connect both local and spatially diverse resources and entities, and the X-Drive means (7714, 7731) is connected to the network means and may serve as a content distributor (and/or receiver (7731)) via the network means (7720). This permits one or more consumer(s) (7751) to retrieve the data content (7713) from the X-drives via said network means (7720) for utilization on the target means (7741), which is connected (directly and/or indirectly via an X-Drive (7731)) to the network means (7720).

Optional Embodiments/Configurations

The data distribution system detailed above (7700) may be augmented in part or whole by any of the following modifications:

(1) The consumer(s) may contribute content up to the publisher for redistribution consideration.

(2) The publishers may also act as data consumers.

(3) The consumer(s) may also act as publishers.

(4) The data content may be distributed among one or more content publishers.

(5) The data distributed may be a textual creative work.

(6) The data content distributed may be audio and/or video.

(7) The data content distributed may be software.

(8) The data content distributed may be encrypted.

(9) The data content distributed may be cached for delayed playback on said target means.

Data Distribution Method (7800)

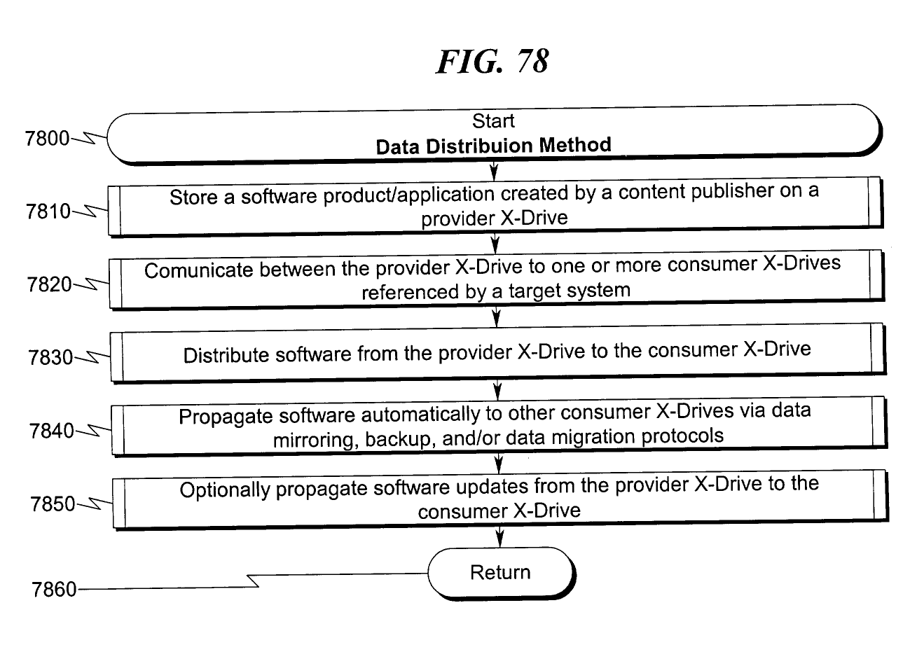

The architectures generalized above may implement a variety of data distribution methods, including that detailed in FIG. 78 (7800), which includes the following steps:

(1) Storing a software product/application created by a content publisher on a provider X-Drive (7810);

(2) Communicating between the provider X-Drive and one or more consumer X-Drives referenced by a target system (7820);

(3) Distributing the software from the provider X-Drive to the consumer X-Drive (7830);

(4) Propagating the software automatically to other consumer X-Drives via data mirroring, backup, and/or data migration protocols (7840); and

(5) Optionally propagating software updates from the provider X-Drive to the consumer X-Drive (7850).

Optional Embodiments

The method described above (7800) can incorporate any or all of the following optional elements to form additional preferred embodiments:

(1) The provider and consumer X-Drives may store software version, usage constraint, and time-stamp information for each item in distribution.

(2) The provider and consumer X-Drives may incorporate authentication and secure communication methodologies.

(3) The consumer X-Drive may reject software updates.

(4) The consumer X-Drive may request software updates based on aging or other criteria.

(5) The target systems may select the best available software version published.

(6) The content publisher may roll the content X-drive back to a previously published software product/application.

(7) The target system may roll a content X-drive back to a previously published software product/application.

(8) The X-Drive may automatically roll back to a previously published software product/application in the event a software failure is detected.

(9) The target systems may each have unique checkpointed software product/application versions associated with the target system on the consumer X-Drive.

### Data Brokering/Metering

Overview

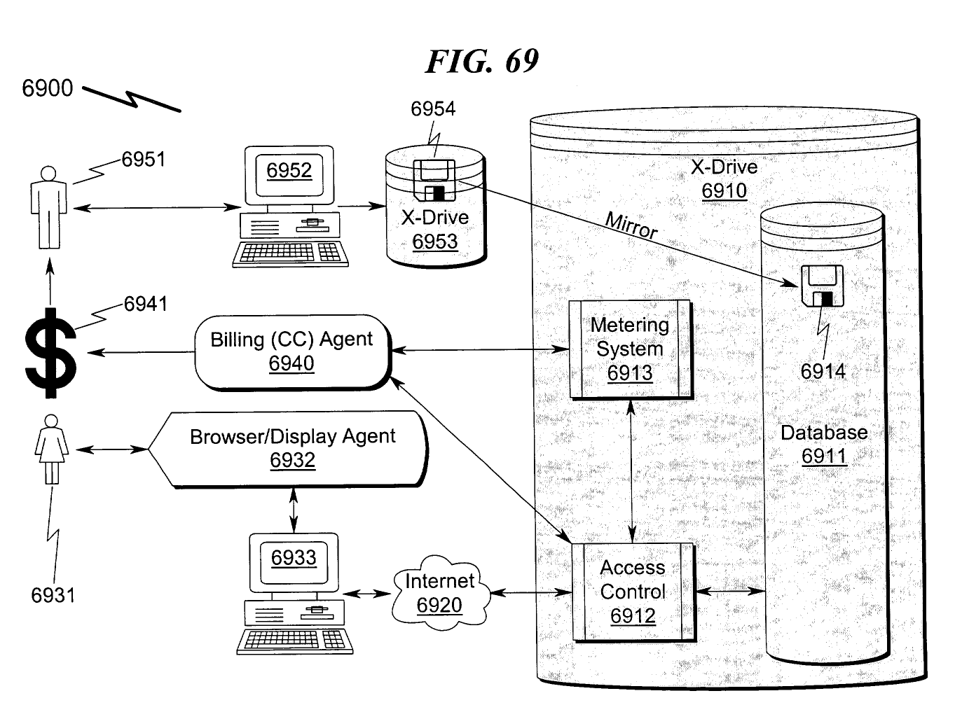

In some preferred embodiments, the present invention may be used as a data brokering/metering device to permit per-use or metered access to databases, software, and other information that is general or specific in nature. An exemplary embodiment of this architecture is illustrated in FIG. 69 (6900) and will now be discussed in detail.

Exemplary Data Brokering/Metering System (6900)

As illustrated in FIG. 69 (6900), this exemplary data brokering/metering system makes use of an X-Drive (6910) as a repository for a database (6911) that could include any data item, file, record, or entity, either viewed collectively or on an individual or granular level. This database (6911) as stored in the X-Drive (6910) has an overlay of access control (6912) to prevent unauthorized access to the database contents (6911). This access control may be in many forms, such as but not limited to system/group/owner/world granularity and read/write/execute/delete access, but may also include more sophisticated mechanisms such as access control lists (ACLs) and the like.

The access control subsystem (6912) permits communication over the Internet (6920) or some other communications medium so that a data consumer (6931) who interacts with a browser/display agent (6932) interface on a computer system (6933) may access the database (6911) contents only if properly authorized. Access control provides information to a metering system (6913) to determine how much a billing (credit card, etc.) agent (6940) should pay (6941) to the originator of the database, the data agent (6951).

Note that in this context a data agent (6951) generally interacts with a computer system (6952) to communicate with an X-Drive (6953) having one or more original copies of the data (6954) to be brokered. This data (6954) is then automatically mirrored (6914) to the database (6911) as a general background feature of the X-Drive architecture. Significant to this architecture is the fact that the data agent (6951) need not have any knowledge of the exact mechanisms in which the data (6954) is brokered or how the transaction between the billing agent (6940) and the data consumer (6931) takes place. This is handled by the X-Drive architecture at a level that is removed from the application interface viewed by either the data agent (6951) or the data consumer (6931).

Encryption Option (7000)

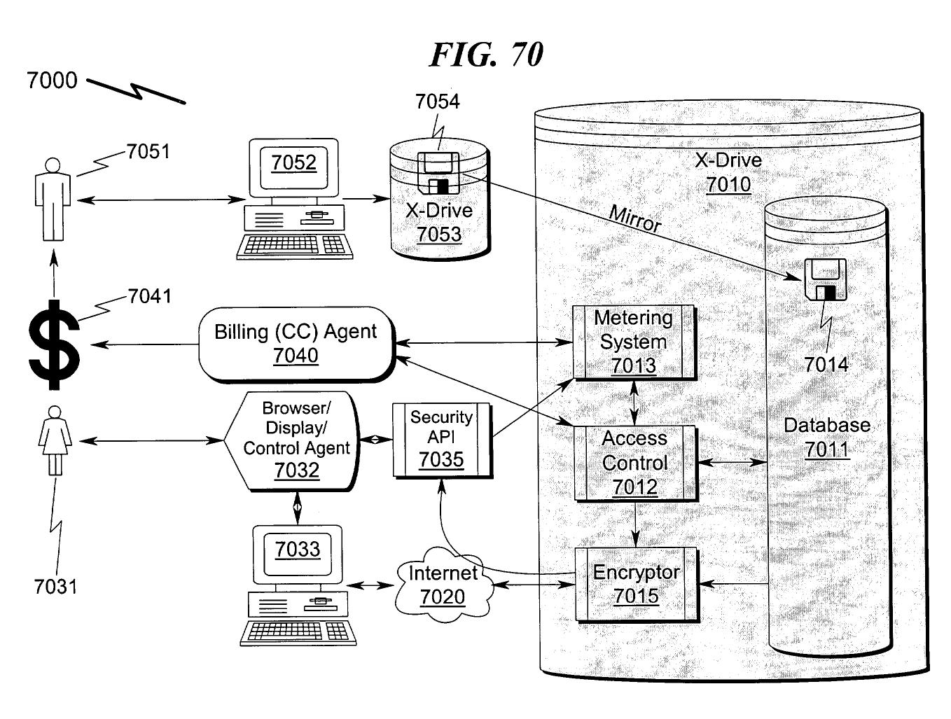

As illustrated in FIG. 70 (7000), the generalized data brokering/metering architecture of FIG. 69 (6900) may be augmented with an X-Drive (7010) based encryptor (7015) that communicates with a security API (7035) to ensure that data presented by the browser/display/control agent (7032) is not usurped by either the data consumer (7031) or hardware (7033) under his control. A significant feature illustrated in this preferred embodiment is the ability to transfer encrypted programs (7014) from the X-Drive (7011) for secure execution on the target data consumer system (7033).

In this scenario, the security API (7035) interacts with the encryptor (7015) and the browser/display/control agent (7032) to transfer programs (7014) from the X-Drive (7011) through the encryptor (7015) to the target system (7033), decrypt the program using the security API (7035), and run the program under the control of the browser/display/control agent (7032). Once execution is complete, the security API removes the metered program (7014) from the target system (7033) and informs the metering system (7013) regarding the program use so that the billing agent (7040) may properly pay (7041) the software developer (7051).

One skilled in the art will recognize that while this model may be advantageously applied to per-use and metered software use and distribution, it is equally applicable to any scenario in which data of any type is brokered by a trusted agent to third parties who are not necessarily trusted agents. The metering aspects of the invention as disclosed may be generalized to a wide variety of contexts, including but not limited to per-use, time metered, per-user, per workload volume processed, per record or other entity accessed/processed, etc.

Note that the integrated use of encryption (7015) within the X-Drive (7011) in this and other scenarios permits distribution of software and other data elements to end-customer systems without loss of security or data integrity. This permits widespread distribution of current software and software updates without the need for elaborate integrated software licensing and encryption within the context of each software application shipped. Instead of the software application providing for application authentication, it is the distribution methodology in this scenario that provides the required data security and integrity prophylactic. While many preferred embodiments anticipate the use of CRIPT encryption in this capacity, one skilled in the art will recognize that other encryption schemes are also applicable in this context.

Secure Multimedia Distribution (7100)

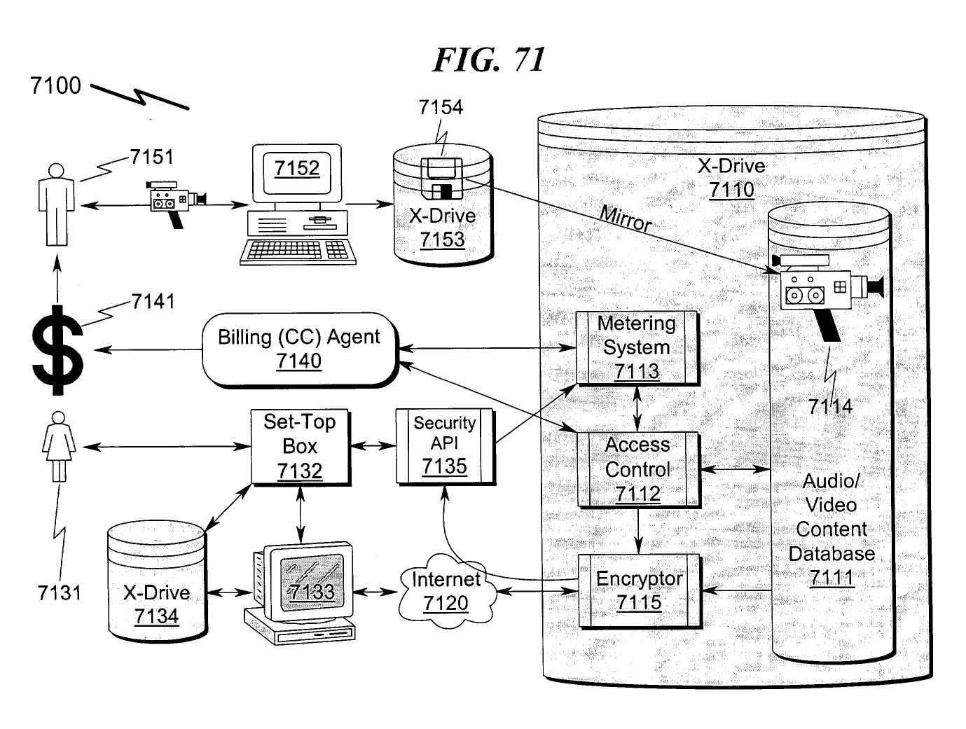

Another preferred embodiment of the present invention as illustrated in FIG. 71 (7100) applies the X-Drive technology to secure multimedia content distribution. In this scenario, the data agent (7151) generates analog and/or digital audio/video content that is initially stored on a local X-Drive (7153) in the form of a digitally mastered multimedia file (7154). This file (7154) is then mirrored (7114) to an X-Drive (7110) for distribution via trusted encryption (7115) over the Internet (7120) or some other communications media to a set-top box (7132) that under control of a security API (7135) decodes the digital content and displays it on a video monitor (7133).

Note in this context that the set-top box may be configured with a local X-Drive (7134) to securely store the digital content without the need for direct real-time access to the host X-Drive (7110) audio/video content database (7111). This methodology allows distributed dispersal of the multimedia content in a secure manner without the bandwidth demands associated with conventional on-demand video pay-per-view methodologies. In addition to time-delayed video playback and bandwidth requirements reduction, this embodiment also provides an automated and distributed method to permit royalties to be paid (7141) for audio/video content that does not directly involve the multi-media producer (7151).

Data Brokering and Metering System (7900)

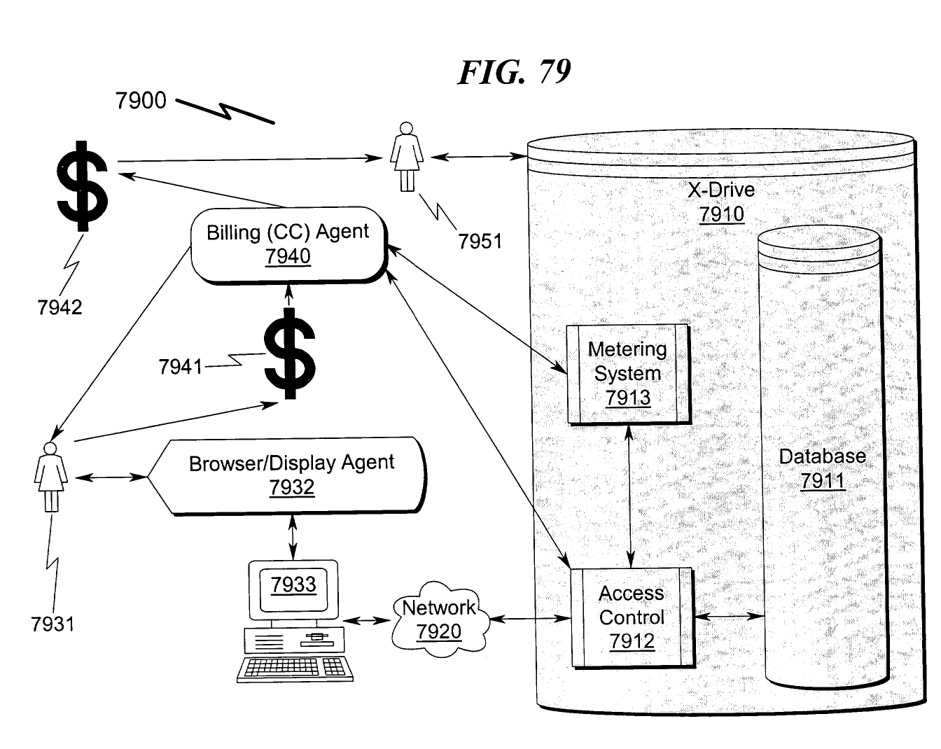

The present invention may be embodied in a data brokering and metering system as illustrated in FIG. 79 (7900) wherein access to a database means (7911) is controlled by an access control means (7912) and a metering means (7913) resident on the X-Drive in which the database means (7911) is embodied. The X-Drive in question may be connected to a network means (7920) that permits the ultimate data consumer means (7931) access to the database means (7911) via the network means (7920). Payment to the data agent (7951) (the person/entity responsible for ownership and access to the database means (7911)) is accomplished via a billing agent means (7940), which communicates directly to the metering system means (7913) and access control means (7912) resident on the X-Drive means (7910). The billing agent means (7940) may communicate with the X-Drive (7910) and/or its components via a variety of methods well known to those skilled in the art, and this communication includes but is not limited to access via the network (7920).

The X-Drive access control means (7912) authenticates the data consumer means (7931) and transactions for the metering means (7913), and ensures secure communication over the network means (7920) to permit the data consumer means (7931) access to the database means (7911) under control of the metering means (7913) and the billing agent means (7940).

The metering means (7913) determines how much the billing agent means (7940) should pay (7942) to the data agent (7951) for access to the database means (7911) by the data consumer (7931). Correspondingly, the billing agent means (7940) bills and collects compensation (7941) from data consumer means (7931) and pays (7942) the data agent means (7951).

While these teachings will permit one skilled in the art a wide variety of variations in construction, one preferred embodiment of the present invention is constructed with the metering means (7913), the billing agent means (7940), the X-Drive means (7910), and the data consumer means (7931) communicate via the network means (7920).

Data Brokering and Metering Method (8000)

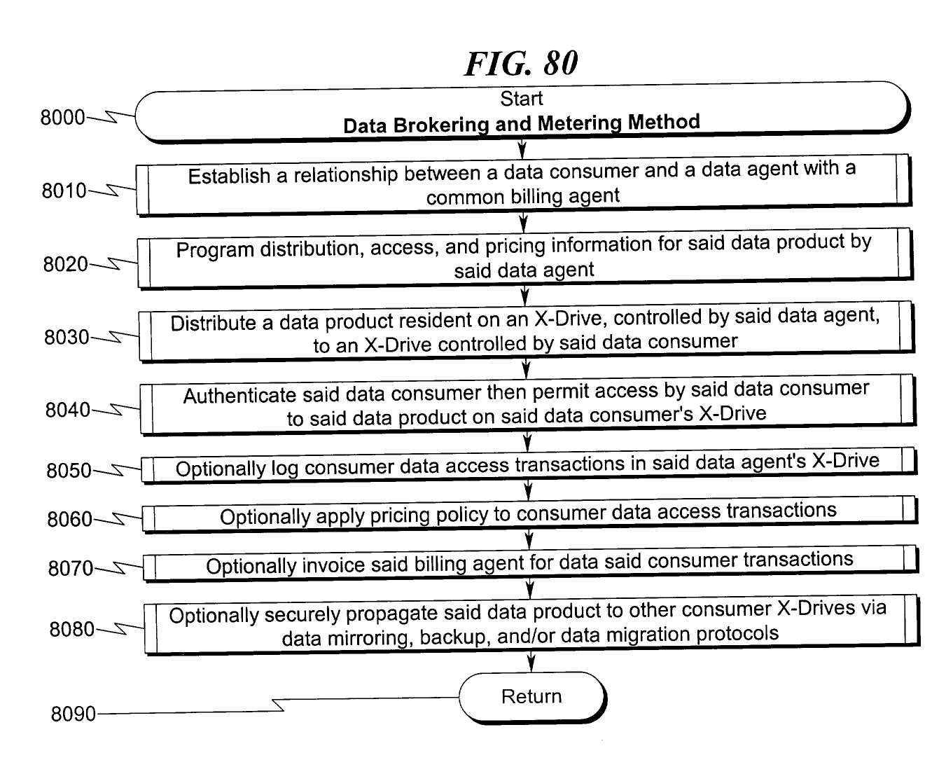

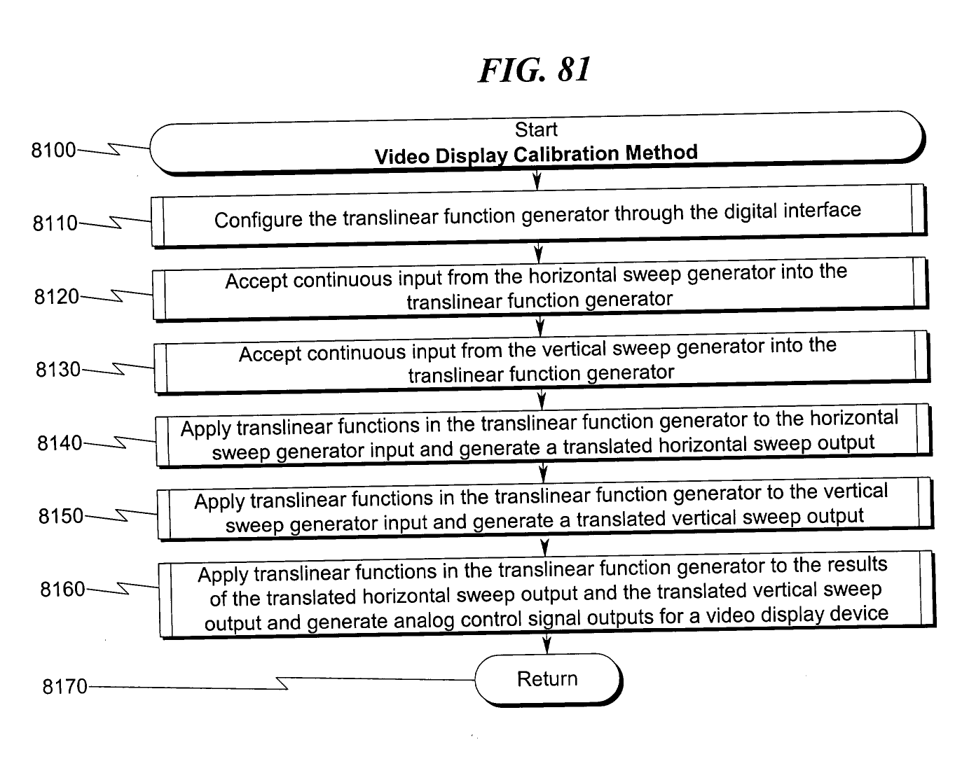

The architectures generalized above may implement a variety of data brokering and metering methods, including that detailed in FIG. 80 (8000), which includes the following steps:

(1) Establish a relationship between a data consumer and a data agent with a common billing agent (8010);

(2) Program distribution, access, and pricing information for the data product by the data agent (8020);

(3) Distribute a data product resident on an X-Drive, controlled by the data agent, to an X-Drive controlled by the data consumer (8030);

(4) Authenticate the data consumer then permitting access by the data consumer to the data product on the data consumer's X-Drive (8040);

(5) Optionally log consumer data access transactions in the data agent's X-Drive (8050);

(6) Optionally apply pricing policy to consumer data access transactions (8060);

(7) Optionally invoice the billing agent for data the consumer transactions (8070); and

(8) Optionally securely propagate the data product to other consumer X-Drives via data mirroring, backup, and/or data migration protocols (8080).

Optional Embodiments

The method described above (8000) can incorporate any or all of the following optional elements to form additional preferred embodiments:

(1) The X-Drives may store data product version, usage constraint, and time-stamp information for each item in distribution.

(2) The data product may be displayed using a TV set-top box.

(3) The data product may be used as input to a digital stereo receiver.

(4) The data product may be used as input to a wireless access device.

(5) The X-Drives may operate within a virtual private network.

(6) The X-Drives may communicate directly with a display device.

(7) The X-Drive may incorporate firewall functionality.

(8) The X-Drive may incorporate encryption.

(9) The X-Drive may protect data content in the event that network connectivity with the data agent's X-Drive is lost.

(10) The X-Drive may erase local access keys in the event tampering is detected.

(11) The X-Drive may accept smart cards for authentication, access control, and/or a debit account for pre-paid access.

(12) The X-Drive may accept a CD-ROM, DVD, tape, Compact Flash, or other recordable media, which contains a secured data product.

(13) The X-Drive may accept and process streaming content broadcast across a data network.

(14) Data authentication may be controlled by access keys comprising access control lists.

(15) The data product consumer authentication may comprise biometric identification.

(16) The X-Drive may accumulate, reject, and/or remove non-authenticated data products under programmable policies.

### Checkpoint/Rollback Support (7200)

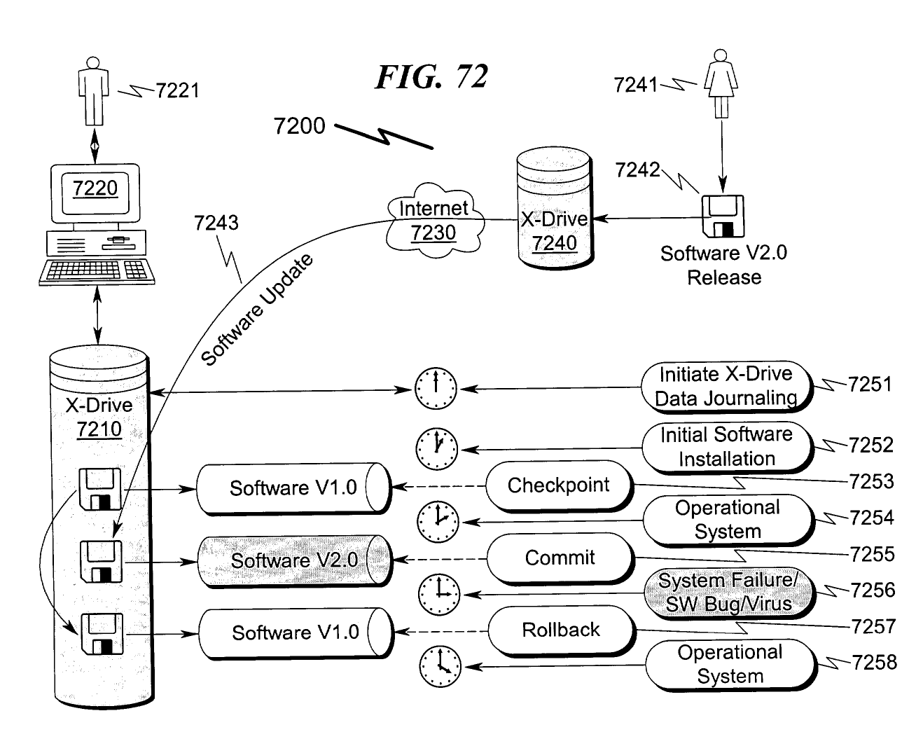

As illustrated in FIG. 72 (7200), the present invention may have application in situations where software or some other system component must be removed from a functional software system due to a system failure or software bug. In this scenario, an X-Drive (7210) services a computer system (7220) and associated users (7221). In this situation, it can be assumed initially that the X-Drive (7210) has initiated data journaling (7251) to track changes in the drive software configuration and includes an initial software installation (7252).

Generally in these situations, the problem that is most frequently of concern is a situation in which a functional operating system or software component is upgraded to a new release or version, and this version contains some software bug or other incompatibility with the existing software complement in the system, causing system failures or other undesirable system behavior. While the concept of “UNINSTALL” programs and the like are available to remove software components after they are installed, there has yet to be developed any checkpoint/journaling mass storage device that is capable of independently executing this function outside the context of a supervising operating system. The present invention permits the mass storage device itself to execute checkpoint/journaling functions outside the context of supervising software.

To see this system in action, consider the situation as illustrated in FIG. 72 (7200) in which an X-Drive (7240) supports a software developer (7241) who develops software (7242) that is distributed as a software update (7243) over the Internet (7230) or some other communications medium to a consumer X-Drive (7210). In this situation, the initial V1.0 software installation (7252) is followed by a checkpoint (7253) operation that preserves the data state of the consumer X-Drive (7210). At this point the system is fully operational (7254) and stable. Subsequent to this, the V2.0 software update is performed (from the software update (7243)) and a commit operation is performed (7255) to make this the current data state of the consumer X-Drive (7210). If at this point a system failure and/or software bug and/or software virus is detected (7256), a rollback operation (7257) is performed by the X-Drive (7210) to restore the operating system to an operational state (7258).

One feature of the consumer X-Drive (7210) in this situation is that it may be configured with a “known good and trusted” operating system kernel to permit the consumer computer (7220) to boot in the event of a total corruption of the operating system due to a virus or software bug in the V2.0 software update. This ability covers the common situation where the data context of a disk drive must be rolled back to a known trusted state after the detection of a computer virus or some system software failure that totally corrupts the system boot disk. Generally, this situation can be corrected by permitting the consumer computer (7220) to access a web-based rollback dialog within the consumer X-Drive (7210) to select which system context to recover.

### Preferred System Contexts

### Overview

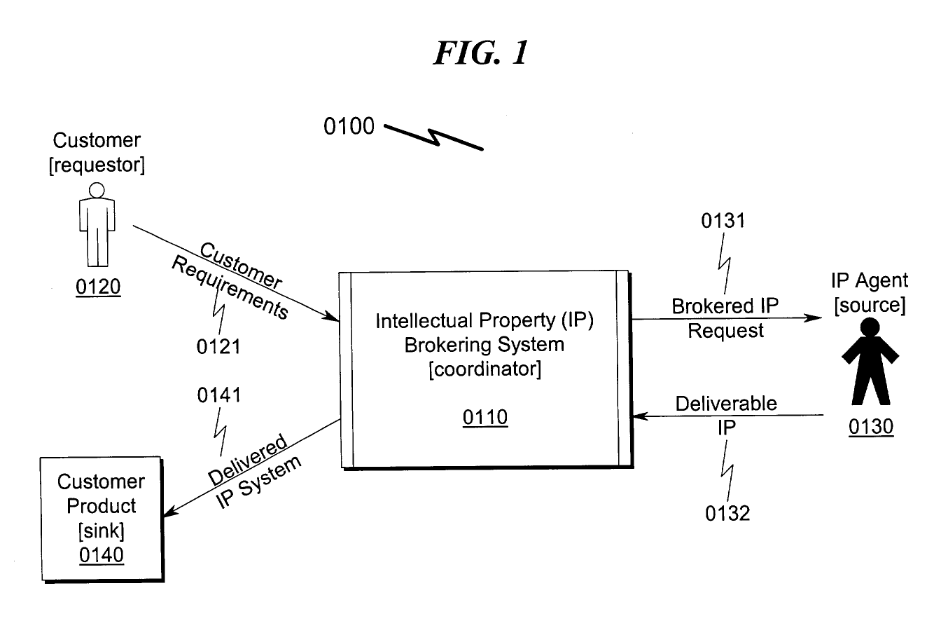

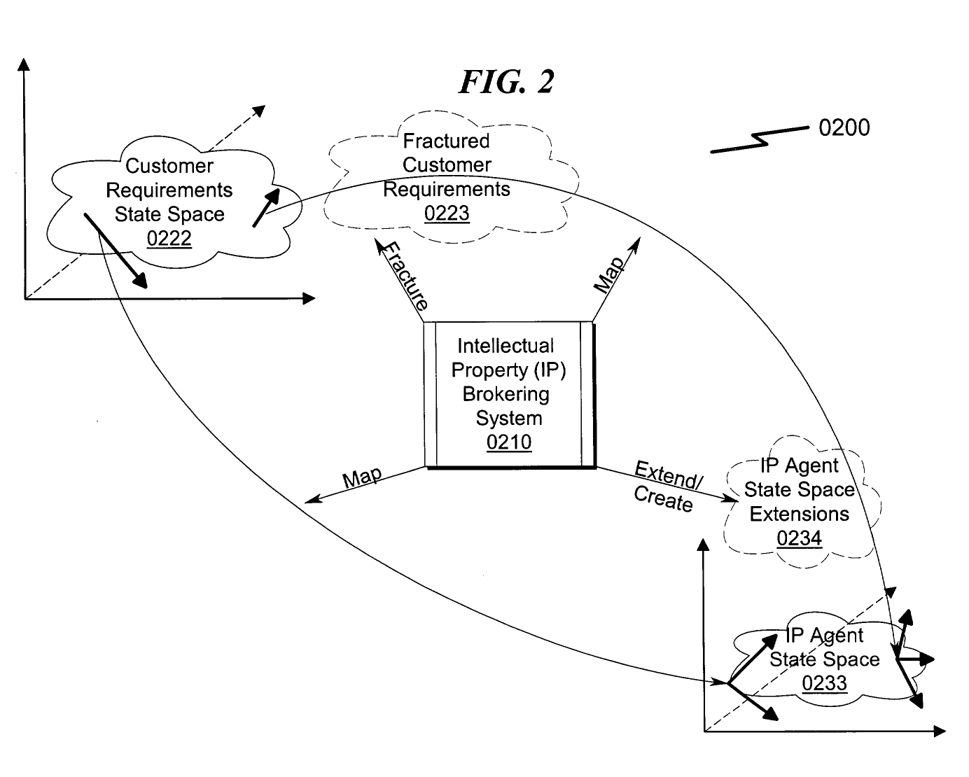

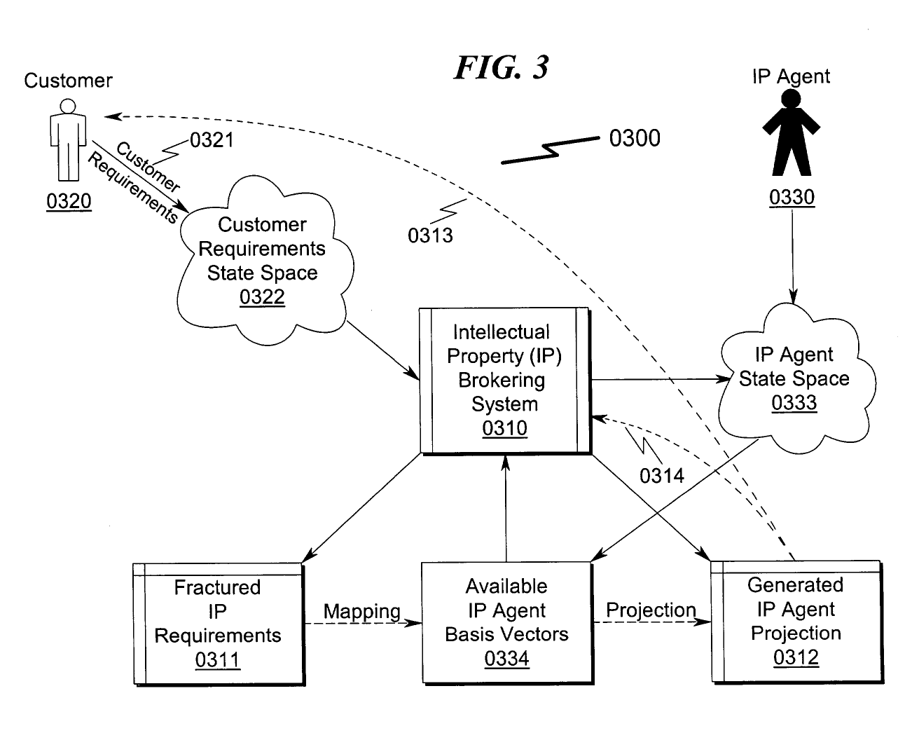

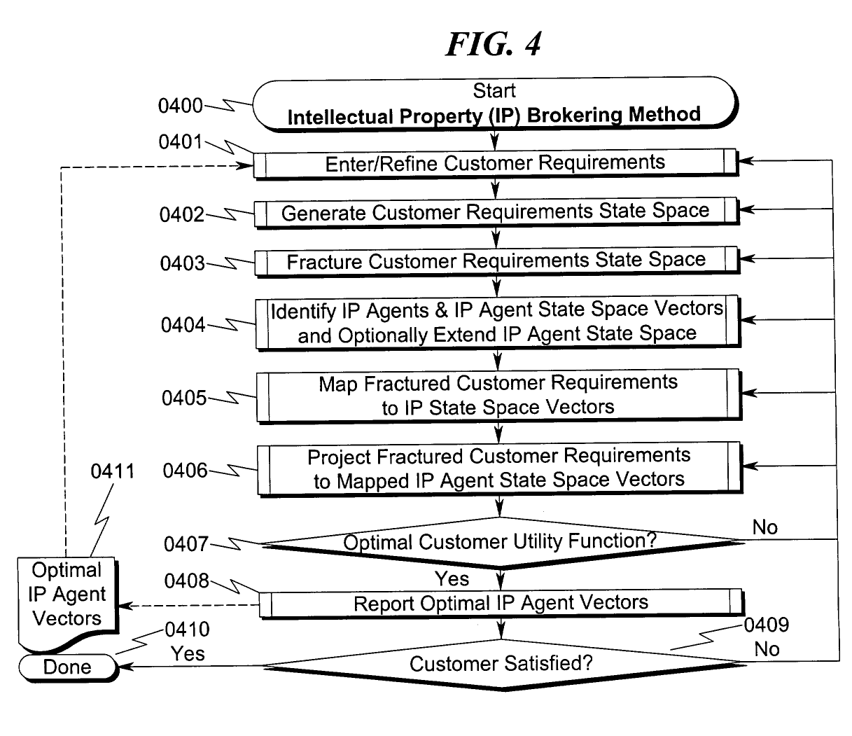

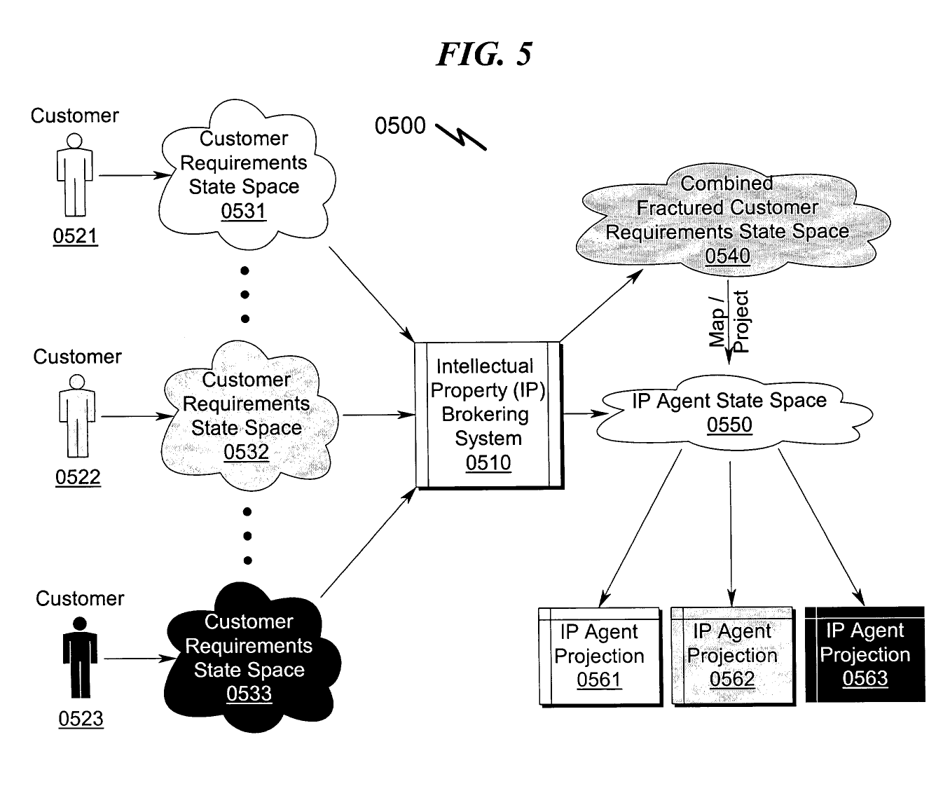

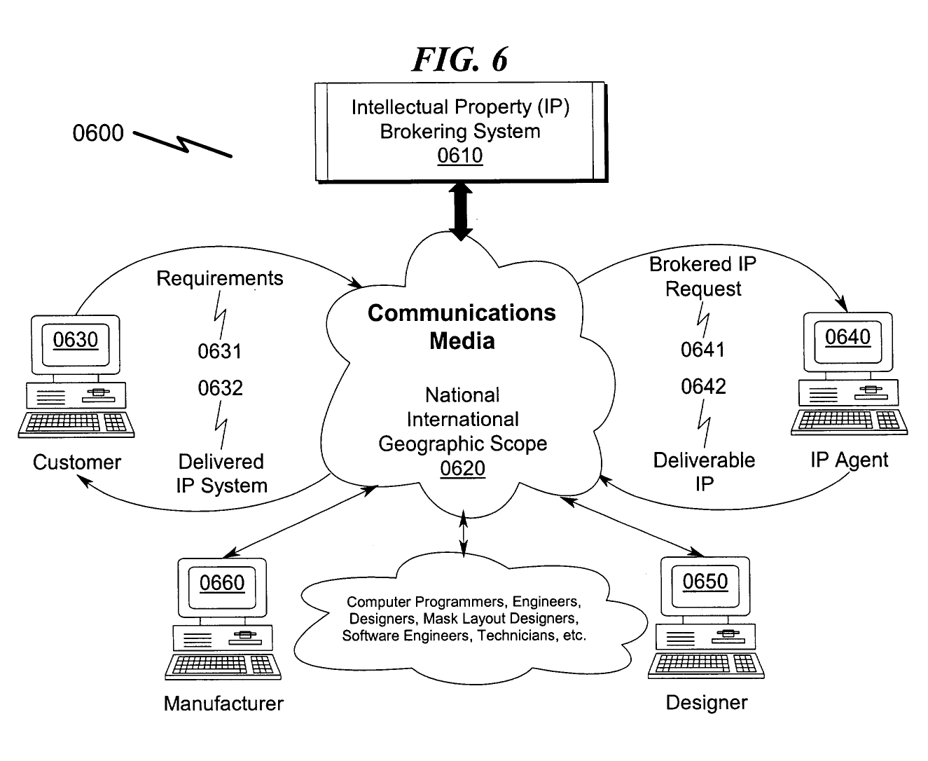

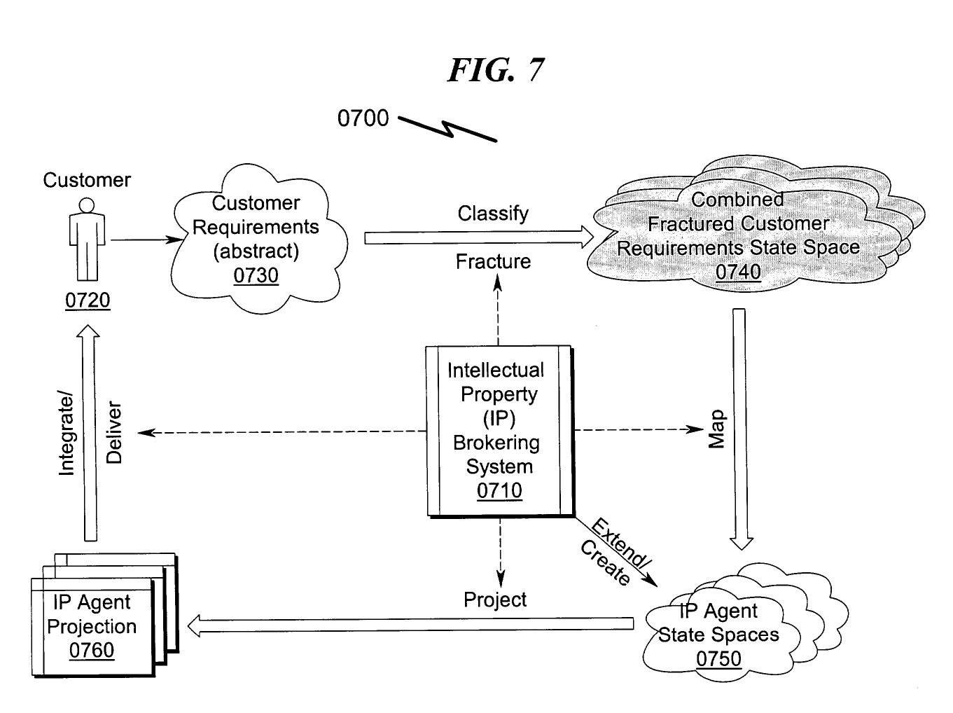

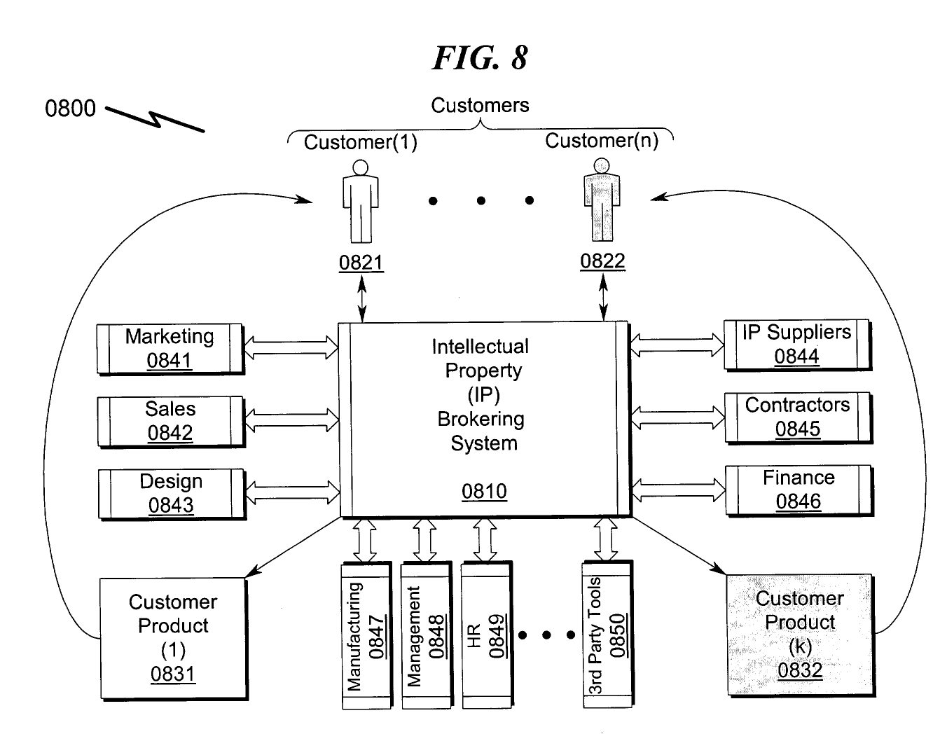

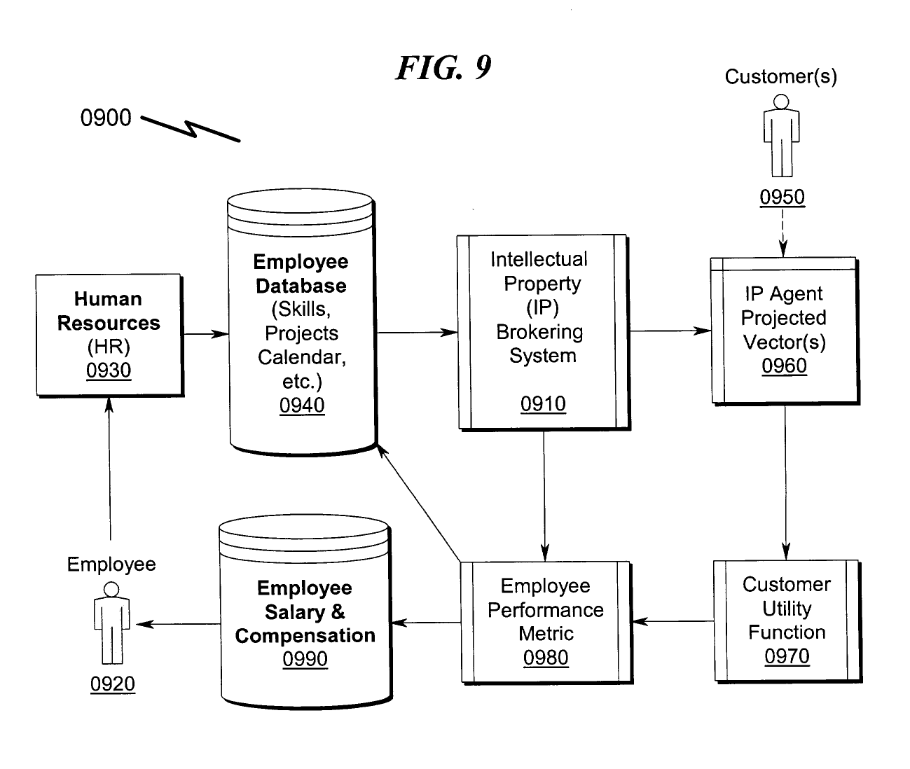

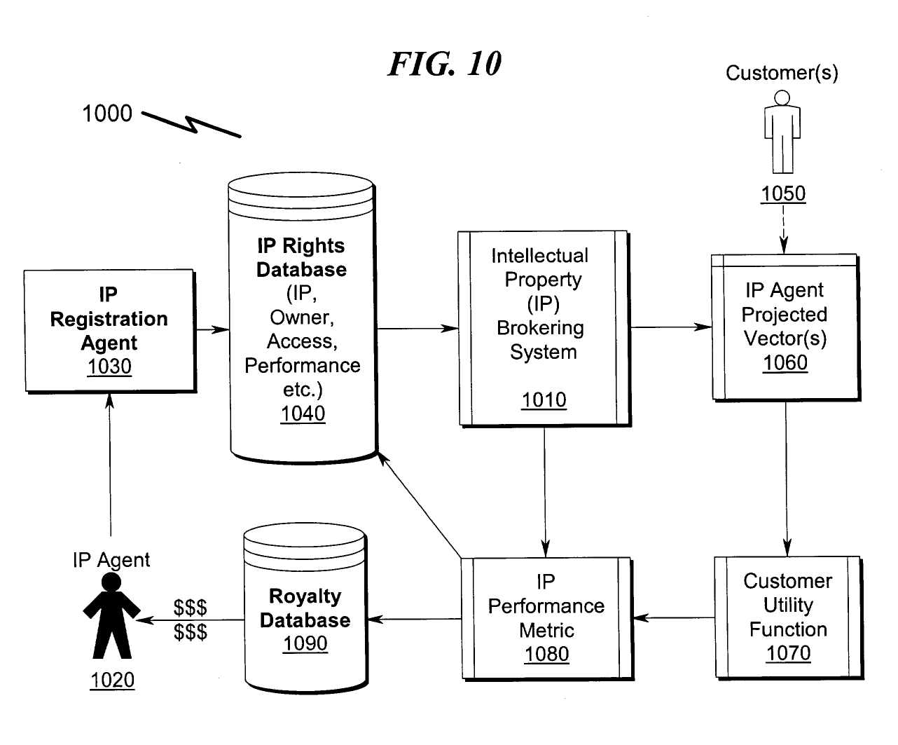

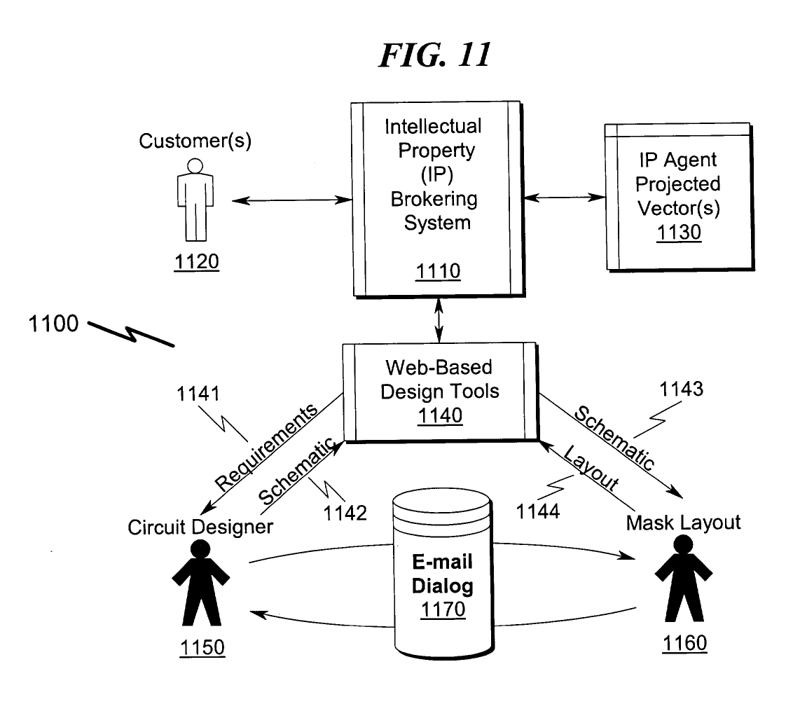

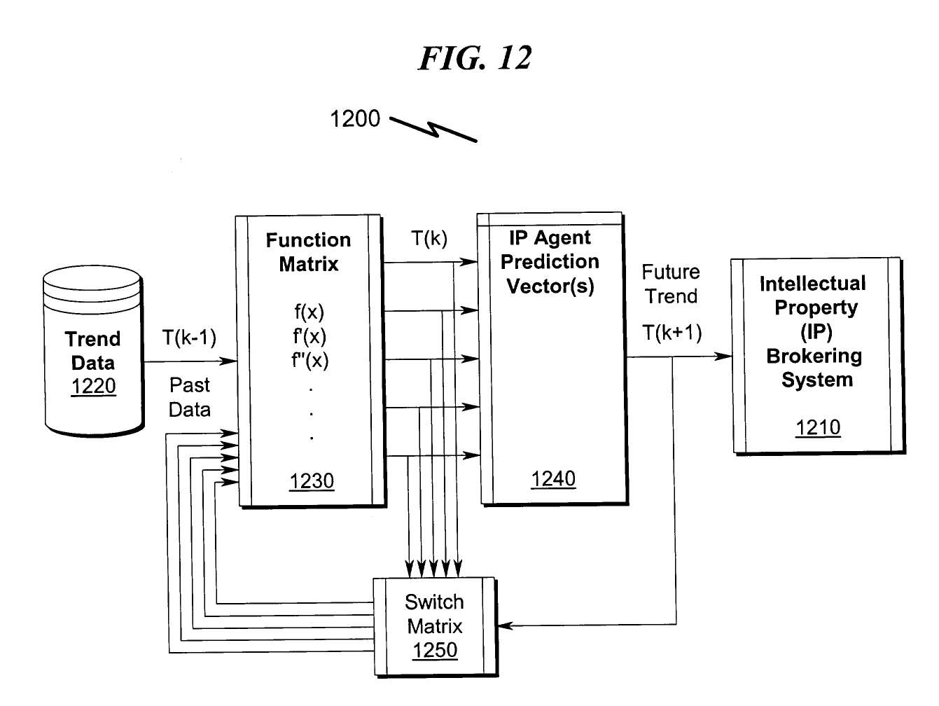

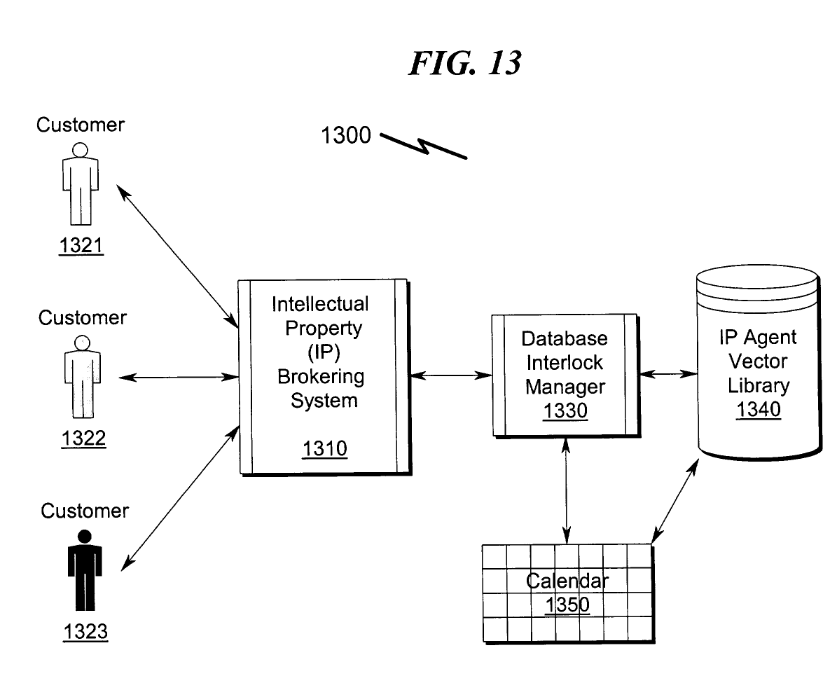

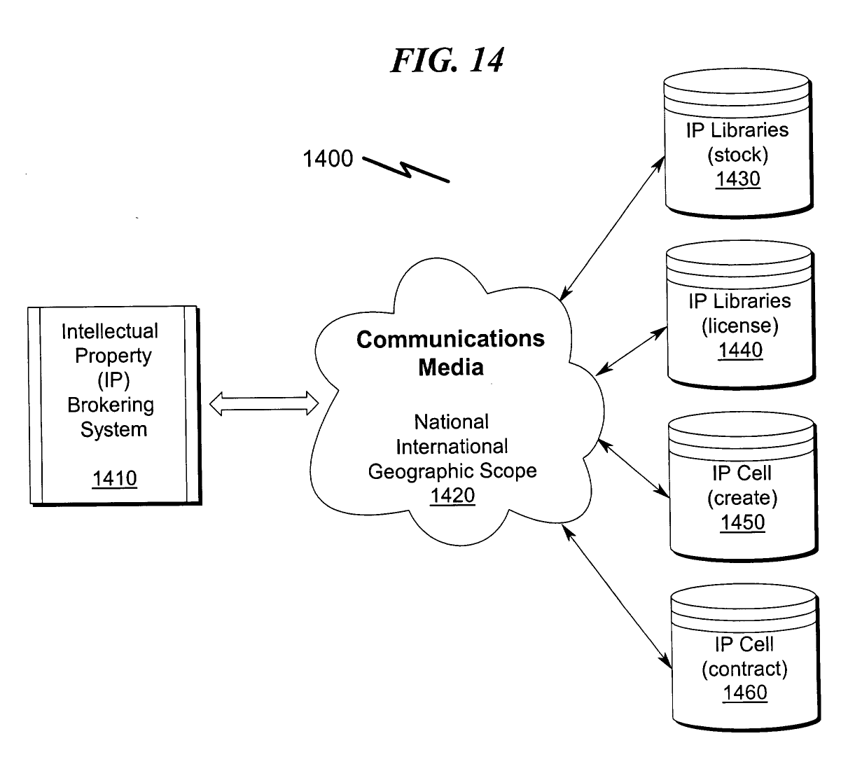

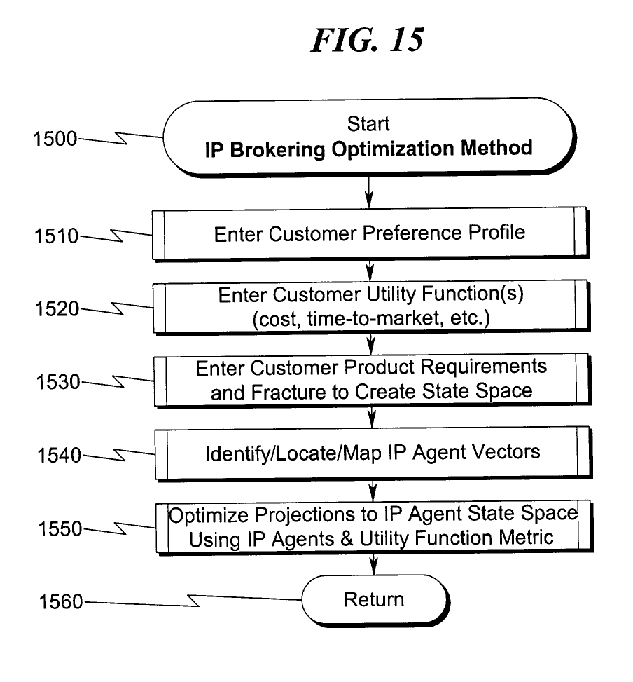

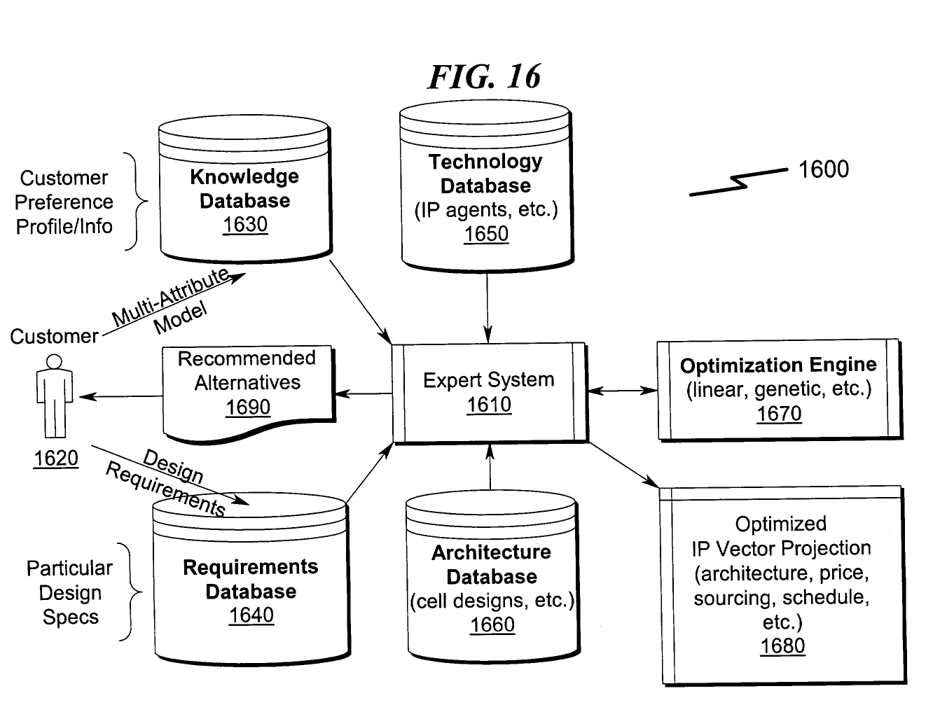

As generically illustrated in FIG. 1 (0100), the present invention may also be characterized and thought of as a generic resource coordinator (0110) that accepts inputs from a resource requester (0120) and brokers these to one or more resource source(s) (0130) that in turn provide requested resources that are integrated and funneled to a resource sink (0140). As thusly characterized, the present invention has application to a wide variety of areas in the commercial and government sectors. Some examples of these applications include but are not limited to those discussed in the following sections.

### Emergency/Terrorist Event Management

A prime example of how the present invention may be used to schedule and coordinate resources is in the context of an emergency/terrorist event management system. Often in the face of a national disaster (whether natural or man-made), a plethora of resources must be coordinated in order to address the emergency. For example, in response to the terrorist attack on the World Trade Center in New York, a wide range of emergency support resources were required to be mobilized across the United States both on an immediate and long-range temporal basis.

The present invention is particularly amenable to application in this situation because it permits a widely dispersed resource pool (medical personnel, fire personnel, police personnel, military personnel, engineers, fire trucks, blood, construction machinery, communications, etc.) to be centrally coordinated and controlled on a nationwide basis. This permits, for example, resources that are needed in New York City to be drawn from the far reaches of the United States or even outside the country for the purposes of meeting the national emergency.

Typical characteristics required in an emergency management context include the following:

dynamic allocation of resources;

time critical scheduling;

optimization of global parameters based on resource availability and other factors;

identification and optimal utilization of specialists;

spatial and temporal optimization of human resources;

logistics management.

The present invention is particularly amenable to application in this environment because it permits global optimization of resource allocation yet permits local logging of status information and resource requests to permit the knowledge base on which decisions are made to extend beyond the local scope of the emergency.

An augmented extension of this basic concept might include incorporation of wireless pagers and/or transponders attached to critical resources (medical personnel, police, fire trucks, etc.) that would permit instant determination by the IP brokering system of both the status and location (via Global Positioning System (GPS) hardware) of a given resource. Thus, mobile resources that may be transitorily within a local range of an emergency event may be paged or located to aid in emergency operations. Similarly, resources that are local but not in service can be eliminated as potential candidates for mapping to the final resource solution sink.

### Warfare Management & Logistics

The present invention is particularly well suited to warfare and logistics management wherein large military or other organized campaigns must be coordinated both spatially and temporally in order to achieve desired objectives.

### Simulation of Hostile Events

The present invention may be used quite effectively to simulate the resource demands on a given infrastructure (whether civilian or military) in response to a hostile or emergency event (war, famine, terrorist event, etc.). Traditional methods of simulating hostile events take the form of war games or emergency event training for individuals in the military and civilian defense. The present invention augments this by permitting the infrastructure to be tested via simulation in addition to traditional methods.

This would, for example, enable a civilian or military defense coordinator to generate a wide range of threat scenarios and simulate how the military/civilian infrastructure at a given time could respond to the threat. This would permit redeployment and/or fortification of resources necessary to ensure optimal coverage of these threat events before a given event occurred in reality. Additionally, this scenario might permit flaws in the existing civilian/military defense structure to be brought to light and addressed before a real threat event occurred.

### Hospital Care Management

Overview

One particularly advantageous use of the present invention is in the area of hospital care management. Here the consumers are the patients and the resources include doctors, nurses, beds, drugs, etc. that must be scheduled for optimal patient care at the lowest possible cost. The present invention permits both brokering of the personnel used to staff a given hospital, but all other resources (equipment, drugs, cleaning personnel, insurance, etc.) that surround such an endeavor.

Additionally, note that the present invention would permit a group of hospitals or other institutions to optimize the use of these resources across their boundaries to ensure maximum patient coverage with minimal cost. This optimization profile would definitely include doctors and nurses but might also include administrative staff such as accounts receivable, accounts payable, and other ancillary functions associated with hospital operation.

Finally, with the advent of remote medical diagnosis, the present invention permits global scheduling of resources for such routine procedures such as X-ray diagnosis, treatment protocols, follow up exams, etc. The use of video and/or other visual transfer mechanisms in this context may permit the fracturing of patient care across widely diverse geographic regions. This may be of special application in terms of emergency management and/or disaster relief situations where resources local to the emergency are scarce but available from remote locations over the Internet.

System (5700)

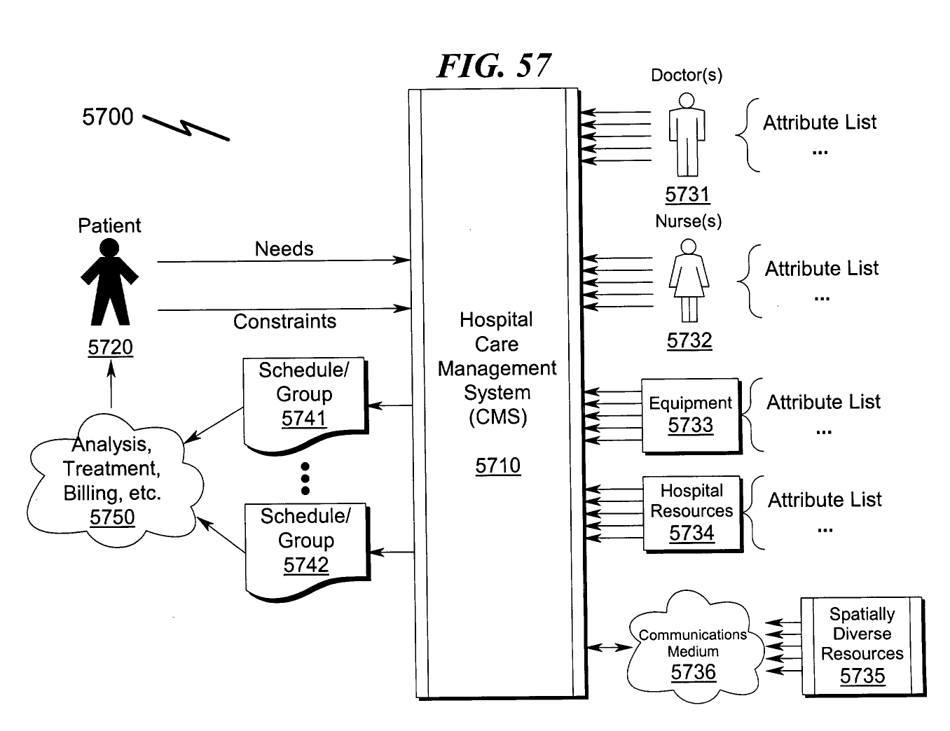

As illustrated in FIG. 57 (5700), an exemplary embodiment of this hospital care management system (CMS) (5710) permits needs and constraints of patients (5720) to be processed and brokered to available doctors (5731), nurses (5732), equipment (5733), hospital resources (5734), and other spatially diverse resources (5735) that may be linked via a communications medium (5736) to the hospital. The CMS coordinates these available resources in response to the needs and constraints of the patient(s) (5720) and generates schedules and groups of optimal treatment (5741, 5742) for the patient(s) (5720). Subsequent to this the patient is analyzed, treated, and billed automatically (5750).

Method (5800)

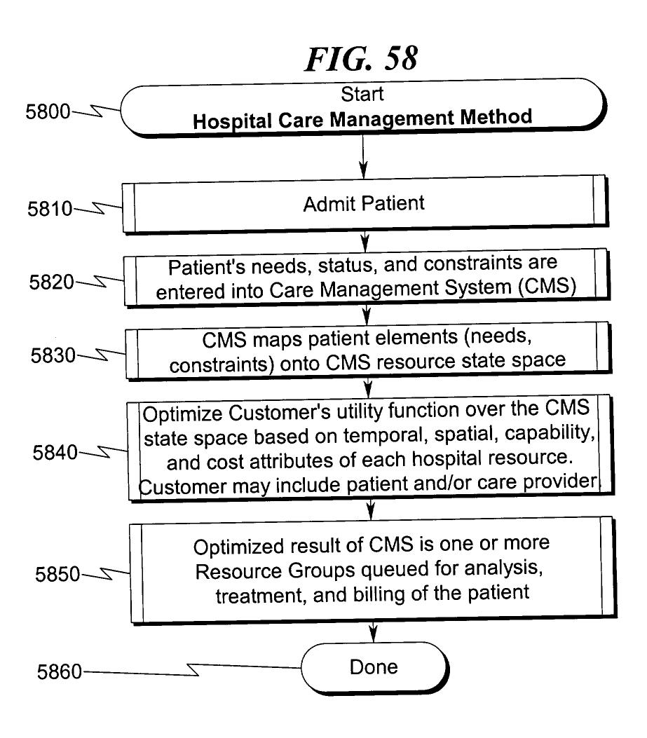

As illustrated in FIG. 58 (5800), an exemplary embodiment of the associated hospital care management method generally includes the following steps:

(1) admitting the patient (5810);

(2) entering the patient's needs, status, and constraints into the care management system (5820);

(3) mapping patient elements onto the care management system resource state space (5830);

(4) optimizing the patient's utility function over the care management system resource state space based on temporal, spatial, capability, and cost attributes of each hospital resource (5840); and

(5) queuing the optimized result of the care management system analysis as resource groups for analysis, treatment, and billing of the patient (5850).

One skilled in the art will recognized that these steps may be added to or subtracted from and rearranged to affect a wide variety of equivalent functions.

### Peer-to-Peer Computer Time Sharing/Job Scheduling

Overview

The present invention is particularly amenable to situations where a diverse group of computer systems are coordinated to form a computing network that provides for peer-to-peer time-sharing of computer resources. Here the present invention brokers “jobs” from users requesting computer time and schedules these to be run across a diverse set of computer systems acting as IP agents. The result of each computer job is then transmitted back to the user requesting the computer time.

Within this context the IP broker accepts job requests from customers, fractures these into manageable portions of job steps, maps these to available computer resources, and instructs the IP agents to act on the fractured job steps and send the results for integration to a destination specified by the customers. Thus, while the IP broker need not perform any of the actual computation, it coordinates the completion of each job and the integration of the final jobs into a cohesive deliverable IP system to the customer.

System (900)

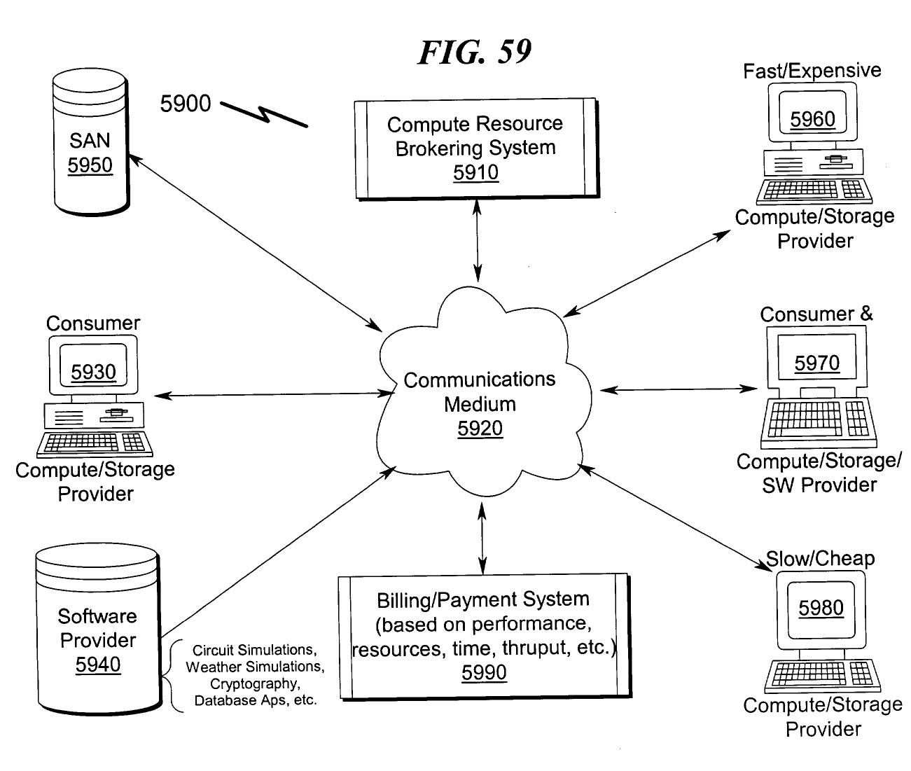

As illustrated in FIG. 59 (5900), an exemplary embodiment of this compute resource architecture permits a compute resource brokering system (5910) to cooperate with compute consumers (5920) via a communications medium (5930) with various software providers (5940), storage area networks (SANs) (5950), as well as compute/storage and/or software providers of various capacities (5960, 5970, 5980) and be billed (5990) based on various factors such as system performance, time used, throughput, etc. The billing/payment system (5990) permits compute/storage resource customers (5910) to be billed with proceeds from the billing to be transferred to the compute/storage resource providers (5950, 5960, 5970, 5980).

Method (6000)

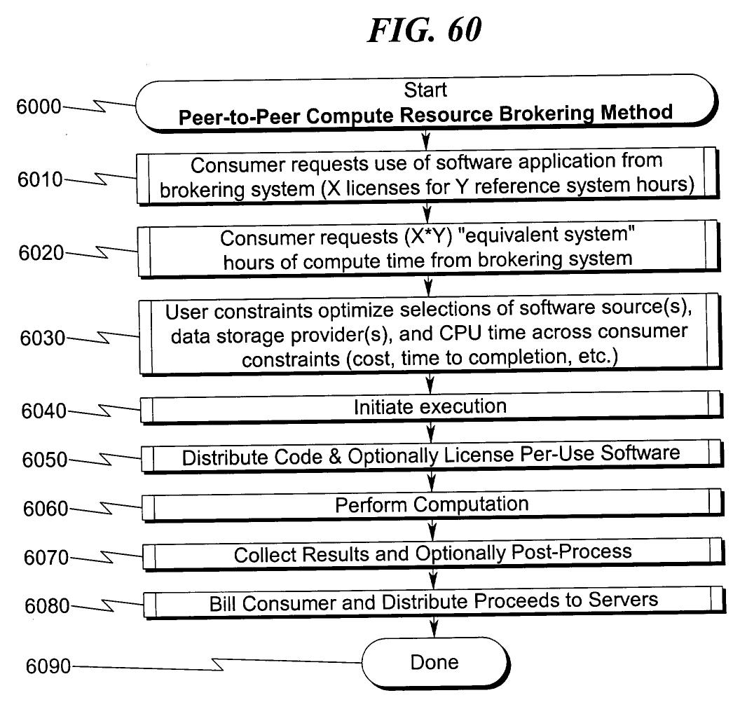

As illustrated in FIG. 60 (6000), an exemplary embodiment of the associated peer-to-peer compute resource brokering method generally includes the following steps:

(1) processing a consumer request for use of a selected software application (6010);

(2) requesting X licenses for Y reference system hours of “equivalent system” hours of compute time from a compute resource brokering system (6020);

(3) optimizing selection of software resources, data storage providers, and CPU time across consumer constraints (6030);

(4) initiating execution of the software application (6040);

(5) distributing software code and optionally licensing the software on a per-use basis (6050);

(6) performing the requested computation (6060);

(7) collecting the results from the requested computation and optionally post-processing these results (6070);

(8) billing the consumer and distributing the billing proceeds to compute/storage servers (6080).

One skilled in the art will recognized that these steps may be added to or subtracted from and rearranged to affect a wide variety of equivalent brokering functions.

Note that the “reference system” hours indicated above may be referenced to a particular compute resource performance level or any other standardized metric to permit gradations in system performance levels to be measured. The “equivalent system” hours indicates the product of the number of licenses times the reference system time value, and thus indicates the total capacity requested. This capacity may be brokered in a wide variety of partitions, to permit a large number of systems to perform a small amount of computation, or alternatively a small number of systems to perform a large quantity of computation.

### Infrastructure/Public Event Management

The present invention may also be advantageously applied to the management of any conventional infrastructure, such as TV cable maintenance/management, telephone service, or any other consumer service in which a set of resources (maintenance vehicles, installation crews, equipment, etc.) must be managed and optimized across a consumer service base.

One example of this application is in the management of large public events such as political conventions, sporting events, and the Olympics, etc. In these situations there are always requirements to manage a fixed set of customer requirements (emergency service personnel, food preparation, security, etc.) against a pool of available resources. The present invention optimizes this mapping and permits simulation of a variety of scenarios that permit management personnel to staff and equip according to projected system requirements and cover anticipated contingencies.

### Network Management

The present invention may be advantageously applied to distributed computer networks which may be used to allocate resources within a network to a wide variety of tasks while maintaining a level of system-wide redundancy to remain immune to outside threats such as terrorist attacks and the like.

### Commodity Brokering

The present invention is particularly useful as applied to commodity (energy, etc.) brokering in that various commodity resources and their respective consumers can be matched with optimal efficiency and in many cases eliminate uncertainty issues associated with commodity trading.

### Transportation Management

Large transportation networks, whether they are trucks, trains, airplanes, etc. are often plagued with a multitude of resource management and procurement issues. The present invention fits well into this environment because it can optimize the transportation and equipment utilization and thus achieve greater profit margins than either human based systems or system that simply optimize traffic patterns and airplane utilization, etc.

### Exemplary Application Markets

### Overview (6100)

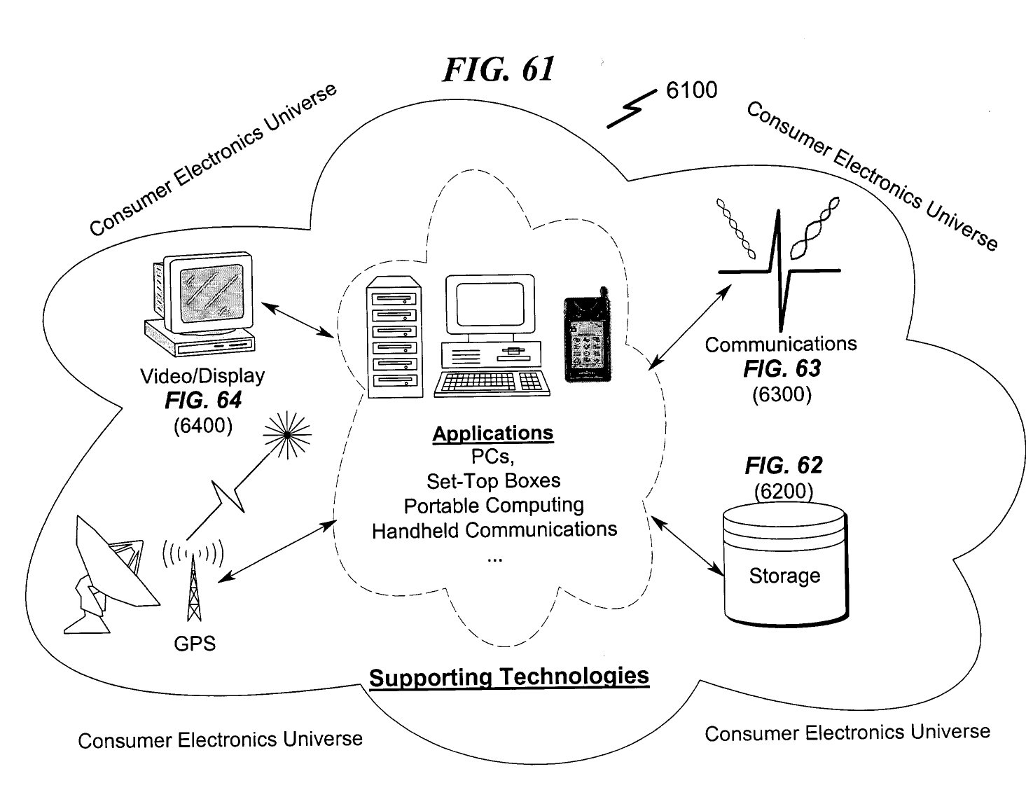

As illustrated in FIG. 61 (6100), the present invention may be advantageously applied to a wide variety of supporting technologies that support a wide variety of consumer applications within the consumer electronics universe. Specifically, the particular integration needs of the data storage (6200), communications (6300), and video/display (6400) markets are amenable to attack using the present invention teachings.

### Consumer Market Growth Trends (6200, 6300, 6400)

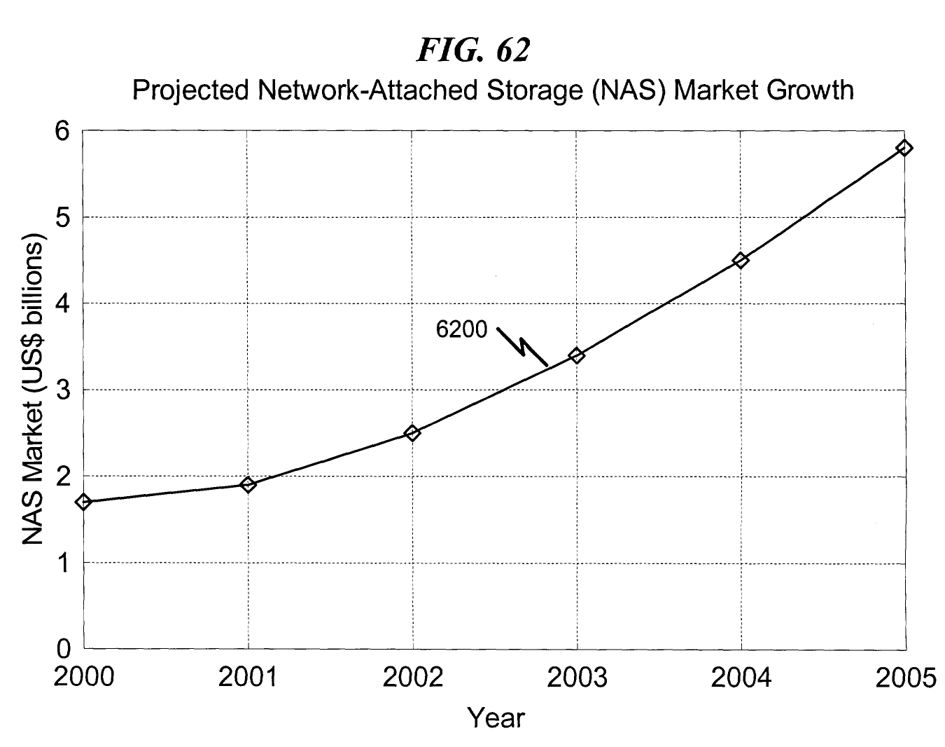

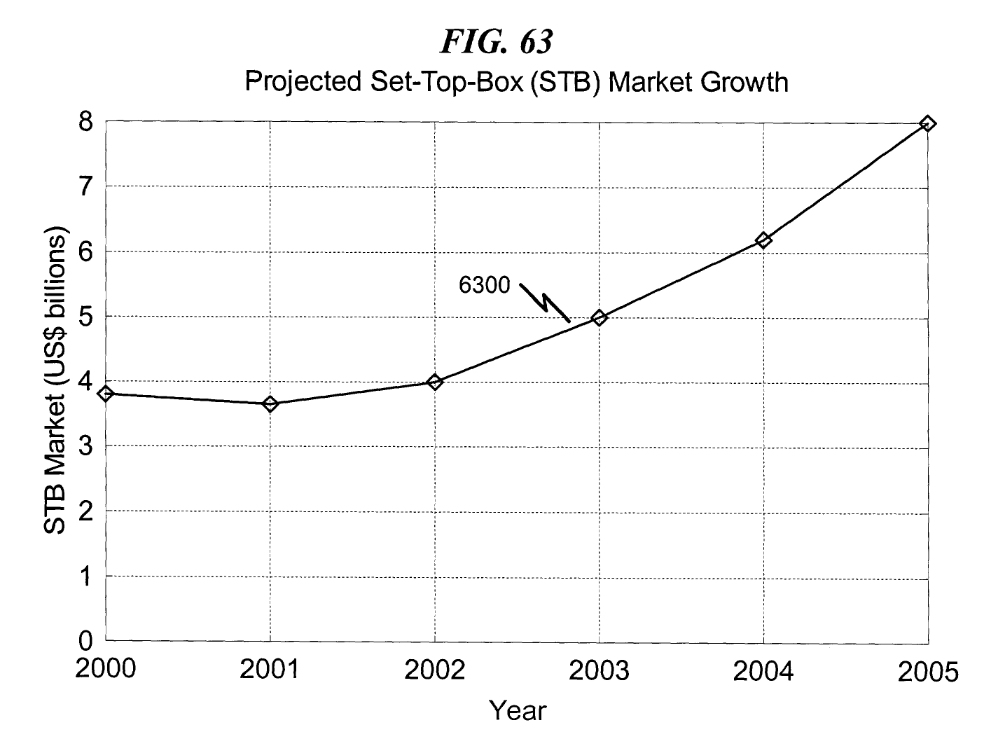

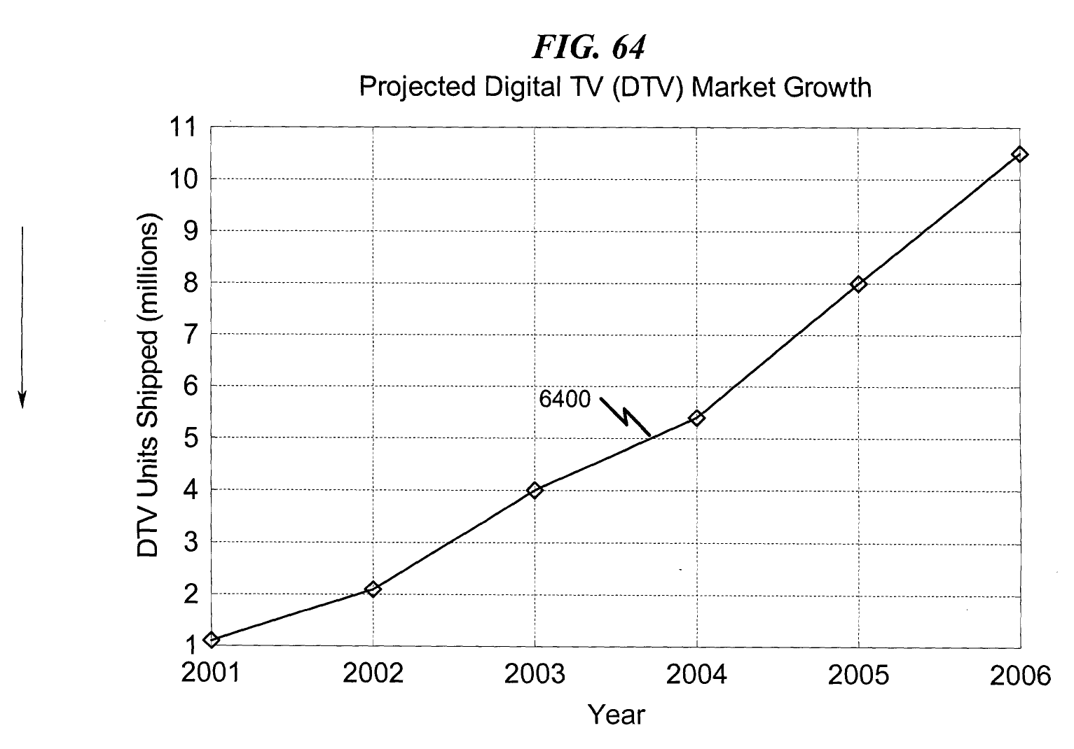

As illustrated in FIG. 62 (6200), FIG. 63 (6300), and FIG. 64 (6400), the data storage market (as exemplified by network-attached storage), communications market (as exemplified by set-top-boxes), and video/display market (as exemplified by digital TVs) will experience non-linear growth in the coming decade. This growth trend will present significant integration demands on the subsystems that comprise these consumer target products. Commensurate with this need for increased integration is a long-felt need for optimized brokering of IP resources to meet this demand that is not taught by the prior art but which is satisfied by a variety of preferred embodiments of the present invention.

### CONCLUSION

A distributed data storage system and method comprising a highly integrated mass storage controller system permitting distributed management and control of data storage is disclosed. The present invention in some preferred embodiments permits mass storage media to be made available on a network in a fashion to permit global access, while automatically handling many high-level file access and data integrity/security/control functions normally associated with a host operating system.

This integration and redistribution of functionality permits spatial diversification of data resources, automatic mirroring of data, fault isolation, data security, and a plethora of other control functions to be integrated into the mass storage device. This integration permits peer-to-peer communication between mass storage devices to both unburden the host data consumers but also isolate the data management functions from the data presentation functions normally associated with host systems.

Exemplary embodiments of the present invention as applied to specific preferred system contexts include but are not limited to distributed data storage in a networked environment, brokered data access metering, database access/control, data backup, journaling, checkpointing, and automated software distribution.

Although a preferred embodiment of the present invention has been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims:

What is claimed is:

1. A distributed data storage system comprising:
a) X-Drive means;
b) network means; and
c) client means;
wherein
said client means communicates to said X-Drive means through said network means;
said X-Drive means permits data resident on said X-Drive to be accessed by said client means through said network means;
said X-Drive means incorporates one or more OSI Model layers (Application, Presentation, Session, Transport, Network, Data Link, and/or Physical) to permit said X-Drive means to operate autonomously of said client means; and
said X-Drive means is capable of controlling and brokering data access among multiple said client means and/or X-Drive means.

2. The distributed data storage system of claim 1 wherein said network means is either flat or hierarchical, and said network means employs standard networking equipment such as routers, switches, and hubs.

3. The distributed data storage system of claim 1 wherein said X-Drive means is not in geographic proximity to said client means.

4. The distributed data storage system of claim 1 wherein said client means is comprised of any combination and number of computers, information appliances, and other X-Drive means.

5. The distributed data storage system of claim 1 wherein said X-Drive means coordinates RAID functionality with one or more additional X-Drive means.

6. The distributed data storage system of claim 1 wherein said X-Drive means operates on a virtual storage area network using VPN tunnels or dedicated time division multiplexed channels to one or more additional X-Drive means.

7. The distributed data storage system of claim 1 wherein said X-Drive means interoperate with one or more additional X-Drive means behind a router, switch, or hub.

8. The distributed data storage system of claim 1 wherein said X-Drive means has multiple network ports for failover protection.

9. The distributed data storage system of claim 1 wherein said X-Drive means have multiple network ports and perform routing and switching.

10. The distributed data storage system of claim 1 wherein said X-Drive means simultaneously services a multitude of said client means.

11. A distributed data storage system comprising:
a) wide area network means;
b) one or more spatial region means further comprising one or more local area network means;
c) one or more X-Drive means, each of said X-Drive means having local information regarding its geographic location;
d) logical data means resident on said one or more X-Drive means; and
e) one or more client means;
wherein
said wide area network means connects said one or more spatial region means and permits said one or more local area network means to communicate across said one or more spatial region means;
said one or more X-Drive means are individually resident on one of said one or more local area network means;
said one or more client means are individually resident on one of said one or more local area network means; and
said logical data means may be accessed by said one or more client means via communication with said one or more X-Drive means via said one or more local area network means via said wide area network means.

12. The distributed data storage system of claim 11 wherein said network means is either flat or hierarchical, and any of said network means employs standard networking equipment such as routers, switches, and hubs.

13. The distributed data storage system of claim 11 wherein said X-Drive means is not in geographic proximity to any of said client means.

14. The distributed data storage system of claim 11 wherein said client means is comprised of any combination and number of computers, information appliances, and other X-Drive means.

15. The distributed data storage system of claim 11 wherein said X-Drive means coordinates RAID functionality with one or more additional X-Drive means.

16. The distributed data storage system of claim 11 wherein said X-Drive means operates on a virtual storage area network using VPN tunnels or dedicated time division multiplexed channels to one or more additional X-Drive means.

17. The distributed data storage system of claim 11 wherein said X-Drive means interoperate with one or more additional X-Drive means behind a router, switch, or hub.

18. The distributed data storage system of claim 11 wherein said X-Drive means has multiple network ports for failover protection.

19. The distributed data storage system of claim 11 wherein said X-Drive means have multiple network ports and perform routing and switching.

20. The distributed data storage system of claim 11 wherein said X-Drive means simultaneously services a multitude of said client means.

21. A distributed data storage configuration method comprising:
(1) connecting an X-Drive to a configuration host;
(2) defining MAC/IP identification on said X-Drive;
(3) determining a GPS locale from a GPS receiver and/or the Internet and loading said GPS locale on said X-Drive;
(4) testing and/or formatting and/or initializing said X-Drive mechanics;
(5) associating said X-Drive onto a storage network;
(6) processing and servicing network file requests on said X-Drive.

22. The distributed data storage configuration method of claim 21 wherein said X-Drive moves data to and from DASDs in clients for data migration.

23. The distributed data storage configuration method of claim 21 wherein said X-Drive moves data to and from DASDs in clients for data mirroring.

24. The distributed data storage configuration method of claim 21 wherein said X-Drive moves data to and from DASDs in clients for data backups.

25. The distributed data storage configuration method of claim 21 wherein said X-Drive performs background virus scanning, data compression, or other duties for clients using spare resources and bandwidth.

26. The distributed data storage configuration method of claim 21 wherein said X-Drive incorporates quality of service functionality.

27. The distributed data storage configuration method of claim 21 wherein said X-Drive incorporates packet routing functionality.

28. The distributed data storage configuration method of claim 21 wherein said X-Drive incorporates packet switching functionality.

29. The distributed data storage configuration method of claim 21 wherein said X-Drive incorporates firewall functionality.

30. The distributed data storage configuration method of claim 21 wherein said X-Drive encrypts and/or decrypts data at the media level.

31. A distributed data storage access method comprising:
(1) receiving a data request from a data requester;
(2) selecting a lookup table entry from a MAC/IP/Latency/GPS table based on said data request;
(3) transmitting a data access request to a selected X-Drive based on said table entry;
(4) processing said request in said selected X-Drive to produce a data request result;
(5) if said data request result is that no data is available or no response is possible, selecting a new entry in said lookup table and returning said lookup table entry to said data requester, and proceeding to step (2);
(6) if said data request result is that the data has been located and a logical unit number is available for accessing said data request, locating data on said X-Drive corresponding to said data request and accessing said located data as directed by said data request; and
(7) if said data request result is that the data is not available on said X-Drive, but available on yet another MAC address with corresponding LUN, referencing said corresponding LUN and forwarding said data access request to said corresponding LUN.

32. The distributed data storage access method of claim 31 wherein said lookup table provides MAC/IP and latency data for available X-Drives.

33. The distributed data storage access method of claim 31 wherein said lookup table provides global positioning data for available X-Drives.

34. The distributed data storage access method of claim 31 wherein said X-Drives store data usage statistics including request time and geospatial information pertaining to both said requester and said requested data.

35. The distributed data storage access method of claim 31 wherein said X-Drives off-load data retrieval and management functions from clients.

36. The distributed data storage access method of claim 31 wherein said X-Drives cooperate with one another to achieve data processing and management goals.

37. The distributed data storage access method of claim 31 wherein said logical file is abstracted to the client by the targeted X-Drive.

38. The distributed data storage access method of claim 31 wherein said logical file is referenced by a centralized database.

39. The distributed data storage access method of claim 31 wherein said logical file is referenced by a distributed database.

40. The distributed data storage access method of claim 31 wherein said logical file is referenced by an instantaneous and temporary link.

41. The distributed data storage access method of claim 31 wherein said logical file is reconstructed on or migrated to the initiating X-Drive.

42. The distributed data storage access method of claim 31 wherein said logical file refers to block data within a larger entity, such as a database.

43. The distributed data storage access method of claim 31 wherein said X-Drive employs usage statistics and automatically migrates data to geospatial points of most frequent access.

44. The distributed data storage access method of claim 31 wherein said X-Drive optimizes data migration against usage statistics, against resource availability, and against programmed quota, network traffic, security, and redundancy requirement rules.

45. The distributed data storage access method of claim 31 wherein said X-Drives are mobile.

46. The distributed data storage access method of claim 31 wherein said X-Drives further comprise mobile data centers.

47. The distributed data storage access method of claim 31 wherein said clients and said requesters are mobile.

48. The distributed data storage access method of claim 31 wherein said X-Drives communicate securely with one another using data encryption.

49. The distributed data storage access method of claim 31 wherein network interfaces and concentrators including routers, switches, and hubs employ X-Drives to cache network traffic.

50. The distributed data storage access method of claim 31 wherein said X-Drives provide policy-managed “guest accounts” to facilitate data migration.

51. A data distribution system comprising:
a) data content resident on X-drive means, said data content produced by one or more content publishers;
b) network means;
c) target means;
d) one or more data consumer(s);
wherein
said network means connects both local and spatially diverse resources and entities;
said X-Drive means is connected to said network means and serves as a content distributor and/or receiver via said network means;
said target means is connected to said network means;
said one or more consumer(s) retrieve said data content from said X-drives via said network means for utilization on said target means.

52. The data distribution system of claim 51 wherein said consumer(s) may contribute content up to said publisher for redistribution consideration.

53. The data distribution system of claim 51 wherein said publishers also act as data consumers.

54. The data distribution system of claim 51 wherein said consumer(s) also act as publishers.

55. The data distribution system of claim 51 wherein said data content is distributed among one or more content publishers.

56. The data distribution system of claim 51 wherein a textual creative work is distributed.

57. The data distribution system of claim 51 wherein said data content is audio and/or video.

58. The data distribution system of claim 51 wherein said data content is software.

59. The data distribution system of claim 51 wherein said data content is encrypted.

60. The data distribution system of claim 51 wherein said data content cached for delayed playback on said target means.

61. A data distribution method comprising:
(1) storing a software product/application created by a content publisher on a provider X-Drive;
(2) communicating between said provider X-Drive to one or more consumer X-Drives referenced by a target system;
(3) distributing said software from said provider X-Drive to said consumer X-Drive;
(4) propagating said software automatically to other consumer X-Drives via data mirroring, backup, and/or data migration protocols; and
(5) optionally propagating software updates from said provider X-Drive to said consumer X-Drive.

62. The software distribution method of claim 61 wherein said provider and consumer X-Drives store software version, usage constraint, and time-stamp information for each item in distribution.

63. The software distribution method of claim 61 wherein said provider and consumer X-Drives incorporate authentication and secure communication methodologies.

64. The software distribution method of claim 61 wherein said consumer X-Drive optionally rejects said software updates.

65. The software distribution method of claim 61 wherein said consumer X-Drive optionally requests software updates based on aging or other criteria.

66. The software distribution method of claim 61 wherein said target systems optionally selects the best available software version published.

67. The software distribution method of claim 61 wherein said content publisher has the option of rolling a content X-drive back to a previously published software product/application.

68. The software distribution method of claim 61 wherein said target system has the option of rolling a content X-drive back to a previously published software product/application.

69. The software distribution method of claim 61 wherein said X-Drive has the option of automatically rolling back to a previously published software product/application in the event a software failure is detected.

70. The software distribution method of claim 61 wherein said target systems can each have unique check-pointed software product/application versions associated with said target system on said consumer X-Drive.

71. A data brokering and metering system comprising:
a) database means;
b) X-Drive means further comprising metering means and access control means;
c) network means;
d) billing agent means;
e) browser/display agent means;
f) data consumer means;
wherein
said database means is stored on said X-Drive means;
said access control means authenticates said data consumer means and transactions for said metering means, and ensures secure communication over said network means to permit said data consumer means access to said database means under control of said metering means and said billing agent means;
said metering means determines how much said billing agent means should pay to a data agent for access to said database means by said data consumer means;
said billing agent means bills and collects compensation from said data consumer means and pays said data agent means; and
said metering means, said billing agent means, said X-Drive means, and said data consumer means communicate via said network means.

72. A data brokering and metering method comprising:
(1) Establishing a relationship between a data consumer and a data agent with a common billing agent;
(2) Programming distribution, access, and pricing information for said data product by said data agent;
(3) Distributing a data product resident on an X-Drive, controlled by said data agent, to an X-Drive controlled by said data consumer;
(4) Authenticating said data consumer then permitting access by said data consumer to said data product on said data consumer's X-Drive;
(5) optionally logging consumer data access transactions in said data agent's X-Drive;
(6) optionally applying pricing policy to consumer data access transactions;
(7) Optionally invoicing said billing agent for data said consumer transactions;
(8) Optionally securely propagating said data product to other consumer X-Drives via data mirroring, backup, and/or data migration protocols.

73. The data brokering and metering method of claim 72 wherein said X-Drives store data product version, usage constraint, and time-stamp information for each item in distribution.

74. The data brokering and metering method of claim 72 wherein said data product is displayed using a TV set-top box.

75. The data brokering and metering method of claim 72 wherein said data product is used as input to a digital stereo receiver.

76. The data brokering and metering method of claim 72 wherein said data product is used as input to a wireless access device.

77. The data brokering and metering method of claim 72 wherein said X-Drives operate within a virtual private network.

78. The data brokering and metering method of claim 72 wherein the said X-Drives communicate directly with a display device.

79. The data brokering and metering method of claim 72 wherein the said X-Drive incorporates firewall functionality.

80. The data brokering and metering method of claim 72 wherein the said X-Drive incorporates encryption.

81. The data brokering and metering method of claim 72 wherein the said X-Drive protects data content in the event that network connectivity with said data agent's X-Drive is lost.

82. The data brokering and metering method of claim 72 wherein the said X-Drive erases local access keys in the event tampering is detected.

83. The data brokering and metering method of claim 72 wherein the said X-Drive accepts smart cards for authentication, access control, and/or a debit account for pre-paid access.

84. The data brokering and metering method of claim 72 wherein said X-Drive accepts a CD-ROM, DVD, tape, Compact Flash, or other recordable media which contains a secured said data product.

85. The data brokering and metering method of claim 72 wherein said X-Drive accepts and processes streaming content broadcast across a data network.

86. The data brokering and metering method of claim 72 wherein data authentication is controlled by access keys comprising access control lists.

87. The data brokering and metering method of claim 72 wherein data product consumer authentication further comprises biometric identification.

88. The data brokering and metering method of claim 72 wherein said X-Drive optionally accumulates, rejects, and/or removes non-authenticated data products under programmable policies.

89. A video display calibration system comprising:
a) digital interface and control means;
b) translinear function generator means;
c) horizontal sweep generator means;
d) vertical sweep generator means; and
e) video display means.
wherein
said digital interface and control means permits interface/control of said translinear function generator means through a digital interface;
said translinear function generator means accepts input from said horizontal sweep generator and said vertical sweep generator;
said translinear function generator makes time-varying gain adjustments to the inputs of said video display means.

90. A video display calibration method comprising:
(1) configuring a translinear function generator through a digital interface;
(2) accepting continuous input from a horizontal sweep generator into said translinear function generator;
(3) accepting continuous input from a vertical sweep generator into said translinear function generator;
(4) applying translinear functions in said translinear function generator to said horizontal sweep generator input and generating a translated horizontal sweep output;
(5) applying translinear functions in said translinear function generator to said vertical sweep generator input and generating a translated vertical sweep output;
(6) applying translinear functions in said translinear function generator to the results of said translated horizontal sweep output and said translated vertical sweep output and generating analog control signal outputs for a video display device.

91. The video display calibration method of claim 90 wherein said translinear function generator is under analog control.

92. The video display calibration method of claim 90 wherein said translinear function generator incorporates closed-loop performance feedback and auto-calibrates.

93. The video display calibration method of claim 90 wherein said video display device is a CRT.

94. The video display calibration method of claim 90 wherein said video display device is a LCD.

95. The video display calibration method of claim 90 wherein said video display device is a plasma display.
